(19) United States
(12) Patent Application Publication
(10) Pub. No.: US 2025/0335253 A1
(43) Pub. Date: Oct. 30, 2025

(54) SYSTEMS AND METHODS FOR COMPUTING FEATURING SYNTHETIC COMPUTING OPERATORS AND COLLABORATION

(71) Applicant: SUN &THUNDER, LLC, Weston, FL (US)

(72) Inventor: Rony Abovitz, Weston, FL (US)

(73) Assignee: SUN &THUNDER, LLC, Weston, FL (US)

(21) Appl. No.: 19/189,122

(22) Filed: Apr. 24, 2025

Related U.S. Application Data
(63) Continuation-in-part of application No. 18/223,514, filed on Jul. 18, 2023.
(60) Provisional application No. 63/390,136, filed on Jul. 18, 2022.
(60) Provisional application No. 63/638,391, filed on Apr. 24, 2024.

(51) Int. Cl. G06F 9/50

(52) U.S. Cl. CPC G06F 9/5027

(57) ABSTRACT

One embodiment is directed to a synthetic engagement system for process-based problem solving, comprising: a computing system comprising one or more operatively coupled computing resources; and a user interface operated by the computing system and configured to engage a human operator in accordance with a predetermined process configuration toward an established requirement based at least in part upon one or more specific facts; wherein the user interface is configured to allow the human operator to select and interactively engage one or more synthetic operators operated by the computing system to proceed through the predetermined process configuration, and to return result to the human operator selected to at least partially satisfy the established requirement; and wherein each of the one or more synthetic operators is informed by a convolutional neural network informed at least in part by historical actions of a particular actual human operator and a synthetic operator background configuration.

### RELATED APPLICATIONS

The present application claims the benefit of priority to U.S. Patent Application Ser. No. 63/638,391 titled “SYSTEMS AND METHODS FOR COMPUTING FEATURING SYNTHETIC COMPUTING OPERATORS AND COLLABORATION” filed on Apr. 24, 2024, which is hereby incorporated by reference in its entirety; and the present application is also a Continuation-in-Part of U.S. patent application Ser. No. 18/223,514 titled “SYSTEMS AND METHODS FOR COMPUTING FEATURING SYNTHETIC COMPUTING OPERATORS AND COLLABORATION” filed on Jul. 18, 2023, claims the benefit of priority to U.S. Patent Application Ser. No. 63/390,136 titled “SYSTEMS AND METHODS FOR COMPUTING FEATURING SYNTHETIC COMPUTING OPERATORS AND COLLABORATION” filed on Jul. 18, 2022, which are hereby incorporated by reference in their entirety.

### FIELD OF THE INVENTION

The present invention relates generally to systems and methods for configuring, organizing, and utilizing computing resources, and more specifically to computing systems, methods, and configurations featuring one or more synthetic computing interface operators configured to assist in the application and control of associated resources.

### BACKGROUND

Computing systems of various types have become ubiquitous to modern life, and various aspects of productivity have been greatly enhanced as a result. The scaling and amplification of human endeavors through computing has, however, been limited, in part due to factors such as the conventional paradigm through which humans interact with and utilize computing resources, and the complexity of many aspects of the human challenges at issue. For example, interfaces for utilizing computers to address specific technical challenges continue to involve arcane operational interfaces, such as those illustrated in the “command line” interface (2) of FIG. 1A and the “visual studio” interface (4) of FIG. 1B, as well as particular background knowledge and experience for optimization. Of course more user-friendly interfaces for scaling access to computing have developed, and some challenges may be relatively easily addressed through access portals such as web browser interfaces, such as that (6) illustrated in FIG. 2, or voice-based computing interfaces through devices such as that (8) illustrated in FIG. 3. In many scenarios, however, the ultimate collaborative resource for a complex task remains not a computing resource, but another human resource, or team thereof, with unique skills, experiences, and capabilities, such as the skills, experience, and capabilities pertinent to operating and utilizing computing resources, along with many other skills, experiences, and capabilities.

The onset of readily-available generalized “artificial intelligence” (or “AI”) computing systems, such as those available from providers such as Amazon, Inc. or Google, Inc. (under the tradenames Alexa™ or Google Assistant™, for example) has assisted in providing relatively convenient, hands-free, low-latency responses to challenges such as: “what is the capital city of Oregon?”. Such systems, however, generally are poorly suited for complex and multifactorial challenges such as: a) design the next successful Ford Mustang, returning ready-to-manufacture design and manufacturing documents; b) create music for what would have been the next Beatles album; or c) create the next successful significant iteration of a consumer electronics product, returning ready-to-manufacture design and manufacturing documents. Again, such challenges typically are the purview of teams of talented and experienced humans, and inherently there are associated human factors related issues such as: finding the best people, keeping them engaged and on challenge, co-locating them as appropriate, having them provide functional synergies for each other and the overall objective. In other words, engaging and maintaining the very best team for a given challenge is very complicated, difficult, expensive, and hard to scale.

Indeed, referring to these three stated challenges in further detail, a typical high-level paradigm for the first (design the next successful Ford Mustang) might involve the following, as illustrated in FIG. 4: a) assembling a core team of designers, mechanical engineers, electrical engineers, suspension engineers, drivetrain engineers, materials experts, regulatory experts, product marketing experts, manufacturing experts, cost control experts, outward-facing-marketing experts, sales experts, project managers, and technical and general management experts (10); b) conducting a collaborative effort to understand what the Ford Mustang has been in the past, what has worked well, what has not, and where the product or product line needs to go in view of not only artistic and performance constraints, but also regulatory and cost controls, amongst others (12); c) settling on a high-level design in a collaborative way that results in something benefitting from the collective expertise (14); d) iterating through many many details to develop one or more detailed designs which may be physically prototyped and/or tested (16); e) manufacturing, marketing, and selling, in requisite numbers, at requisite operating margin, new Ford Mustangs to provide positive contribution to the entity (18). Conducting such a multivariate and complex project, or even obtaining and retaining the preferred resources to do so, is an incredible challenge which is very hard to successfully beat; many would argue that the odds of beating such a challenge with a net positive contribution margin in the end are fairly low, and the up-front costs extremely high.

A typical high-level paradigm for the second aforementioned challenge (creating music for what would have been the next Beatles album) may involve different resources, but arguably no less complexity or risk, as illustrated, for example, in FIG. 5: a) selecting a producer steeped in the knowledge of Beatles music, what made them great, where their musical evolution was going at the time of break-up, what the Beatles should and should not sound like, what they might have written about at the time, what instruments of the time should sound like and how to use modern and/or period equipment to reproduce that, and everything possible about each of Ringo, John, Paul, and George (20); b) selecting musicians steeped in the knowledge of Beatles music, what made them great, where their musical evolution was going at the time of break-up, what the Beatles should and should not sound like, what they might have written about at the time, what instruments of the time should sound like and how to use modern and/or period equipment to reproduce their particular instrument (22); c) conducting a collaborative effort to write and record a new album worth of songs in a manner that results in a product worthy of the mission (24). Again, conducting such a multivariate and complex project, or even obtaining and retaining the preferred resources to do so, is an incredible challenge which is very hard to successfully address; many would argue that the odds of beating such a challenge would be fairly low, and the up-front costs relatively high.

If a user were to try to accomplish one of the aforementioned challenges with a generalized AI system such as Alexa™, the answer likely would be something akin to: “I'm unable to do that”. If a user were to try to utilize conventional computing resources and utility paradigms (such as search queries, audio files, video files, and the like), the challenge would be quite daunting, inefficient, and hard to scale, in part due to the complexity of these challenges, and in part due to the conventional paradigms of interacting with and utilizing computing resources, which is why, as noted above, the best collaborative resource for these types of tasks often has been: a team of talented individuals—and, of course, the related challenge to this is in recruiting, retaining, engaging, and executing with such individuals in a manner which provides a success. Indeed, the notion of trying to access even an individual human to accomplish a complex task, much less a team, can be very challenging on its own. Referring to FIG. 6A, for example, one variation of a model (30) for increasing the odds of success for an individual (28) given a particular challenge (32) is illustrated, wherein many inputs and factors, including but not limited to knowledge (34), experience (36), resource (38), analytical skills (40), technical skills (42), efficiency (44), an environment that appropriately facilitates success (46), an appropriate risk/reward paradigm (48), collaboration/“people” skills (50), hard work (52), instinct regarding the marketability and/or value of various alternatives (54), an understanding of the business opportunity (56), communication skills (58), time (60), and desire/ability to overcome adversity (62), may be brought to bear in addressing the challenge and successfully meeting the goal/objective (32).

While many would argue that FIG. 6A illustrates only one of many models which may assist in characterizing the multifaceted challenge of getting a person to reach a goal, few would argue with a position that such a challenge is multifactorial, complex, and challenging to address—and, again, this is in reference to having a single resource try to address a complex challenge.

FIG. 6B illustrates one variation of a related process flow wherein a challenge is identified, outlined in detail, and deemed to be resourced by a single human resource (64). The single human resource may be identified and/or assigned (66). The resource may clarify understanding of the goals and objectives pertaining to the challenge, along with available resources, background regarding the pertinent business opportunity, where appropriate (68). At this point, the resource may be in a “ready-to-execute” condition (70). Utilizing assets such as skills, knowledge, experience, and instinct, the resource initiates and works through the challenge, as facilitated by factors such as hard work, time, collaboration/people skills, an appropriate risk/reward paradigm, an environment configured to facilitate success, efficiency, resources (such as information, computing, etc), desire/ability to overcome issues and adversities, and communication skills (72). The resource may utilize similar assets and facilitating factors to iterate and improve provisional solutions (74). Finally, the resource may produce the final solution to address the goal/objective (76).

Again, the aforementioned sample process for a single human resource to address a particular challenge is complex, with opportunity for failure or sub-optimal result at many stages. Indeed, as with any human-resource-related process, there are added human factors issues that may impact the process, such as hiring difficulties, lack of appropriate personnel, interpersonal relationship issues, limitations on throughput due to human capability, vacation days, family issues, etc. Teams, and the resources and scale necessary to optimally address a complex challenge such as those described above in reference to a vehicle design goal, a music production goal, and a consumer product goal, add significantly more complexity, and these paradigms probably contribute to the relatively high failure rate in attempts at addressing challenges of equivalent complexity (many vehicle designs fail, many attempts to produce successful music fail, many iterations of consumer electronics fail).

Referring to FIGS. 7A-8C, and 9A-10, some advancements in computing have assisted with human scale challenges of some levels of complexity. For example, referring to FIG. 7A, a robot (78) such as that available under the tradename PR2®, or “personal robot 2”, generally features a head module (84) featuring various vision and sensing devices, a mobile base (86), a left arm with gripper (80), and a right arm with gripper (82). Referring to FIGS. 7B-7K, such a robot (78) has been utilized to address certain challenges such as approaching a pile of towels (88) on a first table (92), selecting a single towel (90), and folding that single towel (90) at a second table (93) in the sequence of FIGS. 7B-7K. Referring to FIG. 8A, an event chart is illustrated wherein such a robot may be configured to march sequentially through a series of events (such as events E1-E10) to fold a towel. FIG. 8B illustrates a related event sequence (96) listing to show that events E1-E10 are serially addressed. Referring to FIG. 8C, an associated flow chart is illustrated to show that the seemingly at least somewhat complex task of folding a towel may be addressed using a sequence of steps, such as having the system powered on, ready, and at the first laundry table (102), identifying and picking up a single towel at the first stable (104), identifying a first corner of the single towel (106), identifying a second corner of the selected towel (108), moving to a second table (110), applying tension between two adjacent corners of the towel and dragging the towel onto the table for folding (112), conducting a first fold of the towel (114), conducting a second fold of the towel (116), picking up the twice-folded towel and moving it to a stacking destination on the second table (118), and conducting a final flattening of the folded towel (120). A sequence of events, in a single-threaded type of execution, is utilized the system to conduct a human-scale challenge of folding a towel. To get such system to accomplish such challenge, however, takes a very significant amount of programming and experimentation, and generally at runtime is much slower than the execution of a human with only the most basic level of attention to the simple task.

Referring to FIGS. 9A-10, another at least somewhat complex challenge is illustrated, wherein a small robotic system such as that available under the tradename TurtleBot® (126) may be programmed and prepared using machine learning techniques to utilize a LIDAR scanner device (130) and a mobile base (132) to scan for obstacles (134) and successfully navigate in a real room (136) at runtime based upon training using a synthetic environment (122) with synthetic obstacles (124) and a simulation of a LIDAR scanning capability (128) for learning purposes. For example, referring to FIG. 10, robot and sensor hardware may be selected for a navigation challenge (140); a goal may be established for a reinforcement learning approach (i.e., for the robot to autonomously reach a designated target in X/Y coordinates somewhere within a maze defined by walls/objects placed upon a substantially planar surface) (142); a synthetic training environment may be created such that a synthetic robot can synthetically/autonomously explore a synthetic maze to repetitively reach various designated goal locations (144); and at runtime the actual robot may navigate the actual maze or room using the trained convolutional neural network (“CNN”) with a goal to reach an actual pre-selected target in the room (146). Thus certain machine learning techniques may be utilized to address computing challenges as well, such as a fairly single-threaded sequence of smaller decisions to navigate a maze or room obstacles, but access to such solutions remains limited and suboptimal, generally requiring significant knowledge of computing, sensors, robotics, and the like.

There continues to be a need for computing technologies and configurations to assist users in scalably and efficiently accomplishing tasks of great human complexity and sophistication. Described herein are systems, methods, and configurations for enhancing the interactivity between human users and computing resources for various purposes, including but not limited to computing systems, methods, and configurations featuring one or more synthetic computing interface operators configured to assist in the application and control of associated resources.

### BRIEF DESCRIPTION OF THE DRAWINGS:

FIGS. 1A and 1B illustrate aspects of computing interfaces.

FIGS. 2 and 3 illustrate aspects of computing interfaces.

FIG. 4 illustrates aspects of a process for a hypothetical engineering project.

FIG. 5 illustrates aspects of a process for a hypothetical music project.

FIGS. 6A and 6B illustrate aspects of paradigms for engaging a human resource to move toward a goal or objective.

FIGS. 7A-7K and 8A-8C illustrate aspects of the complexities which may be involved in getting a computer-based robotic system to accomplish a task or goal.

FIGS. 9A-9C illustrate aspects of an electromechanical configuration which may be utilized to navigate and/or map an environment.

FIG. 10 illustrates aspects of a process configuration for utilizing an electromechanical system to navigate to address an objective such as a maze navigation.

FIGS. 11A-12D, 13A-13C, and 14A-16 illustrate aspects of a configuration wherein relatively simple line drawings may be utilized to assist an automated system in producing a more detailed artistic or graphical product.

FIGS. 17A-18G illustrate aspects of automated design configurations and process examples wherein complex products such as shoes, automobiles, or components thereof may be advanced using the subject computerized configurations.

FIGS. 19A-20C illustrate various aspects of convolutional neural network configurations which may be utilized to assist in solving complex problems.

FIGS. 21A-24C illustrate various complexities of configuration variations which may be utilized to assist in solving complex problems such as those more commonly addressed by teams of humans.

FIGS. 25-27B illustrate various aspects of interfaces which may be utilized to assist in user feedback and control pertaining to team function, expense, and time-domain-related issues.

FIGS. 28A-30D and 31 illustrate aspects of system configuration which may be utilized to provide precision control over computerized processing to address complex challenges more commonly addressed by teams of humans.

FIGS. 32A-32D illustrate aspects of system and method configuration pertaining to synthetic operator background configuration and operation, including various aspects pertaining to training, background development and population, and certification.

FIGS. 33A-33D illustrate aspects of system and method operation in scenarios wherein a plurality of synthetic operators may be employed to address one or more particular challenges associated with process-based problem solving.

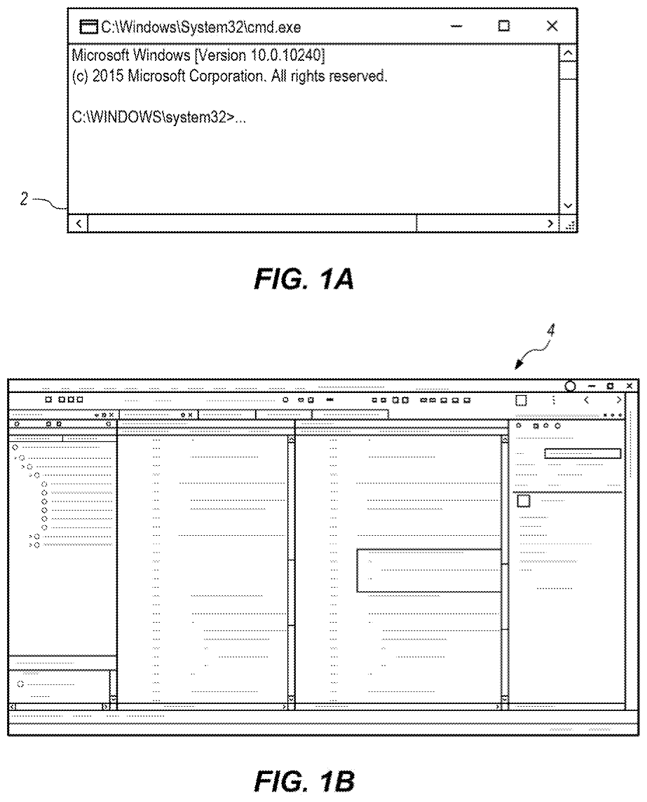

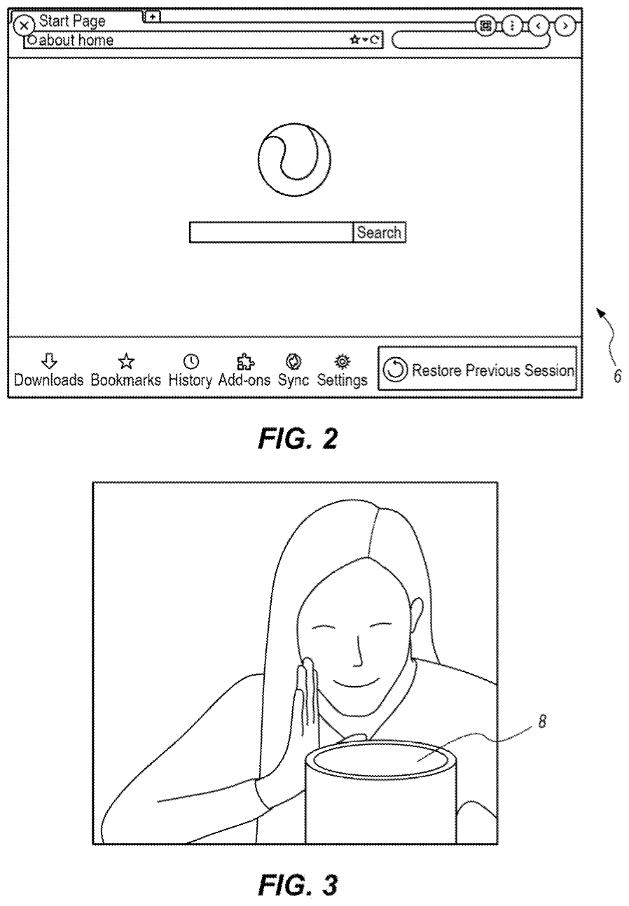

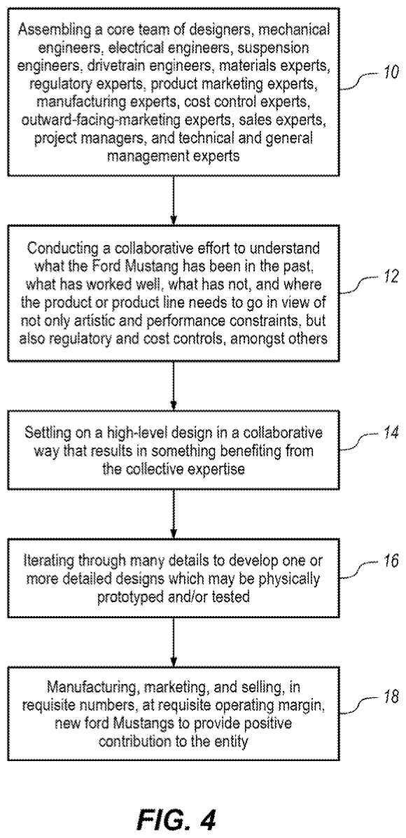

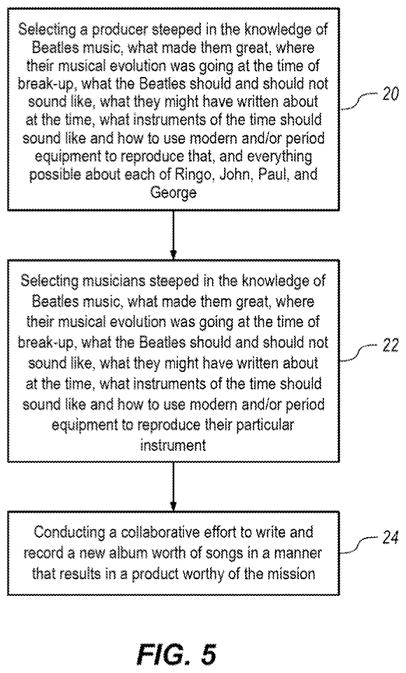

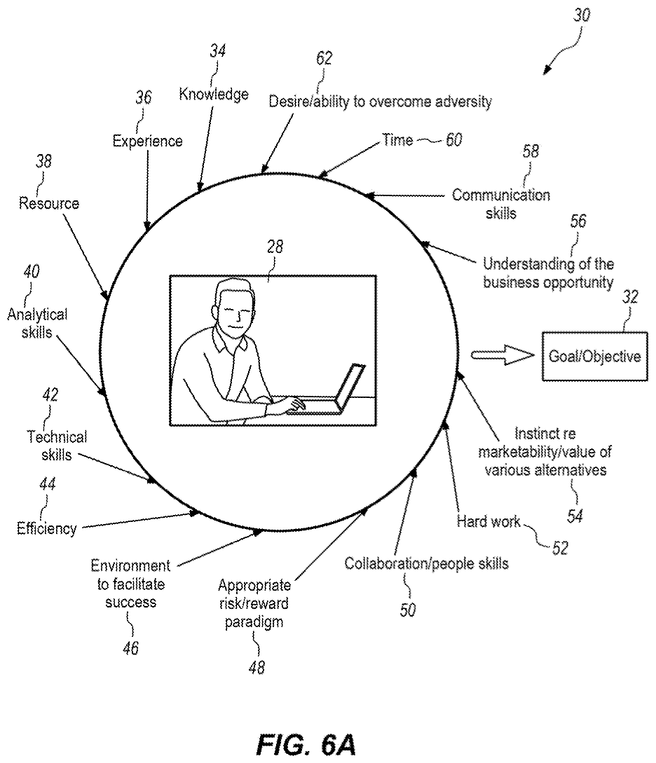

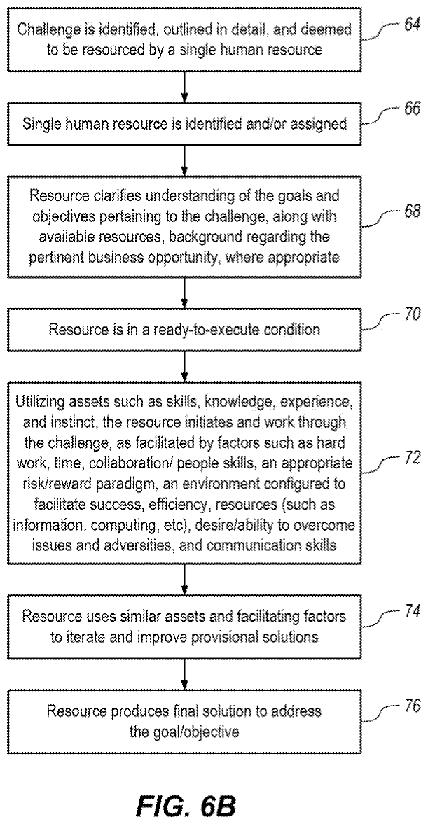

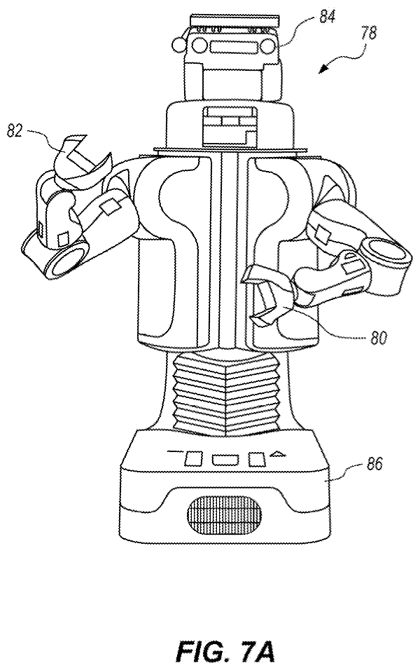

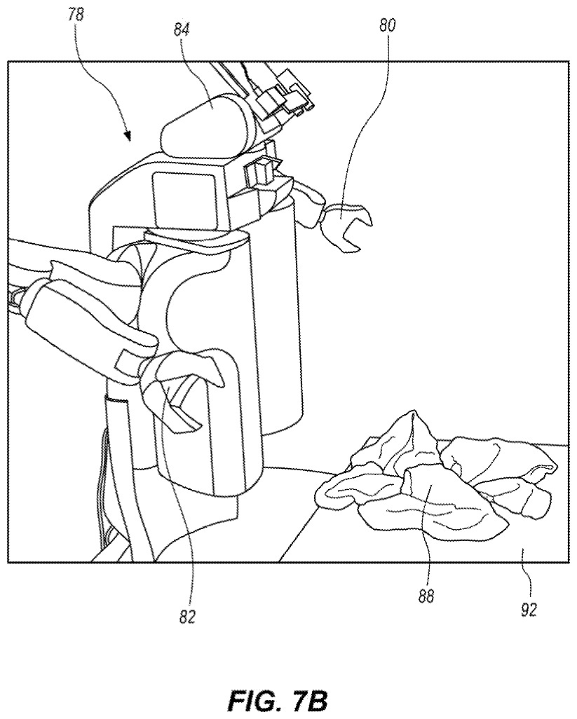

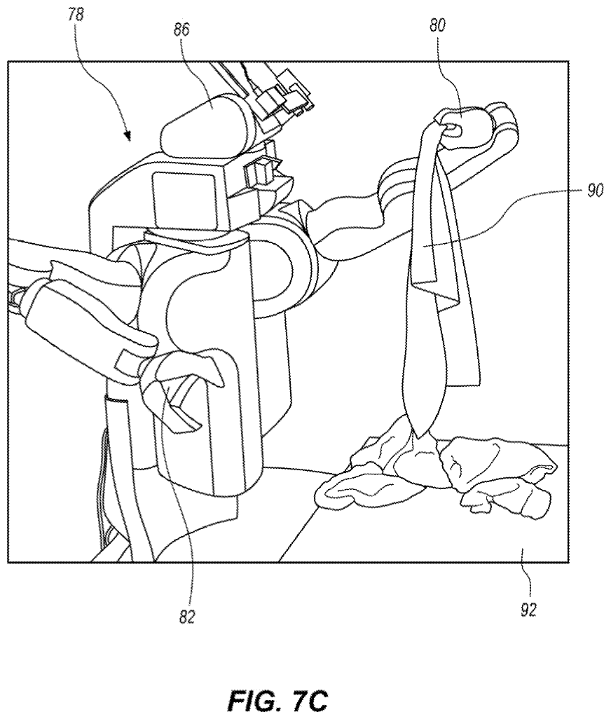

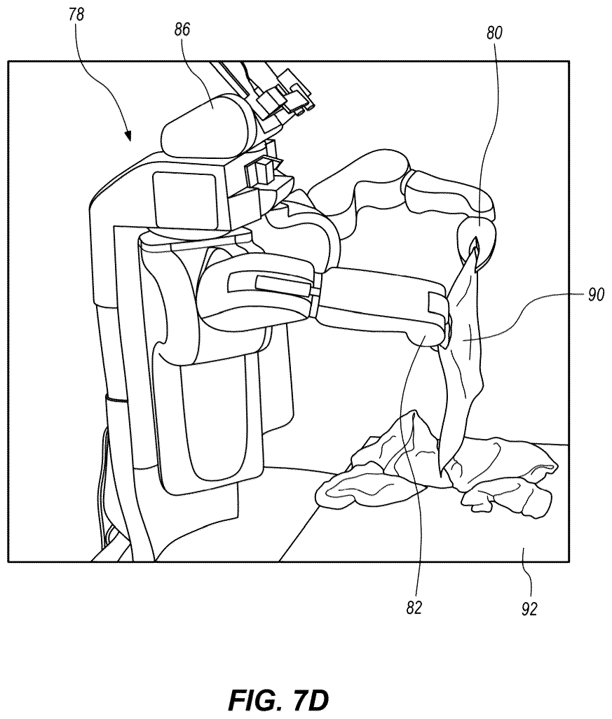

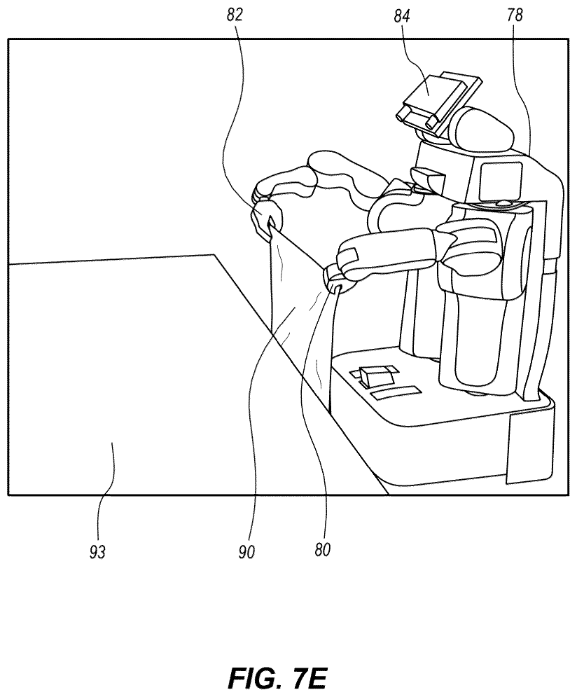

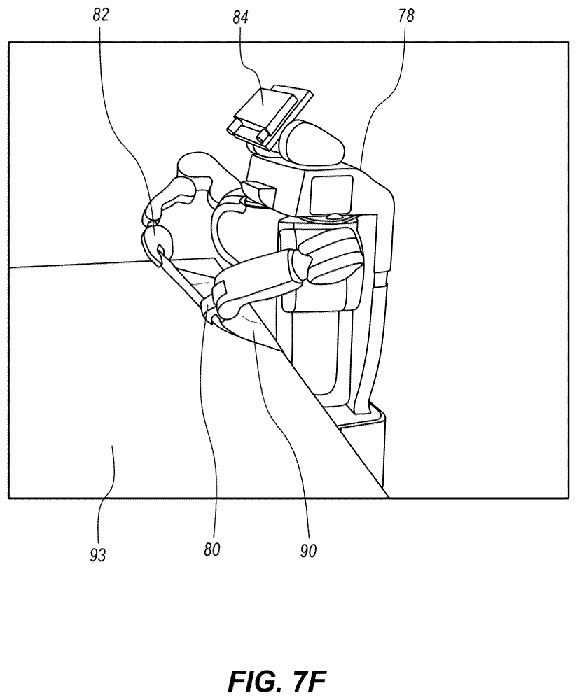

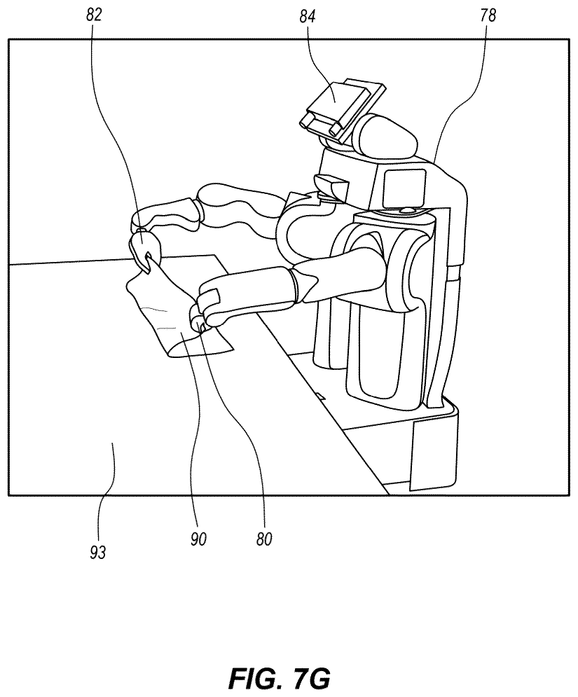

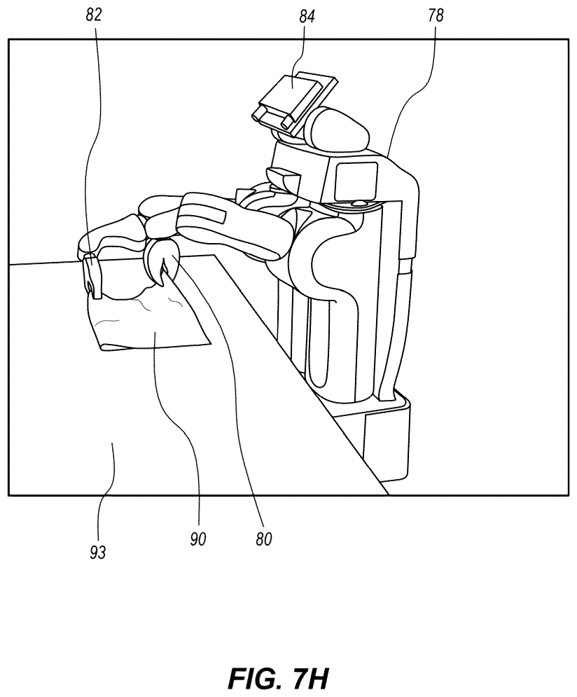

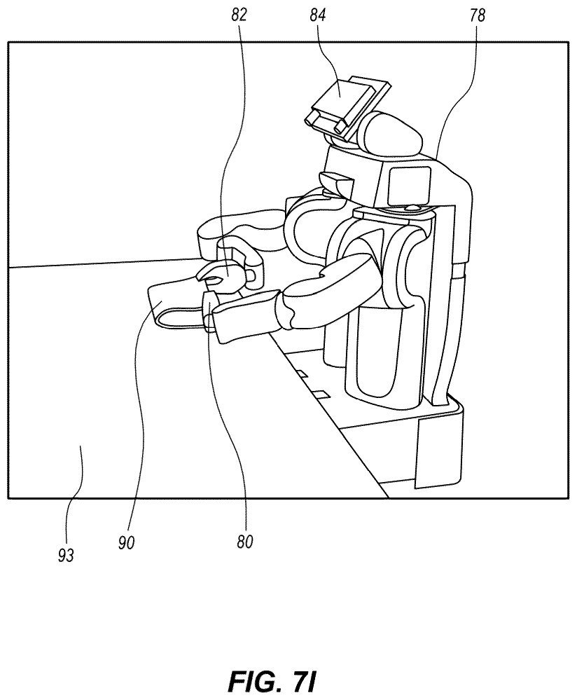

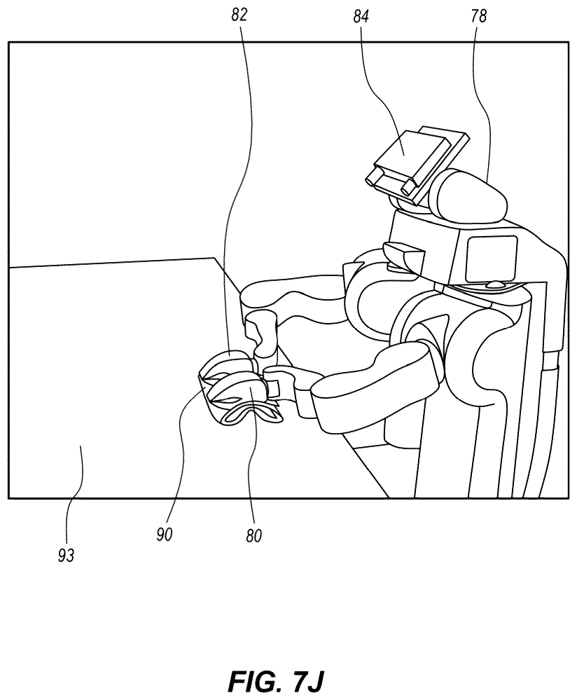

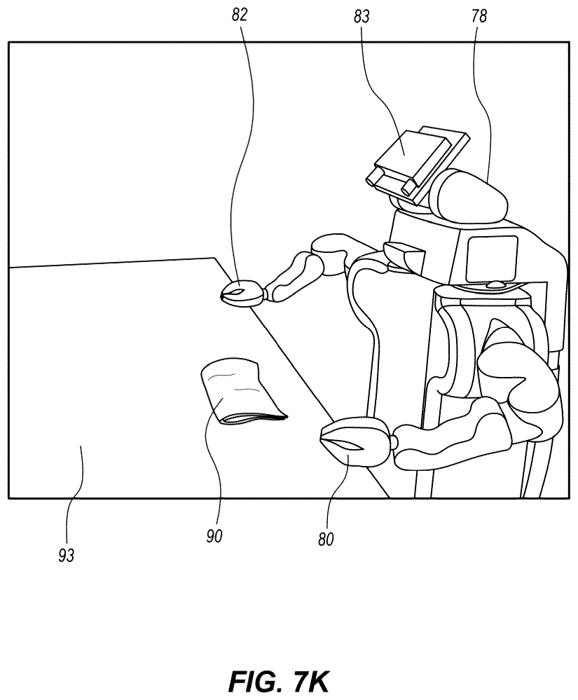

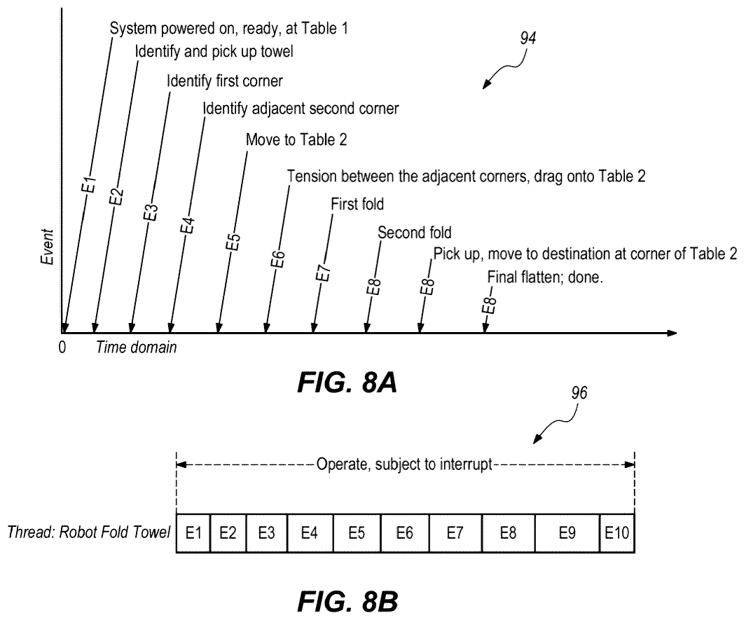

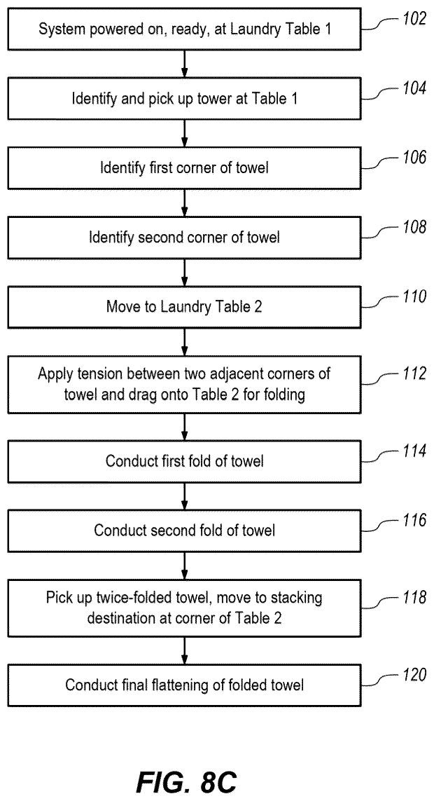

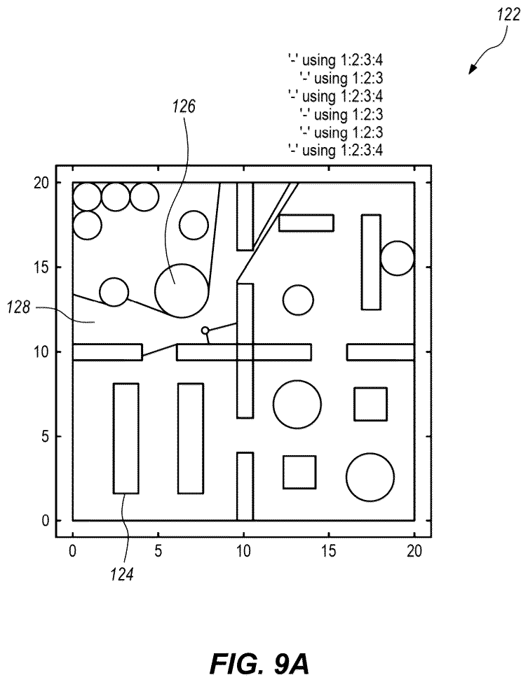

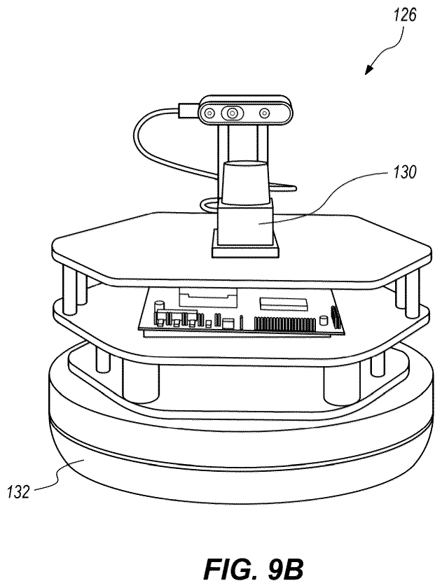

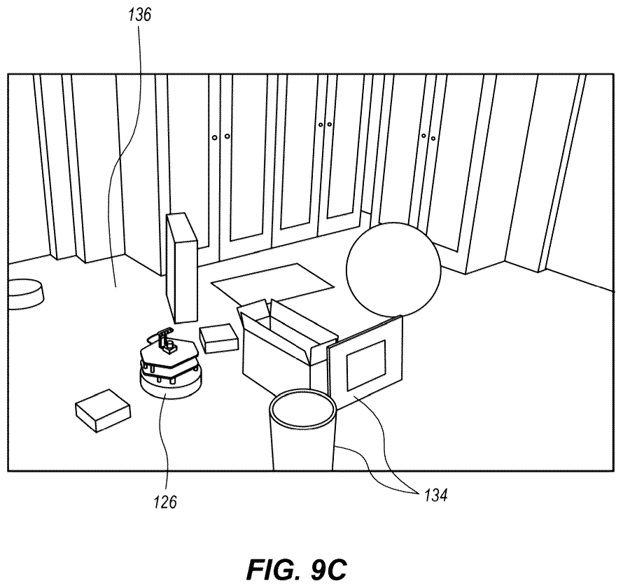

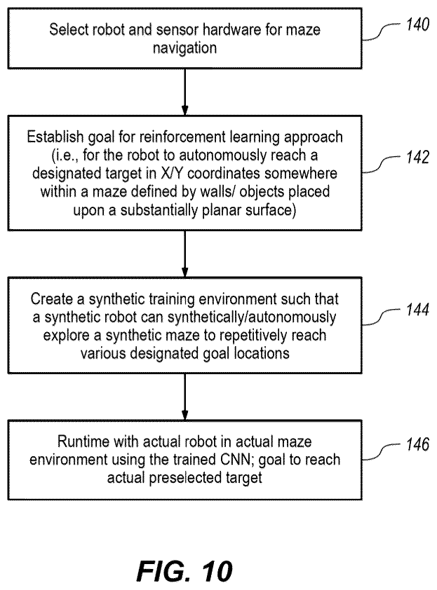

### SUMMARY

One embodiment is directed to a synthetic engagement system for process-based problem solving, comprising: a computing system comprising one or more operatively coupled computing resources; and a user interface operated by the computing system and configured to engage a human operator in accordance with a predetermined process configuration toward an established requirement based at least in part upon one or more specific facts; wherein the user interface is configured to allow the human operator to select and interactively engage one or more synthetic operators operated by the computing system to proceed through the predetermined process configuration, and to return a result to the human operator selected to at least partially satisfy the established requirement; and wherein each of the one or more synthetic operators is informed by a convolutional neural network informed at least in part by historical actions of a particular actual human operator and a synthetic operator background configuration. The one or more specific facts may be selected from the group consisting of: textual information, numeric data, audio information, video information, emotional state information, analog chaos input selection, activity perturbance selection, curiosity selection, memory configuration, learning model, filtration configuration, and encryption configuration. The one or more specific facts may comprise textual information pertaining to specific background information from historical storage. The one or more specific facts may comprise textual information pertaining to an actual operator. The one or more specific facts may comprise textual information pertaining to a synthetic operator. The specific facts may comprise a predetermined profile of specific facts developed as an initiation module for a specific synthetic operator profile. The one or more operatively coupled computing resources may comprise a local computing resource. The local computing resource may be selected from the group consisting of: a mobile computing resource, a desktop computing resource, a laptop computing resource, and an embedded computing resource. The local computing resource may comprise an embedded computing resource selected from the group consisting of: an embedded microcontroller, an embedded microprocessor, and an embedded gate array. The one or more operatively coupled computing resources may comprise resources selected from the group consisting of: a remote data center; a remote server; a remote computing cluster; and an assembly of computing systems in a remote location. The system further may comprise a localization element operatively coupled to the computing system and configured to determine a location of the human operator relative to a global coordinate system. The localization element may be selected from the group consisting of: a GPS sensor; an IP address detector; a connectivity triangulation detector; an electromagnetic localization sensor; an optical location sensor. The one or more operatively coupled computing resources may be activated based upon the determined location of the human operator. The user interface may comprise a graphical user interface. The user interface may comprise an audio user interface. The graphical user interface may be configured to engage the human operator using an element selected from the group consisting of: a computer graphics engagement display; a video graphics engagement display; and an audio engagement accompanied by displayed graphics. The graphical user interface may comprise a video graphics engagement display configured to present a real-time or near real-time graphical representation of a video interface engagement character with which the human operator may converse. The video interface engagement character may be selected from the group consisting of: a humanoid character, an animal character, and a cartoon character. The user interface may be configured to allow the human operator to select the visual presentation of the video interface engagement character. The user interface may be configured to allow the human operator to select a visual presentation characteristic of the video interface engagement character selected from the group consisting of: character gender, character hair color, character hair style, character skin tone, character eye coloration, and character shape. The visual presentation of the video interface engagement character may be modelled after a selected actual human. The user interface may be configured to allow the human operator to select one or more audio presentation aspects of the video interface engagement character. The user interface may be configured to allow the human operator to select one or more audio presentation aspects of the video interface engagement character selected from the group consisting of: character voice intonation; character voice loudness; character speaking language; character speaking dialect; and character voice dynamic range. The one or more audio presentation aspects of the video interface engagement character may be modelled after a selected actual human. The predetermined process configuration may comprise a finite group of steps through which the engagement shall proceed in furtherance of the established requirement. The predetermined process configuration may comprise a process element selected from the group consisting of: one or more generalized operating parameters; one or more resource/input awareness and utilitization settings; a domain expertise module; a process sequencing paradigm; a process cycling/iteration paradigm; and an AI utilization and configuration setting. The finite group of steps may comprise steps selected from the group consisting of: problem definition; potential solutions outline; preliminary design; and detailed design. The predetermined process configuration may comprise a selection of elements by the human operator. Selection of elements by the human operator may comprise selecting synthetic operator resourcing for one or more aspects of the predetermined process configuration. The system may be configured to allow the human operator to specify a particular resourcing for a first specific portion of the predetermined process configuration. The system may be configured to allow the human operator to specify a particular resourcing for a second specific portion of the predetermined process configuration that is different from the particular resourcing for the first specific portion of the predetermined process configuration. The system may be configured to allow the human operator to specify a particular resourcing for a first specific portion of the predetermined process configuration that is based upon a plurality of synthetic operator characters. Each of the plurality of synthetic operator characters may be applied to the first specific portion sequentially. Each of the plurality of synthetic operator characters may be applied to the first specific portion simultaneously. The system may be configured to allow the human operator to specify a particular resourcing for a first specific portion of the predetermined process configuration that is based upon one or more hybrid synthetic operator characters. The one or more hybrid synthetic operator characters may comprise a combination of otherwise separate synthetic operator characters which may be applied to the first specific portion simultaneously. The convolutional neural network may be informed using inputs from a training dataset comprising data pertaining to the historical actions of the particular actual human operator. The convolutional neural network may be informed using inputs from a training dataset using a supervised learning model. The convolutional neural network may be informed using inputs from a training dataset along with analysis of the established requirement using a reinforcement learning model. Each of the one or more synthetic operators may be informed by a convolutional neural network informed at least in part by a curated selection of synthetic action records pertaining to synthetic actions of an actual human operator. Each of the one or more synthetic operators may be informed by a convolutional neural network informed at least in part by a curated selection of synthetic action records pertaining to synthetic actions of a synthetic operator. The computing system may be configured to separate each of the finite group of steps with an execution step during which the one or more synthetic operators are configured to progress toward the established requirement in accordance with one or more execution behaviors associated with the pertinent convolutional neural network. At least one of the one or more execution behaviors may be based upon a project leadership influence on the pertinent convolutional neural network. The computing system, based at least in part upon the at least one execution behavior based upon a project leadership influence, may be configured to divide the execution step into a plurality of tasks which may be addressed by the available resources in furtherance of the established requirement. The computing system, based at least in part upon the at least one execution behavior based upon a project leadership influence, may be further configured to project manage accomplishment of the plurality of tasks toward one or more milestones in pursuit of the established requirement. The computing system, based at least in part upon the at least one execution behavior based upon a project leadership influence, may be further configured to functionally provide an update pertaining to accomplishment of the plurality of tasks at one or more stages of the execution step. The computing system, based at least in part upon the at least one execution behavior based upon a project leadership influence, may be further configured to functionally provide an update pertaining to accomplishment of the plurality of tasks at the end of each executing step for consideration in each of the finite group of steps in the process configuration. The computing system, based at least in part upon the at least one execution behavior based upon a project leadership influence, may be further configured to functionally present the update update for consideration by the human operator utilizing the user interface operated by the computing system. The computing system, based at least in part upon the at least one execution behavior based upon a project leadership influence, may be further configured to incorporate instructions from the human operator pertaining to the presented update utilizing the user interface operated by the computing system, as the finite steps of the process configuration are continued. The user interface may be configured to allow the human operator to pause the computing system while it otherwise proceeds through the predetermined process configuration so that one or more intermediate results may be examined by the human operator pertaining to the established requirement. The user interface may be configured to allow the human operator to change one or more aspects of the one or more specific facts during the pause of the computing system to facilitate forward execution based upon the change. The user interface may be configured to provide the human operator with a calculated resourcing cost based at least in part upon utilization of the operatively coupled computing resources in the predetermined process configuration. The synthetic operator background configuration may comprise one or more selectable educational requirements. The one or more selectable educational requirements are based at least in part upon synthetic coursework pertaining to areas of formal study. The synthetic coursework pertaining to areas of formal study may be based at least in part upon education from a university setting. The areas of formal study may be based at least in part upon education from a university setting categorized in at least one conventional higher education paradigm. The at least one conventional higher education paradigm may comprise division of subject matter into one or more scientific and liberal arts subjects. The one or more scientific and liberal arts subjects may be selected from the group consisting of: a college of engineering, a school of law, a school of medicine, a college of arts and sciences, a school of nursing, a school of music, a school of architecture, a school of marine, atmospheric, and earth science, a school of communication, a trade school, and a school of safety, basics, and ethics. The one or more selectable educational requirements may comprise subject matter areas, the selectable inclusion of which imputes a level of knowledge to the given one or more synthetic operators. A given synthetic operator, having knowledge imputed via operator selectable inclusion, may be deemed to have a certification status to have a specific groups knowledge, experience, or skills which may thereafter be expected by a human operator selecting synthetic operators with such certification status. The user interface may be further configured to allow the human operator to select and interactively engage two or more synthetic operators operated by the computing system to collaboratively proceed through the predetermined process configuration, and to return a result to the human operator selected to at least partially satisfy the established requirement; wherein each of the two or more synthetic operators is informed by a convolutional neural network informed at least in part by historical actions of a particular actual human operator and a synthetic operator background configuration. The system may be configured to allow the human operator to specify that the two or more synthetic operators are different. The system may be configured to allow the human operator to specify that the two or more synthetic operators are the same and may be configured to collaboratively scale their productivity as they proceed through the predetermined process configuration. The two or more synthetic operators may be configured to automatically optimize their application as resources as they proceed through the predetermined process configuration. The system may be configured to utilize the two or more synthetic operators to produce an initial group of decision nodes pertinent to the established requirement based at least in part upon characteristics of the two or more synthetic operators. The system may be further configured to create a group of mediated decision nodes based upon the initial group of decision nodes. The system may be further configured to create a group of operative decision nodes based upon the group of mediated decision nodes. The two or more synthetic operators may be operated by the computing system to collaboratively proceed through the predetermined process configuration by sequencing through the operative decision nodes in furtherance of the established requirement. The two or more synthetic operators may comprise a plurality limited only by the operatively coupled computing resources.

Another embodiment is directed to a synthetic engagement method for process-based problem solving, comprising: providing a computing system comprising one or more operatively coupled computing resources; and providing a user interface operated by the computing system and configured to engage a human operator in accordance with a predetermined process configuration toward an established requirement based at least in part upon one or more specific facts; wherein the user interface is configured to allow the human operator to select and interactively engage one or more synthetic operators operated by the computing system to proceed through the predetermined process configuration, and to return a result to the human operator selected to at least partially satisfy the established requirement; and wherein each of the one or more synthetic operators is informed by a convolutional neural network informed at least in part by a combination of historical actions of a particular actual human operator and a synthetic operator background configuration. The one or more specific facts may be selected from the group consisting of: textual information, numeric data, audio information, video information, emotional state information, analog chaos input selection, activity perturbance selection, curiosity selection, memory configuration, learning model, filtration configuration, and encryption configuration. The one or more specific facts may comprise textual information pertaining to specific background information from historical storage. The one or more specific facts may comprise textual information pertaining to an actual operator. The one or more specific facts may comprise textual information pertaining to a synthetic operator. The specific facts may comprise a predetermined profile of specific facts developed as an initiation module for a specific synthetic operator profile. The one or more operatively coupled computing resources may comprise a local computing resource. The local computing resource may be selected from the group consisting of: a mobile computing resource, a desktop computing resource, a laptop computing resource, and an embedded computing resource. The local computing resource may comprise an embedded computing resource selected from the group consisting of: an embedded microcontroller, an embedded microprocessor, and an embedded gate array. The one or more operatively coupled computing resources may comprise resources selected from the group consisting of: a remote data center; a remote server; a remote computing cluster; and an assembly of computing systems in a remote location. The method further may comprise providing a localization element operatively coupled to the computing system and configured to determine a location of the human operator relative to a global coordinate system. The localization element may be selected from the group consisting of: a GPS sensor; an IP address detector; a connectivity triangulation detector; an electromagnetic localization sensor; an optical location sensor. The one or more operatively coupled computing resources may be activated based upon the determined location of the human operator. The user interface may comprise a graphical user interface. The user interface may comprise an audio user interface. The graphical user interface may be configured to engage the human operator using an element selected from the group consisting of: a computer graphics engagement display; a video graphics engagement display; and an audio engagement accompanied by displayed graphics. The graphical user interface may comprise a video graphics engagement display configured to present a real-time or near real-time graphical representation of a video interface engagement character with which the human operator may converse. The video interface engagement character may be selected from the group consisting of: a humanoid character, an animal character, and a cartoon character. The user interface may be configured to allow the human operator to select the visual presentation of the video interface engagement character. The user interface may be configured to allow the human operator to select a visual presentation characteristic of the video interface engagement character selected from the group consisting of: character gender, character hair color, character hair style, character skin tone, character eye coloration, and character shape. The visual presentation of the video interface engagement character may be modelled after a selected actual human. The user interface may be configured to allow the human operator to select one or more audio presentation aspects of the video interface engagement character. The user interface may be configured to allow the human operator to select one or more audio presentation aspects of the video interface engagement character selected from the group consisting of: character voice intonation; character voice loudness; character speaking language; character speaking dialect; and character voice dynamic range. The one or more audio presentation aspects of the video interface engagement character may be modelled after a selected actual human. The predetermined process configuration may comprise a finite group of steps through which the engagement shall proceed in furtherance of the established requirement. The predetermined process configuration may comprise a process element selected from the group consisting of: one or more generalized operating parameters; one or more resource/input awareness and utilitization settings; a domain expertise module; a process sequencing paradigm; a process cycling/iteration paradigm; and an AI utilization and configuration setting. The finite group of steps may comprise steps selected from the group consisting of: problem definition; potential solutions outline; preliminary design; and detailed design. The predetermined process configuration may comprise a selection of elements by the human operator. Selection of elements by the human operator may comprise selecting synthetic operator resourcing for one or more aspects of the predetermined process configuration. The system may be configured to allow the human operator to specify a particular resourcing for a first specific portion of the predetermined process configuration. The system may be configured to allow the human operator to specify a particular resourcing for a second specific portion of the predetermined process configuration that is different from the particular resourcing for the first specific portion of the predetermined process configuration. The system may be configured to allow the human operator to specify a particular resourcing for a first specific portion of the predetermined process configuration that is based upon a plurality of synthetic operator characters. Each of the plurality of synthetic operator characters may be applied to the first specific portion sequentially. Each of the plurality of synthetic operator characters may be applied to the first specific portion simultaneously. The system may be configured to allow the human operator to specify a particular resourcing for a first specific portion of the predetermined process configuration that is based upon one or more hybrid synthetic operator characters. The one or more hybrid synthetic operator characters may comprise a combination of otherwise separate synthetic operator characters which may be applied to the first specific portion simultaneously. The convolutional neural network may be informed using inputs from a training dataset comprising data pertaining to the historical actions of the particular actual human operator. The convolutional neural network may be informed using inputs from a training dataset using a supervised learning model. The convolutional neural network may be informed using inputs from a training dataset along with analysis of the established requirement using a reinforcement learning model. Each of the one or more synthetic operators may be informed by a convolutional neural network informed at least in part by a curated selection of synthetic action records pertaining to synthetic actions of an actual human operator. Each of the one or more synthetic operators may be informed by a convolutional neural network informed at least in part by a curated selection of synthetic action records pertaining to synthetic actions of a synthetic operator. The computing system may be configured to separate each of the finite group of steps with an execution step during which the one or more synthetic operators are configured to progress toward the established requirement in accordance with one or more execution behaviors associated with the pertinent convolutional neural network. At least one of the one or more execution behaviors may be based upon a project leadership influence on the pertinent convolutional neural network. The computing system, based at least in part upon the at least one execution behavior based upon a project leadership influence, may be configured to divide the execution step into a plurality of tasks which may be addressed by the available resources in furtherance of the established requirement. The computing system, based at least in part upon the at least one execution behavior based upon a project leadership influence, may be further configured to project manage accomplishment of the plurality of tasks toward one or more milestones in pursuit of the established requirement. The computing system, based at least in part upon the at least one execution behavior based upon a project leadership influence, may be further configured to functionally provide an update pertaining to accomplishment of the plurality of tasks at one or more stages of the execution step. The computing system, based at least in part upon the at least one execution behavior based upon a project leadership influence, may be further configured to functionally provide an update pertaining to accomplishment of the plurality of tasks at the end of each executing step for consideration in each of the finite group of steps in the process configuration. The computing system, based at least in part upon the at least one execution behavior based upon a project leadership influence, may be further configured to functionally present the update update for consideration by the human operator utilizing the user interface operated by the computing system. The computing system, based at least in part upon the at least one execution behavior based upon a project leadership influence, may be further configured to incorporate instructions from the human operator pertaining to the presented update utilizing the user interface operated by the computing system, as the finite steps of the process configuration are continued. The user interface may be configured to allow the human operator to pause the computing system while it otherwise proceeds through the predetermined process configuration so that one or more intermediate results may be examined by the human operator pertaining to the established requirement. The user interface may be configured to allow the human operator to change one or more aspects of the one or more specific facts during the pause of the computing system to facilitate forward execution based upon the change. The user interface may be configured to provide the human operator with a calculated resourcing cost based at least in part upon utilization of the operatively coupled computing resources in the predetermined process configuration. The synthetic operator background configuration may comprise one or more selectable educational requirements. The one or more selectable educational requirements are based at least in part upon synthetic coursework pertaining to areas of formal study. The synthetic coursework pertaining to areas of formal study may be based at least in part upon education from a university setting. The areas of formal study may be based at least in part upon education from a university setting categorized in at least one conventional higher education paradigm. The at least one conventional higher education paradigm may comprise division of subject matter into one or more scientific and liberal arts subjects. The one or more scientific and liberal arts subjects may be selected from the group consisting of: a college of engineering, a school of law, a school of medicine, a college of arts and sciences, a school of nursing, a school of music, a school of architecture, a school of marine, atmospheric, and earth science, a school of communication, a trade school, and a school of safety, basics, and ethics. The one or more selectable educational requirements may comprise subject matter areas, the selectable inclusion of which imputes a level of knowledge to the given one or more synthetic operators. A given synthetic operator, having knowledge imputed via operator selectable inclusion, may be deemed to have a certification status to have a specific groups knowledge, experience, or skills which may thereafter be expected by a human operator selecting synthetic operators with such certification status. The user interface may be further configured to allow the human operator to select and interactively engage two or more synthetic operators operated by the computing system to collaboratively proceed through the predetermined process configuration, and to return a result to the human operator selected to at least partially satisfy the established requirement; wherein each of the two or more synthetic operators is informed by a convolutional neural network informed at least in part by historical actions of a particular actual human operator and a synthetic operator background configuration. The system may be configured to allow the human operator to specify that the two or more synthetic operators are different. The system may be configured to allow the human operator to specify that the two or more synthetic operators are the same and may be configured to collaboratively scale their productivity as they proceed through the predetermined process configuration. The two or more synthetic operators may be configured to automatically optimize their application as resources as they proceed through the predetermined process configuration. The system may be configured to utilize the two or more synthetic operators to produce an initial group of decision nodes pertinent to the established requirement based at least in part upon characteristics of the two or more synthetic operators. The method may be further configured to create a group of mediated decision nodes based upon the initial group of decision nodes. The method may be further configured to create a group of operative decision nodes based upon the group of mediated decision nodes. The two or more synthetic operators may be operated by the computing system to collaboratively proceed through the predetermined process configuration by sequencing through the operative decision nodes in furtherance of the established requirement. The two or more synthetic operators may comprise a plurality limited only by the operatively coupled computing resources.

### DETAILED DESCRIPTION

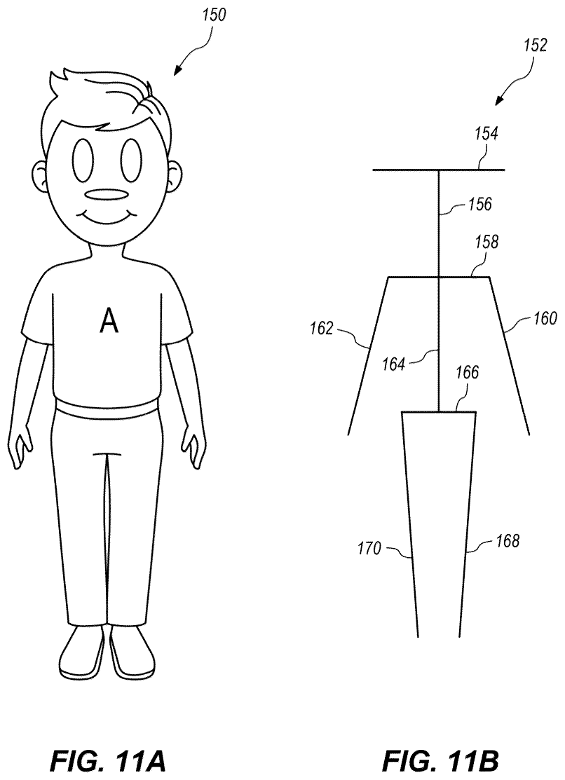

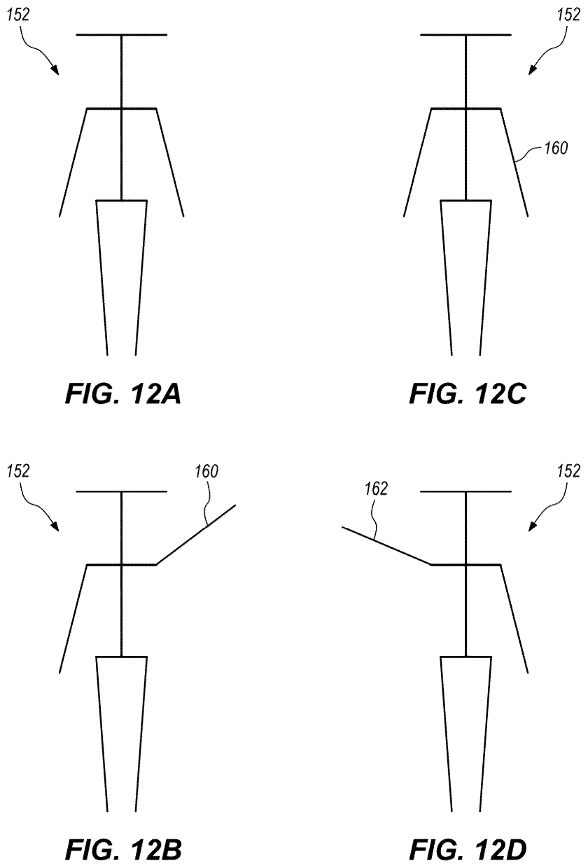

Referring to FIGS. 11A-16, a relatively simple challenge of creating a colorized cartoon is utilized to illustrate a synthetic operator configuration whereby a user may harness significant computing resources to address a challenge.

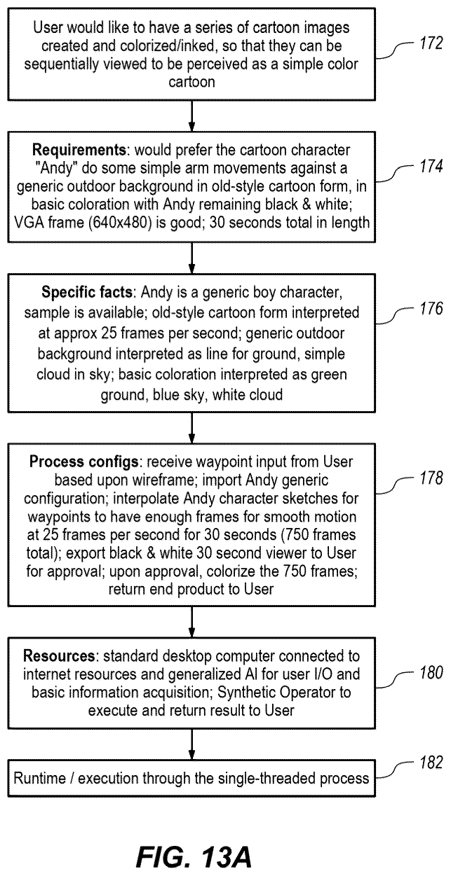

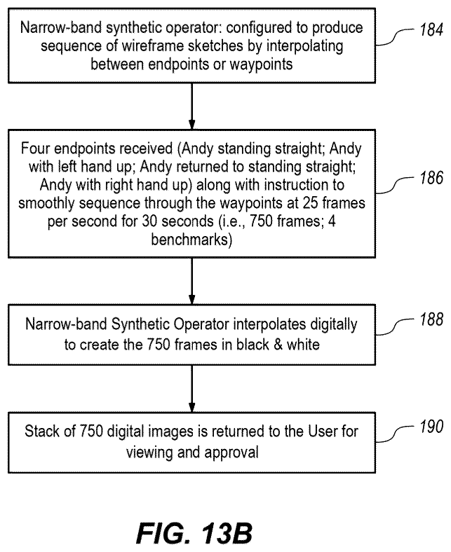

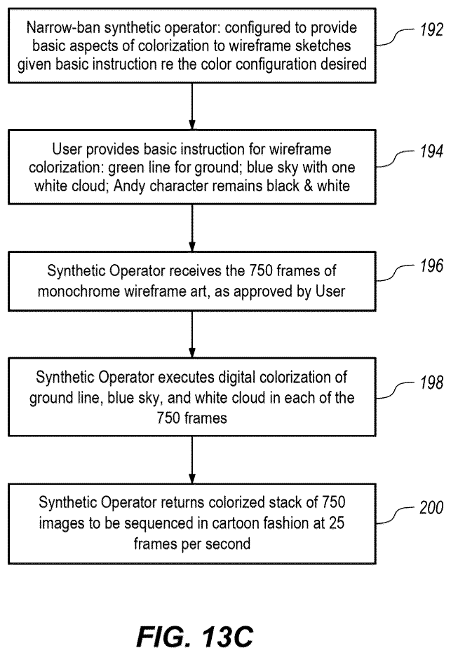

Referring to FIG. 11A, an “Andy” cartoon character (150) is illustrated comprising a relatively simple wireframe drawing. Referring to FIG. 11B, the basic structure of the character may be represented using a stick-figure or group of segments aggregation (152), with segments to represent positioning of the character's head (154), neck (156), shoulders (158), left arm (160), right arm (162), torso (164), hips (166), left leg (168), and right leg (170). Referring to FIGS. 12A-12D, for example, a very simple cartoon sequence may comprise a series of views of the character (150) standing straight, raising a right hand (160), lowering the right hand, and then raising the left hand (162). Indeed, referring to FIG. 13A, let's assume that a user would like to have a computing system automatically produce a series of cartoon images, and to colorize these images, so that they may be sequentially viewed to be perceived as a simple color cartoon (172). The user may provide requirements such that the user would prefer the cartoon character “Andy” do some simple arm movements against a generic outdoor background in “old-style cartoon form”, in “basic coloration” with Andy remaining black & white; “VGA frame (640×480) is good”; “30 seconds total in length” (174). The computing system may be configured to have certain specific facts from input and conducted searching, such as: “Andy” is a generic boy character, and a sample is available from searching; “old-style cartoon” form may be interpreted from other searched references to be at approximately 25 frames per second; a “generic outdoor background” may be interpreted based upon available benchmarks as a line for the cartoon ground, with a simple cloud in sky; “basic coloration” for these may be interpreted based upon similar reference benchmarking as green ground, blue sky, white cloud (176). The system may be configured with certain process configuration to address the challenge, such as: utilizing a stick figure type of configuration and waypoints or benchmarks developed from the user instructions; importing an Andy generic configuration; interpolating Andy character sketches for waypoints to have enough frames for smooth motion at 25 frames per second for 30 seconds (750 frames total); exporting a black & white 30 second viewer to the user for approval; upon approval, colorizing the 750 frames, and returning end product to user (178). The system may be provided with resources such as a standard desktop computer connected to internet resources, a generalized AI for user communication and basic information acquisition, and a synthetic operator configuration designed to execute and return a result to the user (180). By utilizing such instructions, requirements, facts, process configurations, and resources, the synthetic operator may be configured to work through a sequence, such as a single-threaded type of sequence as illustrated herein, to execute at runtime and return a result (182).

Referring to FIGS. 13B and 13C, operation of the illustrative synthetic operator may be broken down more granularly. For example, the challenge may be addressed by selecting a first relatively “narrow band” synthetic operator operatively coupled to the computing resources, which may be configured through training (such as via training of a neural network) to do not much more than (i.e., narrow training/narrow band; i.e., such configuration may only be capable of the functional skills to do this type of narrow task based upon training) produce sequences of wireframe sketches of simple characters such as Andy by interpolating between endpoints or waypoints (184). Four endpoints may be received (Andy standing straight; Andy with left hand up; Andy returned to standing straight; Andy with right hand up) along with instruction to smoothly sequence through the waypoints at 25 frames per second for 30 seconds (i.e., 750 frames; 4 benchmarks) (186). The narrow band synthetic operator may be configured to simply interpolate (i.e., average between) digitally to create the 750 frames in black and white (188). The synthetic operator may be configured to return to the user the stack of 750 black and white digital images for viewing and approval (190).

Referring to FIG. 13C, after approval of the images from FIG. 13A (190), a different narrow band synthetic operator, trained, for example, only to simply provide the most basic colorization of wireframe sketches based upon simple inputs, may be utilized to execute (198) colorization of the images (192) using the provided basic inputs (194) and black and white wireframes (196), and to return the result to the user (200).

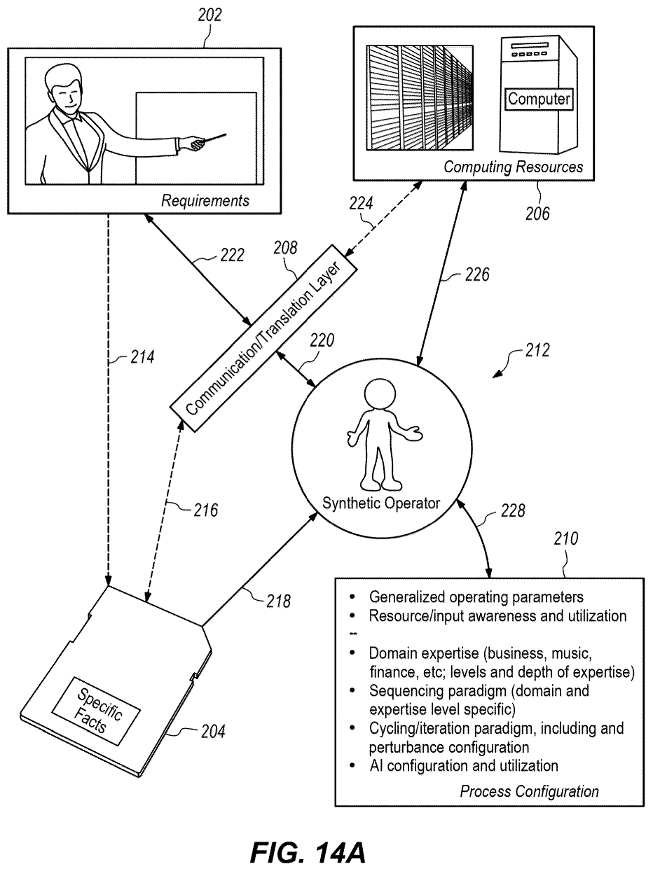

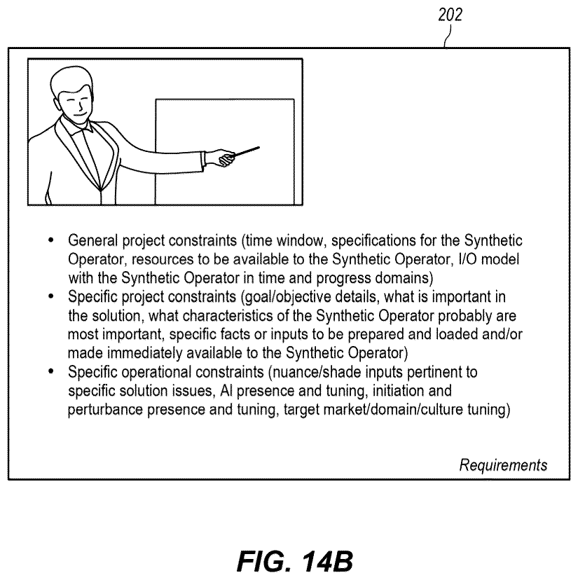

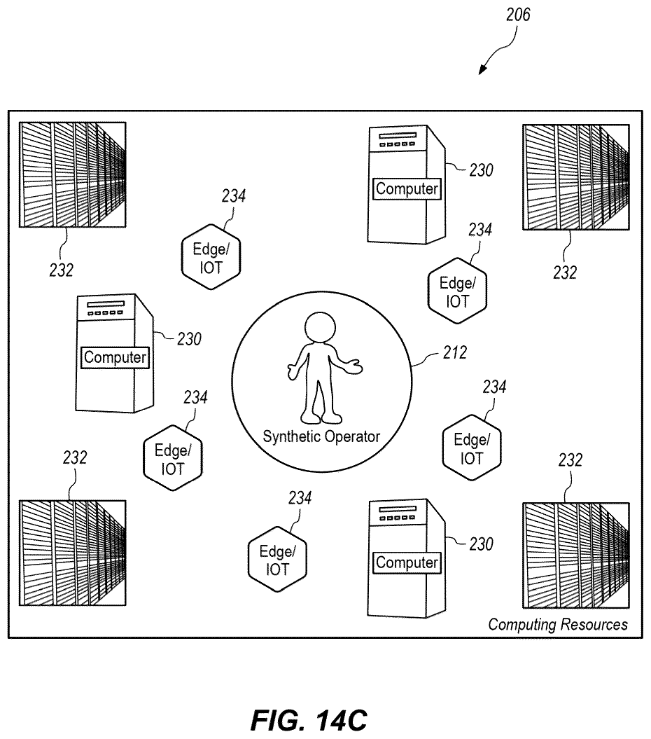

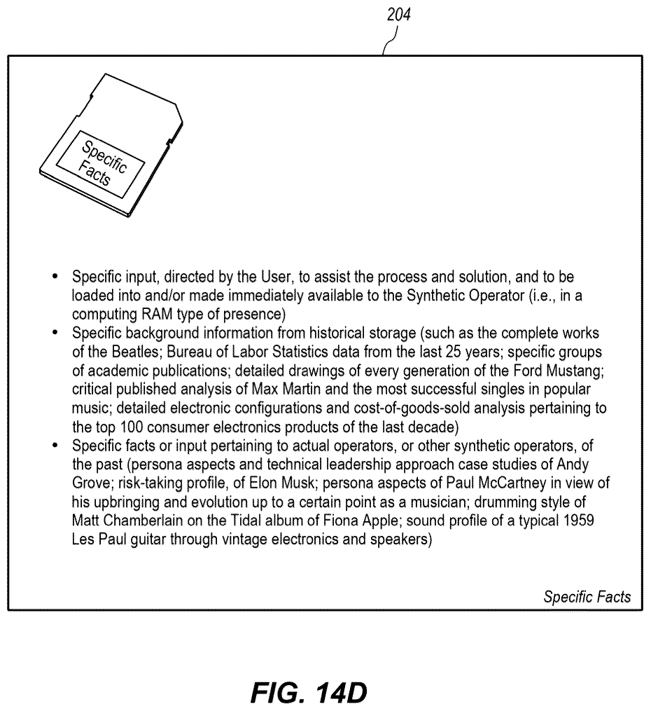

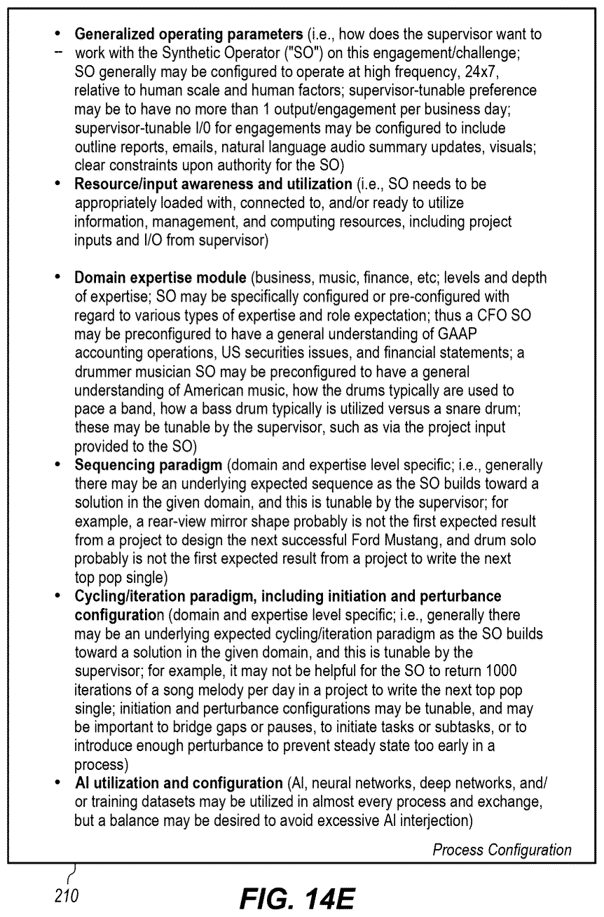

Thus referring to FIG. 14A, a synthetic operator (212) may be thought of and presented to a human user via a user interface as a synthetic character with certain human-like capabilities, depending upon the configuration and challenge, which may be configured to communicate (208) with a user, such as via natural language generalized AI for spoken instructions, typed instructions, direct computing interface-based commands, and the like. An associated system may be configured to assist the user in providing requirements (202) pertaining to a challenge, providing specific facts (204) pertaining to the challenge, to be intercoupled with computing resources (206), and to receive certain process configurations (210) pertinent to the challenge.

One embodiment related, for example, to that illustrated in FIG. 14A, for example, may comprise a synthetic engagement system for process-based problem solving, comprising: a computing system comprising one or more operatively coupled computing resources; and a user interface operated by the computing system and configured to engage a human operator in accordance with a predetermined process configuration toward an established requirement based at least in part upon one or more specific facts; wherein the user interface is configured to allow the human operator to select and interactively engage one or more synthetic operators operated by the computing system to proceed through the predetermined process configuration, and to return a result to the human operator selected to at least partially satisfy the established requirement; and wherein each of the one or more synthetic operators is informed by a convolutional neural network informed at least in part by historical actions of a particular actual human operator. The one or more specific facts may be selected from the group consisting of: textual information, numeric data, audio information, video information, emotional state information, analog chaos input selection, activity perturbance selection, curiosity selection, memory configuration, learning model, filtration configuration, and encryption configuration. The one or more specific facts may comprise textual information pertaining to specific background information from historical storage. The one or more specific facts may comprise textual information pertaining to an actual operator. The one or more specific facts may comprise textual information pertaining to a synthetic operator. The specific facts may comprise a predetermined profile of specific facts developed as an initiation module for a specific synthetic operator profile. The one or more operatively coupled computing resources may comprise a local computing resource. The local computing resource may be selected from the group consisting of: a mobile computing resource, a desktop computing resource, a laptop computing resource, and an embedded computing resource. The local computing resource may comprise an embedded computing resource selected from the group consisting of: an embedded microcontroller, an embedded microprocessor, and an embedded gate array. The one or more operatively coupled computing resources may comprise resources selected from the group consisting of: a remote data center; a remote server; a remote computing cluster; and an assembly of computing systems in a remote location. The system further may comprise a localization element operatively coupled to the computing system and configured to determine a location of the human operator relative to a global coordinate system. The localization element may be selected from the group consisting of: a GPS sensor; an IP address detector; a connectivity triangulation detector; an electromagnetic localization sensor; an optical location sensor. The one or more operatively coupled computing resources may be activated based upon the determined location of the human operator. The user interface may comprise a graphical user interface. The user interface may comprise an audio user interface. The graphical user interface may be configured to engage the human operator using an element selected from the group consisting of: a computer graphics engagement display; a video graphics engagement display; and an audio engagement accompanied by displayed graphics. The graphical user interface may comprise a video graphics engagement display configured to present a real-time or near real-time graphical representation of a video interface engagement character with which the human operator may converse. The video interface engagement character may be selected from the group consisting of: a humanoid character, an animal character, and a cartoon character. The user interface may be configured to allow the human operator to select the visual presentation of the video interface engagement character. The user interface may be configured to allow the human operator to select a visual presentation characteristic of the video interface engagement character selected from the group consisting of: character gender, character hair color, character hair style, character skin tone, character eye coloration, and character shape. The visual presentation of the video interface engagement character may be modelled after a selected actual human. The user interface may be configured to allow the human operator to select one or more audio presentation aspects of the video interface engagement character. The user interface may be configured to allow the human operator to select one or more audio presentation aspects of the video interface engagement character selected from the group consisting of: character voice intonation; character voice loudness; character speaking language; character speaking dialect; and character voice dynamic range. The one or more audio presentation aspects of the video interface engagement character may be modelled after a selected actual human. The predetermined process configuration may comprise a finite group of steps through which the engagement shall proceed in furtherance of the established requirement. The predetermined process configuration may comprise a process element selected from the group consisting of: one or more generalized operating parameters; one or more resource/input awareness and utilitization settings; a domain expertise module; a process sequencing paradigm; a process cycling/iteration paradigm; and an AI utilization and configuration setting. The finite group of steps may comprise steps selected from the group consisting of: problem definition; potential solutions outline; preliminary design; and detailed design. The predetermined process configuration may comprise a selection of elements by the human operator. Selection of elements by the human operator may comprise selecting synthetic operator resourcing for one or more aspects of the predetermined process configuration. The system may be configured to allow the human operator to specify a particular resourcing for a first specific portion of the predetermined process configuration. The system may be configured to allow the human operator to specify a particular resourcing for a second specific portion of the predetermined process configuration that is different from the particular resourcing for the first specific portion of the predetermined process configuration. The system may be configured to allow the human operator to specify a particular resourcing for a first specific portion of the predetermined process configuration that is based upon a plurality of synthetic operator characters. Each of the plurality of synthetic operator characters may be applied to the first specific portion sequentially. Each of the plurality of synthetic operator characters may be applied to the first specific portion simultaneously. The system may be configured to allow the human operator to specify a particular resourcing for a first specific portion of the predetermined process configuration that is based upon one or more hybrid synthetic operator characters. The one or more hybrid synthetic operator characters may comprise a combination of otherwise separate synthetic operator characters which may be applied to the first specific portion simultaneously. The convolutional neural network may be informed using inputs from a training dataset comprising data pertaining to the historical actions of the particular actual human operator. The convolutional neural network may be informed using inputs from a training dataset using a supervised learning model. The convolutional neural network may be informed using inputs from a training dataset along with analysis of the established requirement using a reinforcement learning model. Each of the one or more synthetic operators may be informed by a convolutional neural network informed at least in part by a curated selection of synthetic action records pertaining to synthetic actions of an actual human operator. Each of the one or more synthetic operators may be informed by a convolutional neural network informed at least in part by a curated selection of synthetic action records pertaining to synthetic actions of a synthetic operator. The computing system may be configured to separate each of the finite group of steps with an execution step during which the one or more synthetic operators are configured to progress toward the established requirement in accordance with one or more execution behaviors associated with the pertinent convolutional neural network. At least one of the one or more execution behaviors may be based upon a project leadership influence on the pertinent convolutional neural network. The computing system, based at least in part upon the at least one execution behavior based upon a project leadership influence, may be configured to divide the execution step into a plurality of tasks which may be addressed by the available resources in furtherance of the established requirement. The computing system, based at least in part upon the at least one execution behavior based upon a project leadership influence, may be further configured to project manage accomplishment of the plurality of tasks toward one or more milestones in pursuit of the established requirement. The computing system, based at least in part upon the at least one execution behavior based upon a project leadership influence, may be further configured to functionally provide an update pertaining to accomplishment of the plurality of tasks at one or more stages of the execution step. The computing system, based at least in part upon the at least one execution behavior based upon a project leadership influence, may be further configured to functionally provide an update pertaining to accomplishment of the plurality of tasks at the end of each executing step for consideration in each of the finite group of steps in the process configuration. The computing system, based at least in part upon the at least one execution behavior based upon a project leadership influence, may be further configured to functionally present the update update for consideration by the human operator utilizing the user interface operated by the computing system. The computing system, based at least in part upon the at least one execution behavior based upon a project leadership influence, may be further configured to incorporate instructions from the human operator pertaining to the presented update utilizing the user interface operated by the computing system, as the finite steps of the process configuration are continued. The user interface may be configured to allow the human operator to pause the computing system while it otherwise proceeds through the predetermined process configuration so that one or more intermediate results may be examined by the human operator pertaining to the established requirement. The user interface may be configured to allow the human operator to change one or more aspects of the one or more specific facts during the pause of the computing system to facilitate forward execution based upon the change. The user interface may be configured to provide the human operator with a calculated resourcing cost based at least in part upon utilization of the operatively coupled computing resources in the predetermined process configuration.

FIGS. 14B-14E illustrate further detail regarding various of these components, in relation to various hypothetical problem or challenge scenarios. For example, referring to FIG. 14B, requirements (202) from a user to a synthetic operator may comprise: general project constraints (time window, specifications for the synthetic operator, resources to be available to the synthetic operator, I/O, interaction, or communications model with the synthetic operator in time and progress domains); specific project constraints (goal/objective details, what is important in the solution, what characteristics of the synthetic operator probably are most important, specific facts or inputs to be prepared and loaded and/or made immediately available to the synthetic operator); and specific operational constraints (nuance/shade inputs pertinent to specific solution issues, AI presence and tuning, initiation and perturbance presence and tuning, target market/domain/culture tuning).

Referring to FIG. 14C, intercoupled resources (206) may comprise one or more desktop or laptop type computing systems (230), one or more interconnected data center type computing assemblies (232), as well as smaller computing systems such as those utilized in mobile systems or “edge” or “internet of things” (IOT) (234) computing configurations.

Referring to FIG. 14D, specific facts (204) provided may, for example, include specific input, directed by the user, to assist the process and solution, and to be loaded into and/or made immediately available to the synthetic operator (i.e., in a computing RAM type of presence); specific background information from historical storage (such as the complete works of the Beatles; Bureau of Labor Statistics data from the last 25 years; specific groups of academic publications; detailed drawings of every generation of the Ford Mustang; critical published analysis of Max Martin and the most successful singles in popular music; detailed electronic configurations and cost-of-goods-sold analysis pertaining to the top 100 consumer electronics products of the last decade); and specific facts or input pertaining to actual operators, or other synthetic operators, of the past (persona aspects and technical leadership approach case studies of Andy Grove; risk-taking profile of Elon Musk; persona aspects of Paul Mccartney in view of his upbringing and evolution up to a certain point as a musician; drumming style of Matt Chamberlain on the Tidal album of Fiona Apple; sound profile of a typical 1959 Les Paul guitar through vintage electronics and speakers).

Referring to FIG. 14E, process configuration (210) directed by the user and/or a supervisory role may, for example, include: generalized operating parameters (i.e., how does the supervisor want to work with the synthetic operator (“SO”) on this engagement/challenge; SO generally may be configured to operate at high frequency, 24×7, relative to human scale and human factors; supervisor-tunable preference may be to have no more than 1 output/engagement per business day; supervisor-tunable I/O for engagements may be configured to include outline reports, emails, natural language audio summary updates, visuals; clear constraints upon authority for the SO); resource/input awareness and utilization (i.e., SO needs to be appropriately loaded with, connected to, and/or ready to utilize information, management, and computing resources, including project inputs and I/O from supervisor); a domain expertise module (business, music, finance, etc; levels and depth of expertise; SO may be specifically configured or pre-configured with regard to various types of expertise and role expectation; thus a CFO SO may be preconfigured to have a general understanding of GAAP accounting operations, US securities issues, and financial statements; a drummer musician SO may be preconfigured to have a general understanding of American music, how the drums typically are used to pace a band, how a bass drum typically is utilized versus a snare drum; these may be tunable by the supervisor, such as via the project input provided to the SO); a sequencing paradigm (domain and expertise level specific; i.e., generally there may be an underlying expected sequence as the SO builds toward a solution in the given domain, and this is tunable by the supervisor; for example, a rear-view mirror shape probably is not the first expected result from a project to design the next successful Ford Mustang, and drum solo probably is not the first expected result from a project to write the next top pop single); a cycling/iteration paradigm, including initiation and perturbance configuration (domain and expertise level specific; i.e., generally there may be an underlying expected cycling/iteration paradigm as the SO builds toward a solution in the given domain, and this is tunable by the supervisor; for example, it may not be helpful for the SO to return 1000 iterations of a song melody per day in a project to write the next top pop single; initiation and perturbance configurations may be tunable, and may be important to bridge gaps or pauses, to initiate tasks or subtasks, or to introduce enough perturbance to prevent steady state too early in a process); and/or AI utilization and configuration (AI, neural networks, deep networks, and/or training datasets may be utilized in almost every process and exchange, but a balance may be desired to avoid excessive AI interjection).

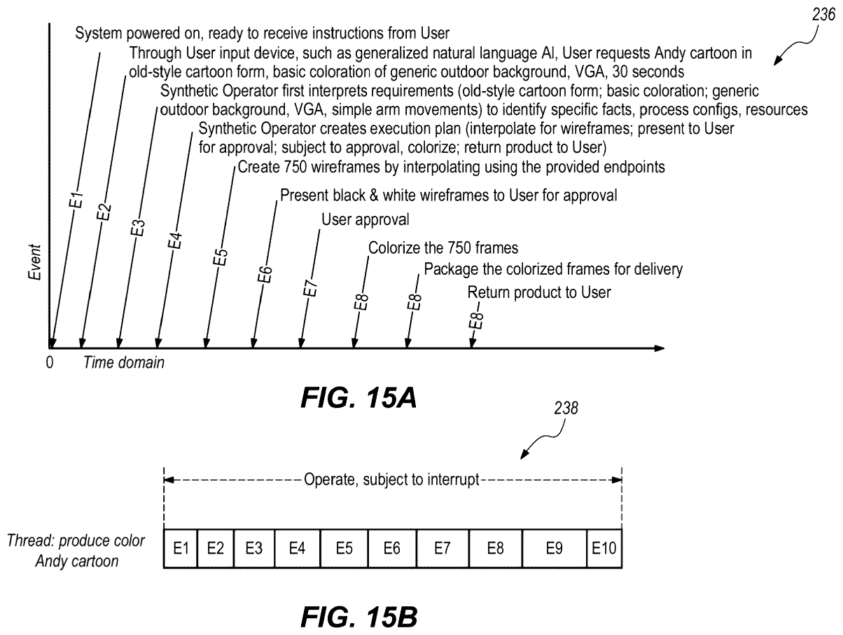

Referring to FIG. 15A, an event flow (236) is illustrated for the associated cartoon challenge, wherein a sequence of events (E1-E10) may be utilized to march sequentially through the process of returning a colorized image stack to a user for presentation as a short cartoon.

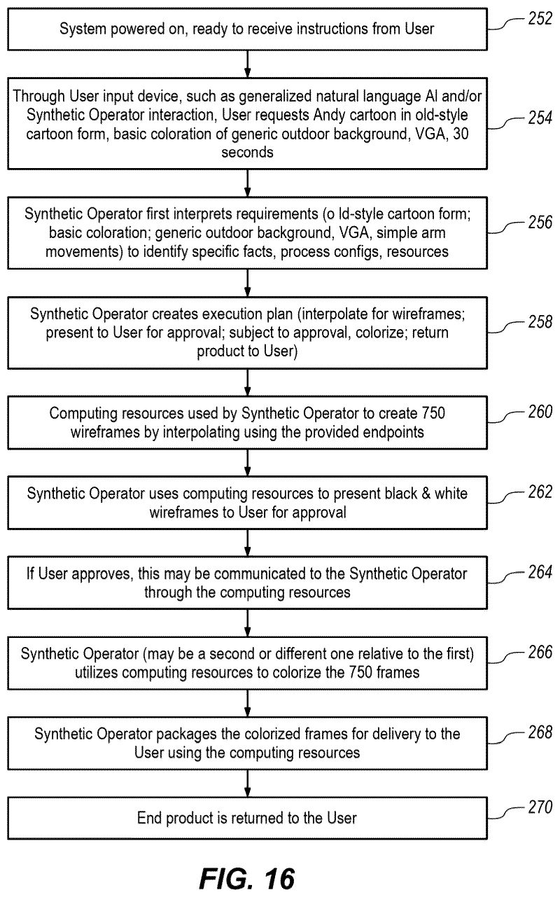

FIG. 15B illustrates a related simplified event sequence (238) to again show that the cartoon challenge may be accomplished through a series of smaller challenges, and with the engagement of an appropriately resourced and instructed synthetic operator, in an efficient manner. For example, referring to FIG. 16, specific engagement steps of a synthetic operator are shown. A synthetic operator integrated system may be powered on, ready to receive instructions from a user (252). Through a user input device, such as generalized natural language AI and/or other synthetic operator communications interaction, the user may request an

Andy cartoon in old-style cartoon form, with basic coloration of generic outdoor background, VGA, for about 30 seconds (254). The synthetic operator may be configured to interpret the requirements (old-style cartoon form; basic coloration; generic outdoor background, VGA, simple arm movements) and to identify specific facts, process configs, and resources (256). The synthetic operator may be configured to create an execution plan (interpolate for wireframes; present to user for approval; subject to approval, colorize; return product to user) (258). The computing resources may be used by the synthetic operator to create 750 wireframes by interpolating using provided endpoints (260). The synthetic operator may use intercoupled computing resources to present black and white wireframes to the user for approval (262). If the user approves, such approval may be communicated to the synthetic operator, such as through the intercoupled computing resources (264). The synthetic operator (may be a different synthetic operator better suited to the particular task) may utilize the intercoupled computing resources to colorize the 750 frames (266) and package them for delivery to the user (268) as the returned end product (270).

Thus a synthetic operator configuration may be utilized to execute upon certain somewhat complex instructions to return a result to a user through usage of appropriately trained, informed, and resourced computing systems.

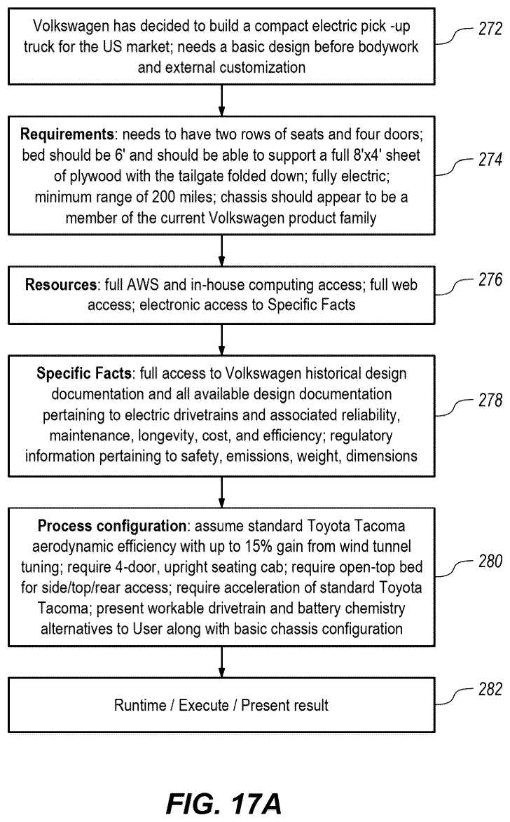

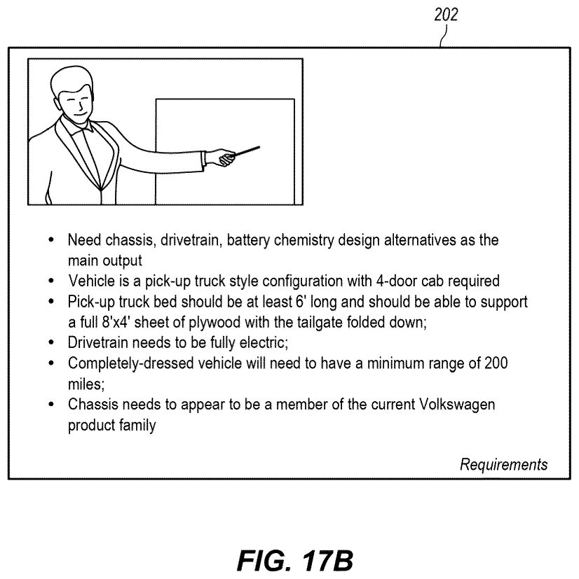

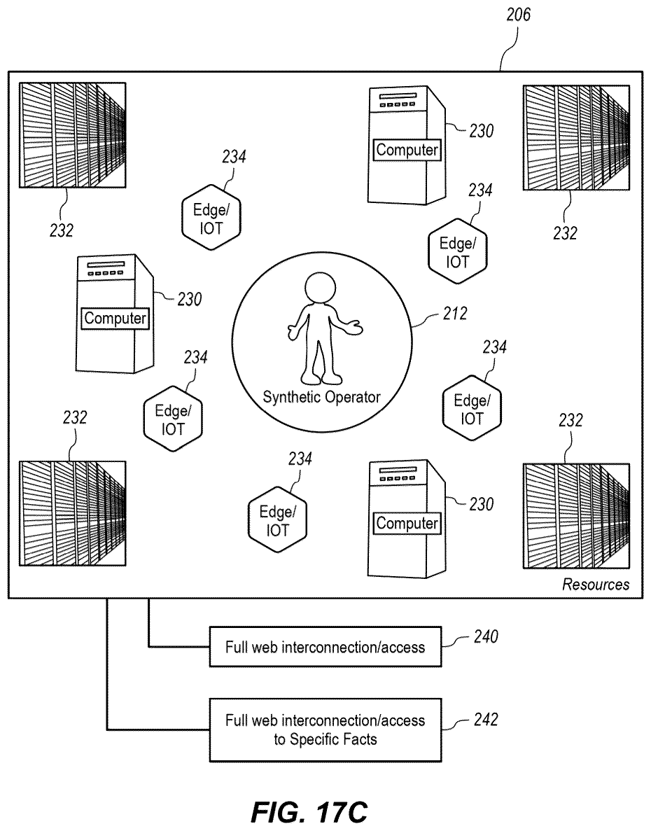

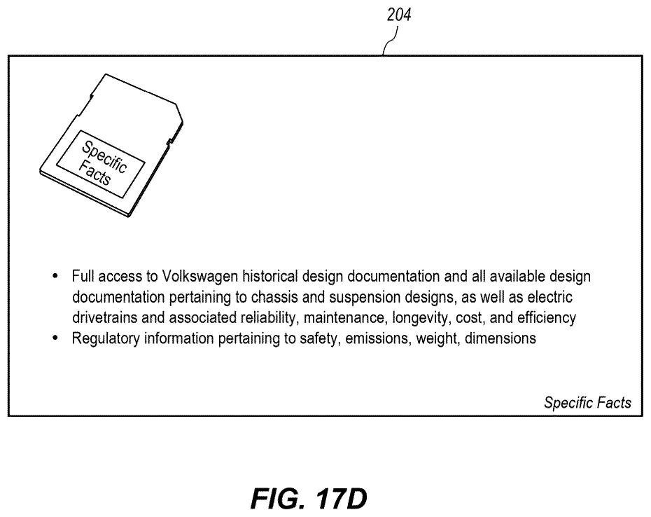

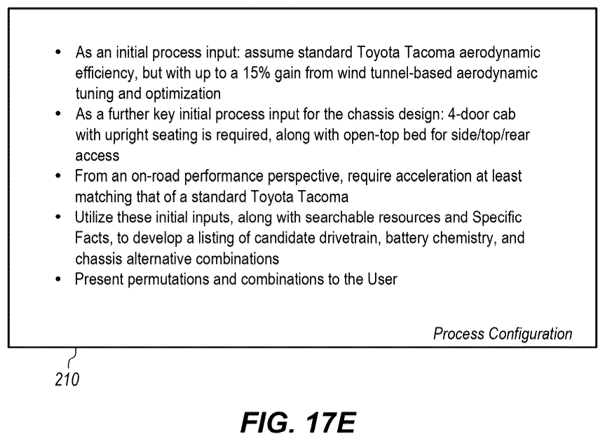

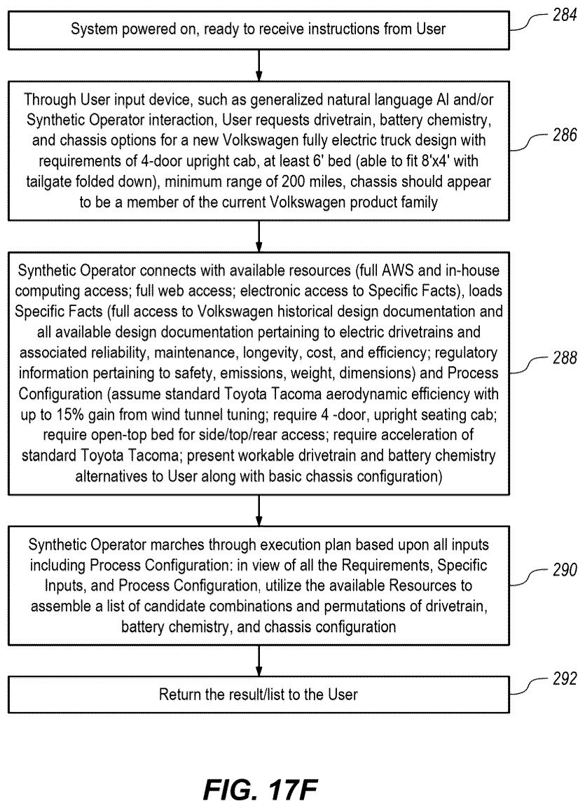

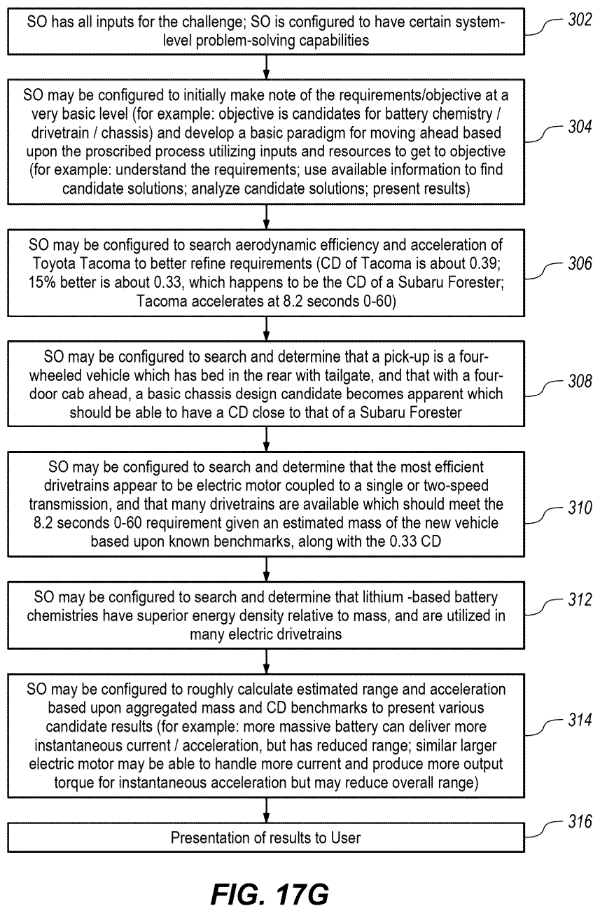

Referring to FIGS. 17A-17G, another illustrative example is shown utilizing a synthetic operator configuration to execute upon a challenge which might conventionally be the domain of a mechanical or systems engineer. As shown in FIG. 17A, in such scenario, Volkswagen has decided to build a compact electric pick-up truck for the US market, and needs a basic design before bodywork and external customization (272). Requirements may be provided, such as: the vehicle needs to have two rows of seats and four doors; bed should be 6′ and should be able to support a full 8′×4′ sheet of plywood with the tailgate folded down; fully electric; minimum range of 200 miles; chassis should appear to be a member of the current Volkswagen product family (274). Resources may be dictated and provided, such as: a full access to a data or computing center, such as AWS; access to the internet; and electronic access to pertinent specific facts (276). Specific facts may be provided, such as: full access to Volkswagen historical design documentation and all available design documentation pertaining to electric drivetrains and associated reliability, maintenance, longevity, cost, and efficiency; regulatory information pertaining to safety, emissions, weight, dimensions (278). Process configuration may be provided, such as: assume standard Toyota Tacoma aerodynamic efficiency with up to 15% gain from wind tunnel tuning; require 4-door, upright seating cab; require open-top bed for side/top/rear access; require acceleration of standard Toyota Tacoma; present workable drivetrain and battery chemistry alternatives to User along with basic chassis configuration (280). Finally, the system may be configured to utilize these inputs and resources at runtime to execute and present a result (282). Referring to FIG. 17B, requirements (202) from the user may include, for example: need chassis, drivetrain, battery chemistry design alternatives as the main output; vehicle is a pick-up truck style configuration with 4-door cab required; pick-up truck bed should be at least 6′ long and should be able to support a full 8′×4′ sheet of plywood with the tailgate folded down; drivetrain needs to be fully electric; completely-dressed vehicle will need to have a minimum range of 200 miles; chassis needs to appear to be a member of the current Volkswagen product family.

Referring to FIG. 17C, computing resources (206) may include intercoupled data center (232), desktop (230), and edge/IOT type systems, as well as intercoupled access to the internet/web (240) and electronic access to particular specific facts data (242).

Referring to FIG. 17D, specific facts (204) for the particular challenge may include: full access to Volkswagen historical design documentation and all available design documentation pertaining to chassis and suspension designs, as well as electric drivetrains and associated reliability, maintenance, longevity, cost, and efficiency; and regulatory information pertaining to safety, emissions, weight, dimensions.

Referring to FIG. 17E, process configuration (210) for the particular challenge may include: as an initial process input, assume standard Toyota Tacoma aerodynamic efficiency, but with up to a 15% gain from wind tunnel-based aerodynamic tuning and optimization; as a further key initial process input for the chassis design: 4-door cab with upright seating is required, along with open-top bed for side/top/rear access; from an on-road performance perspective, require acceleration at least matching that of a standard Toyota Tacoma; utilize these initial inputs, along with searchable resources and specific facts, to develop a listing of candidate drivetrain, battery chemistry, and chassis alternative combinations; present permutations and combinations to the user.

Thus referring to the process flow of FIG. 17F, a synthetic operator capable system may be powered on, ready to receive instructions from a user (284). Through one or more user input devices, such as a generalized natural language AI and/or other synthetic operator interaction, the user may request drivetrain, battery chemistry, and chassis options for a new Volkswagen fully electric truck design with requirements of 4-door upright cab, at least 6′ bed (able to fit 8′×4′ with tailgate folded down), minimum range of 200 miles, chassis should appear to be a member of the current Volkswagen product family (286). The synthetic operator may be configured to connect with available resources (full AWS and in-house computing access; full web access; electronic access to Specific Facts), loads Specific Facts (full access to Volkswagen historical design documentation and all available design documentation pertaining to electric drivetrains and associated reliability, maintenance, longevity, cost, and efficiency; regulatory information pertaining to safety, emissions, weight, dimensions) and Process Configuration (assume standard Toyota Tacoma aerodynamic efficiency with up to 15% gain from wind tunnel tuning; require 4-door, upright seating cab; require open-top bed for side/top/rear access; require acceleration of standard Toyota Tacoma; present workable drivetrain and battery chemistry alternatives to User along with basic chassis configuration) (288). The synthetic operator may be configured to march through the execution plan based upon all inputs including the process configuration; in view of all the requirements, specific inputs, and process configuration, utilize the available resources to assemble a list of candidate combinations and permutations of drivetrain, battery chemistry, and chassis configuration (290). Finally the system may be configured to return the result to the user (292).

Referring to FIG. 17G, a synthetic operator (“SO”) centric flow is illustrated for the challenge. Having all inputs for the particular challenge, the SO may be configured to have certain system-level problem-solving capabilities (302). The SO may be configured to initially make note of the requirements/objective at a very basic level (for example: objective is candidates for battery chemistry/drivetrain/chassis) and develop a basic paradigm for moving ahead based upon the proscribed process utilizing inputs and resources to get to objective (for example: understand the requirements; use available information to find candidate solutions; analyze candidate solutions; present results) (304). The SO may be configured to search aerodynamic efficiency and acceleration of Toyota Tacoma to better refine requirements (CD of Tacoma is about 0.39; 15% better is about 0.33, which happens to be the CD of a Subaru Forester; Tacoma accelerates at 8.2 seconds 0-60) (306). The SO may be configured to search and determine that a pick-up is a four-wheeled vehicle which has bed in the rear with tailgate, and that with a four-door cab ahead, a basic chassis design candidate becomes apparent which should be able to have a CD close to that of a Subaru Forester (308). The SO may be configured to search and determine that the most efficient drivetrains appear to be electric motor coupled to a single or two-speed transmission, and that many drivetrains are available which should meet the 8.2 seconds 0-60 requirement given an estimated mass of the new vehicle based upon known benchmarks, along with the 0.33 CD (310). The SO may be configured to to search and determine that lithium-based battery chemistries have superior energy density relative to mass, and are utilized in many electric drivetrains (312). The SO may be configured to roughly calculate estimated range and acceleration based upon aggregated mass and CD benchmarks to present various candidate results (for example: more massive battery can deliver more instantaneous current/acceleration, but has reduced range; similar larger electric motor may be able to handle more current and produce more output torque for instantaneous acceleration but may reduce overall range) (314). Finally the SO may be configured to present the results to the user (316).

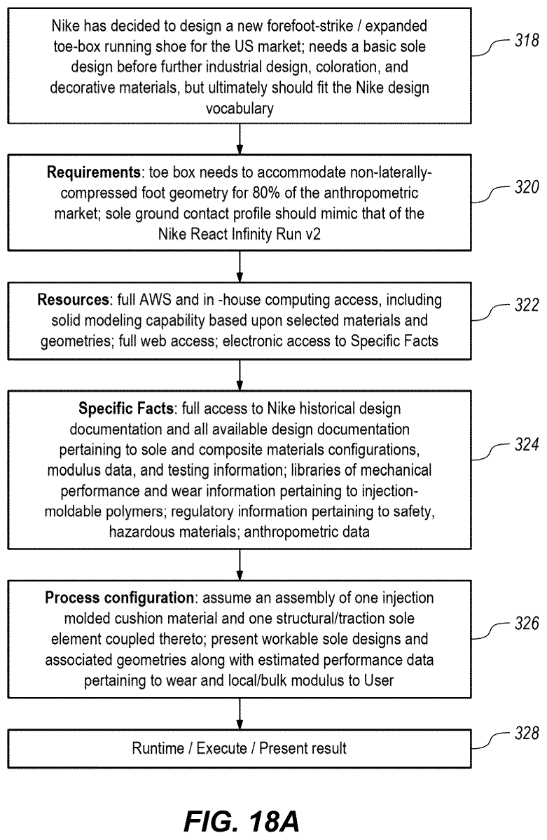

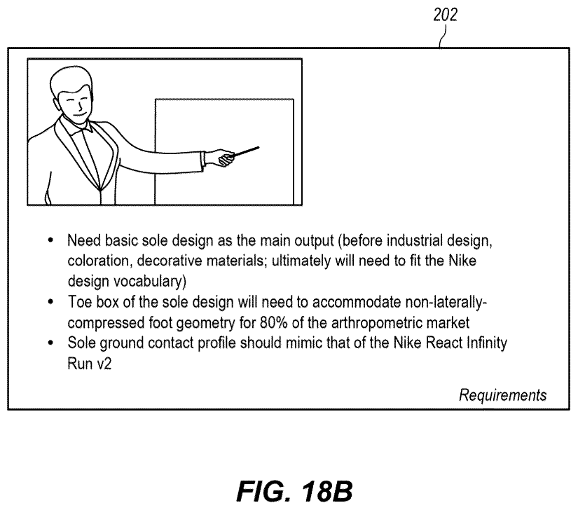

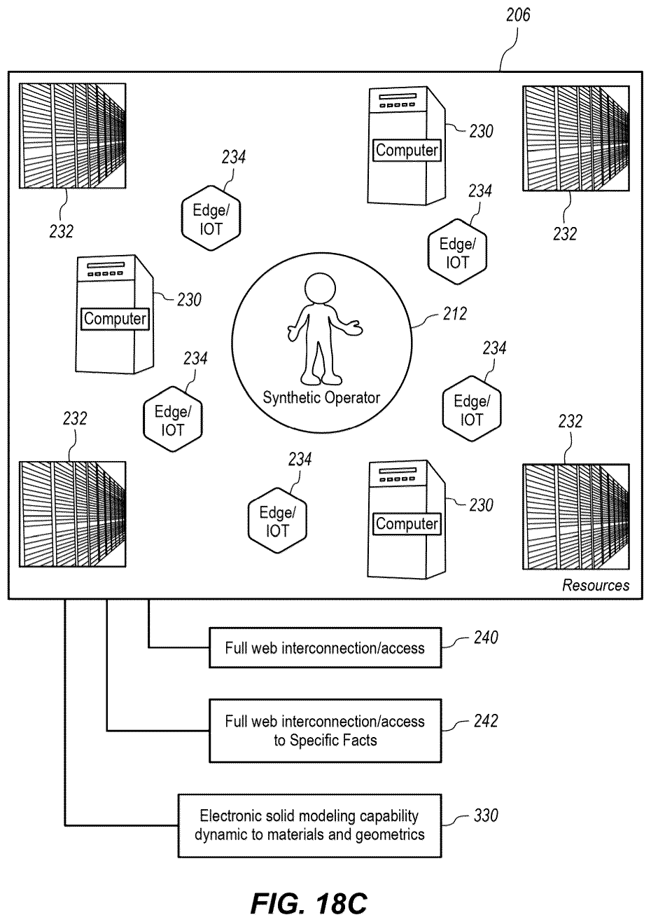

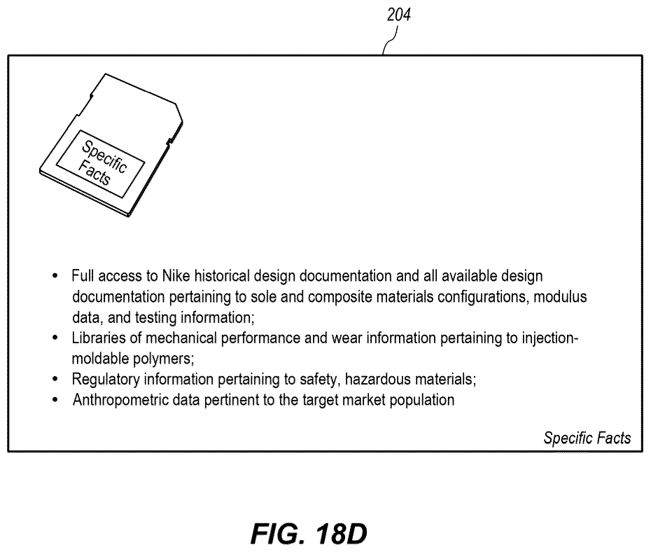

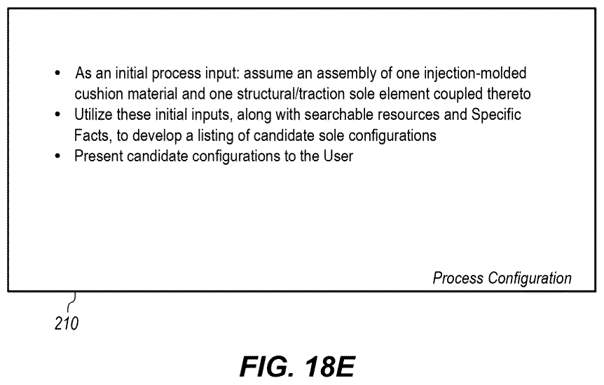

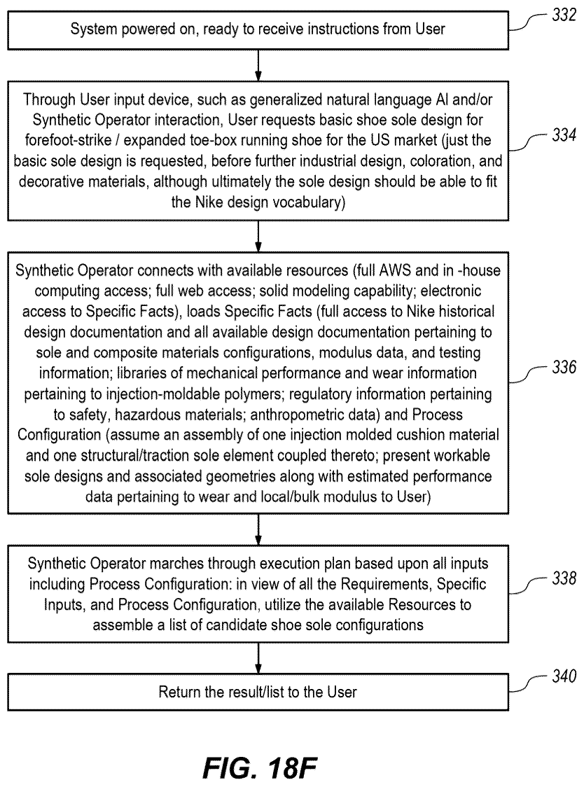

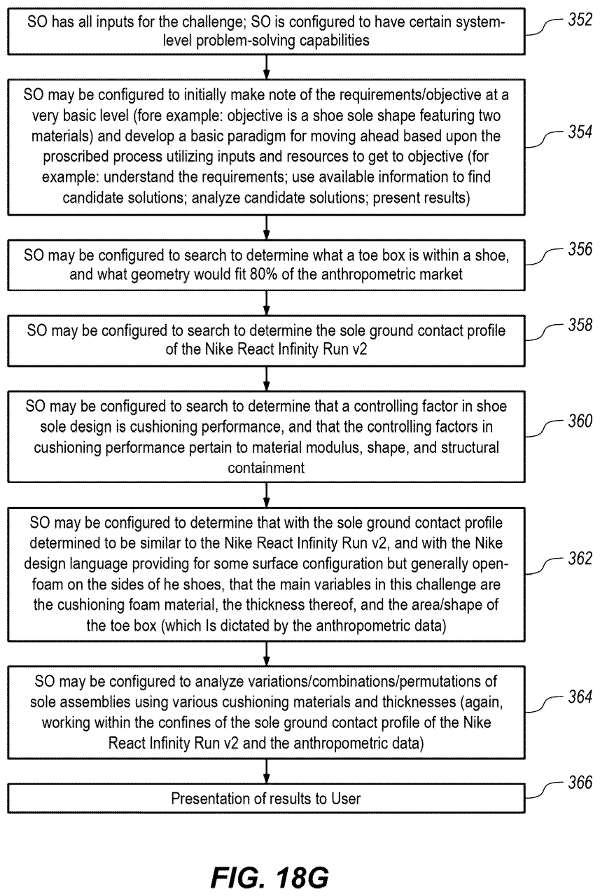

Referring to FIGS. 18A-18G, another illustrative example is shown utilizing a synthetic operator configuration to execute upon a challenge which might conventionally be the domain of a materials engineer. Referring to FIG. 18A, Nike has decided to design a new forefoot-strike/expanded toe-box running shoe for the US market, and needs a basic sole design before further industrial design, coloration, and decorative materials, but ultimately the configuration should fit the Nike design vocabulary (318). The requirements from the user to the synthetic operator enhanced system configuration may include: toe box needs to accommodate non-laterally-compressed foot geometry for 80% of the anthropometric market; sole ground contact profile should mimic that of the Nike React Infinity Run v2®. Resources for the synthetic operator may include full Amazon Web Services (“AWS”) and in-house computing access, including solid modelling capability based upon selected materials and geometries; full web access; electronic access to specific facts (322). Specific facts for the particular challenge may include: full access to Nike historical design documentation and all available design documentation pertaining to sole and composite materials configurations, modulus data, and testing information; libraries of mechanical performance and wear information pertaining to injection-moldable polymers; regulatory information pertaining to safety, hazardous materials; anthropometric data (i.e., based upon actual human anatomy statistics) (324). Process configuration for the synthetic operator to navigate the particular challenge may include: assume an assembly of one injection molded cushion material and one structural/traction sole element coupled thereto; present workable sole designs and associated geometries along with estimated performance data pertaining to wear and local/bulk modulus to the user (326). Finally the system may be configured such that the synthetic operator may execute and present the result to the user (328).

Referring to FIG. 18B, requirements (202) for the particular challenge may include: a requirement for a basic sole design as the main output (before industrial design, coloration, decorative materials; ultimately will need to fit the Nike design vocabulary); the toe box of the sole design will need to accommodate non-laterally-compressed foot geometry for 80% of the arthropometric market; the shoe sole ground contact profile should mimic that of the Nike React Infinity Run v2®.

Referring to FIG. 18C, computing resources (206) may include intercoupled data center (232), desktop (230), and edge/IOT type systems, as well as intercoupled access to the internet/web (240), electronic access to particular specific facts data (242), and electronic access to computerized solid modelling capability dynamic to materials and geometries (330).

Referring to FIG. 18D, specific facts (204) pertaining to the particular challenge may include: full access to Nike historical design documentation and all available design documentation pertaining to sole and composite materials configurations, modulus data, and testing information; libraries of mechanical performance and wear information pertaining to injection-moldable polymers; regulatory information pertaining to safety, hazardous materials; and anthropometric data pertinent to the target market population.

Referring to FIG. 18E, process configuration (210) for the particular synthetic operator enhanced scenario may include: as an initial process input: assume an assembly of one injection-molded cushion material and one structural/traction sole element coupled thereto; utilize these initial inputs, along with searchable resources and Specific Facts, to develop a listing of candidate sole configurations; and present candidate configurations to the user.

Thus referring to the process flow of FIG. 18F, a synthetic operator capable system may be powered on, ready to receive instructions from a user (332). Through a user input device, such as generalized natural language AI and/or other Synthetic Operator interaction, the user may request a basic shoe sole design for forefoot-strike/expanded toe-box running shoe for the US market (just the basic sole design is requested, before further industrial design, coloration, and decorative materials, although ultimately the sole design should be able to fit the Nike design vocabulary) (334). The synthetic operator may be configured to connect with available resources (full AWS and in-house computing access; full web access; solid modelling capability; electronic access to Specific Facts), loads Specific Facts (full access to Nike historical design documentation and all available design documentation pertaining to sole and composite materials configurations, modulus data, and testing information; libraries of mechanical performance and wear information pertaining to injection-moldable polymers; regulatory information pertaining to safety, hazardous materials; anthropometric data) and Process Configuration (assume an assembly of one injection molded cushion material and one structural/traction sole element coupled thereto; present workable sole designs and associated geometries along with estimated performance data pertaining to wear and local/bulk modulus to User) (336). The synthetic operator may be configured to march through the execution plan based upon all inputs including process configuration; for example, in view of all the requirements, specific inputs, and process configuration, utilize the available resources to assemble a list of candidate shoe sole configurations (338). Finally the synthetic operator may be configured to return the result to the user (340).

Referring to FIG. 18G, a synthetic operator (“SO”) centric flow is illustrated for the challenge. Having all inputs for the particular challenge, the SO may be configured to have certain system-level problem-solving capabilities (352). The SO may be configured to initially make note of the requirements/objective at a very basic level (for example: objective is a shoe sole shape featuring two materials) and develop a basic paradigm for moving ahead based upon the proscribed process utilizing inputs and resources to get to objective (for example: understand the requirements; use available information to find candidate solutions; analyze candidate solutions; present results) (354). The SO may be configured to search to determine what a toe box is within a shoe, and what geometry would fit 80% of the anthropometric market (356). The SO may be configured to search to determine the sole ground contact profile of the Nike React Infinity Run v2® (358). The SO may be configured to search to determine that a controlling factor in shoe sole design is cushioning performance, and that the controlling factors in cushioning performance pertain to material modulus, shape, and structural containment (360). The SO may be configured to determine that with the sole ground contact profile determined to be similar to the Nike React Infinity Run v2®, and with the Nike design language providing for some surface configuration but generally open-foam on the sides of the shoes, that the main variables in this challenge are the cushioning foam material, the thickness thereof, and the area/shape of the toe box (which is dictated by the anthropometric data) (362). The SO may be configured to analyze variations/combinations/permutations of sole assemblies using various cushioning materials and thicknesses (again, working within the confines of the sole ground contact profile of the Nike React Infinity Run v2 and the anthropometric data) (364). Finally the synthetic operator may be configured to present the results to the user (366).

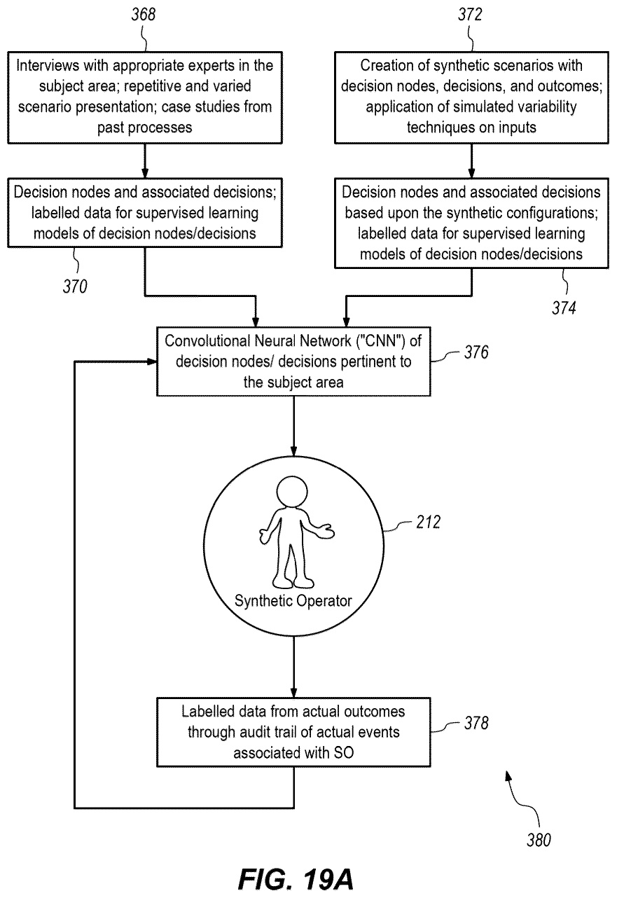

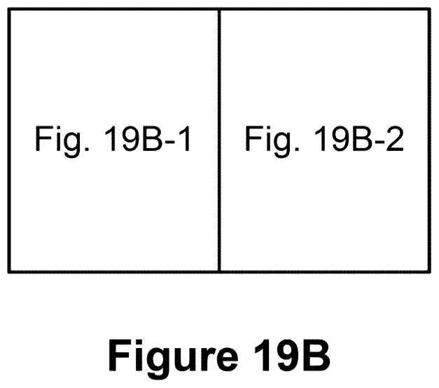

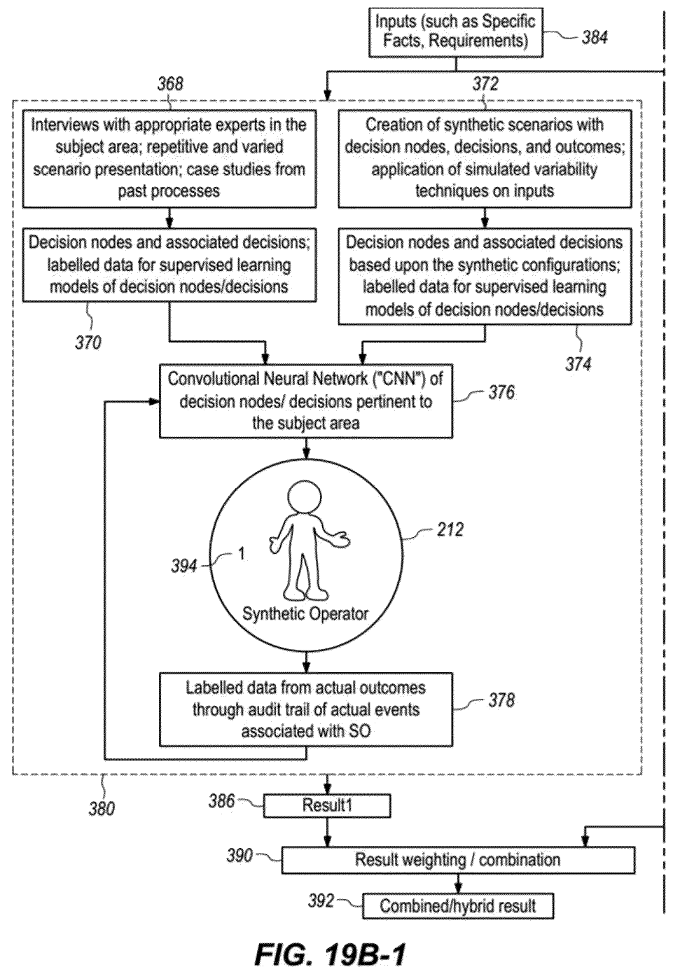

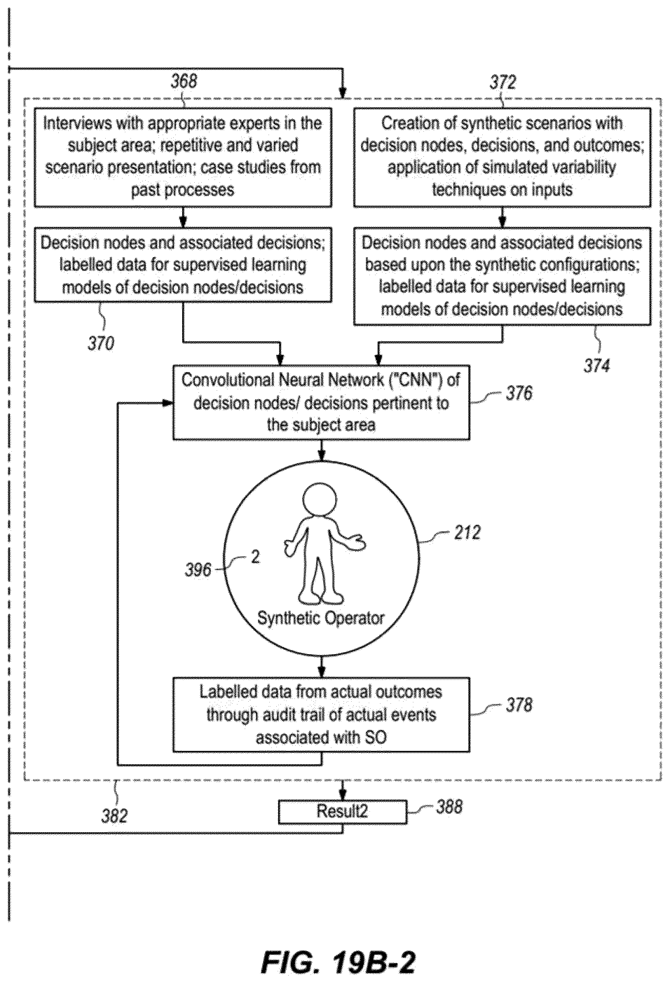

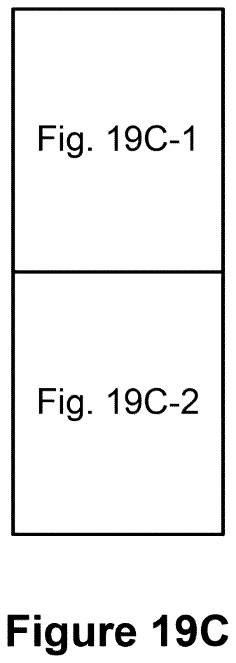

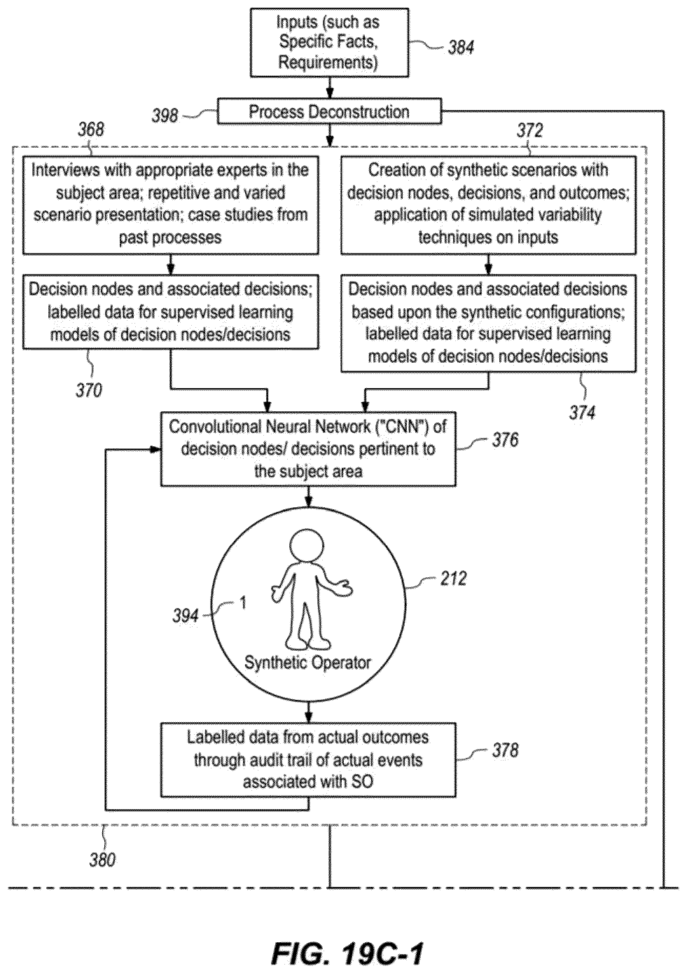

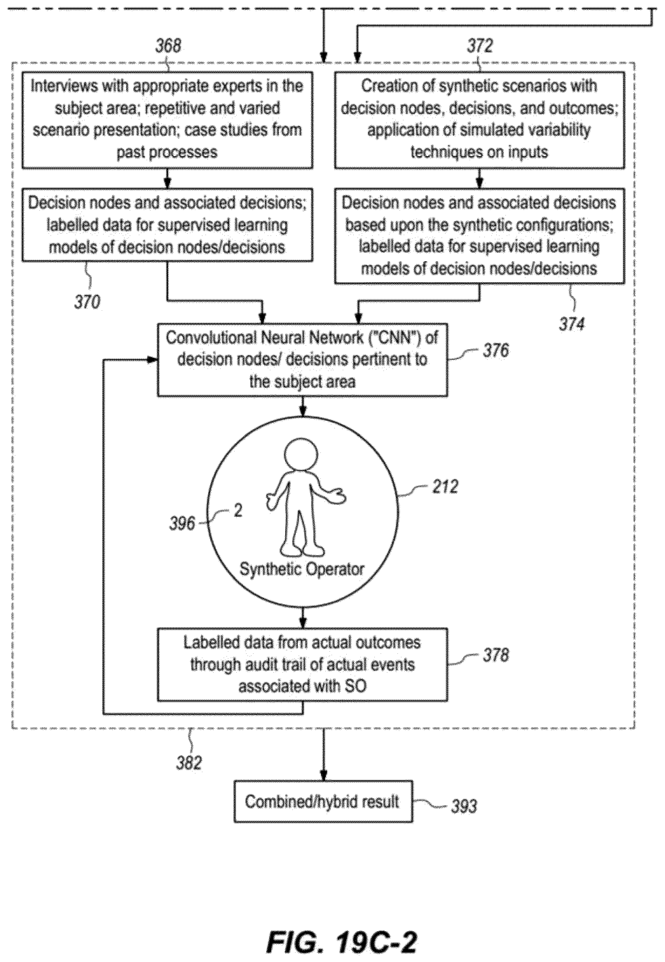

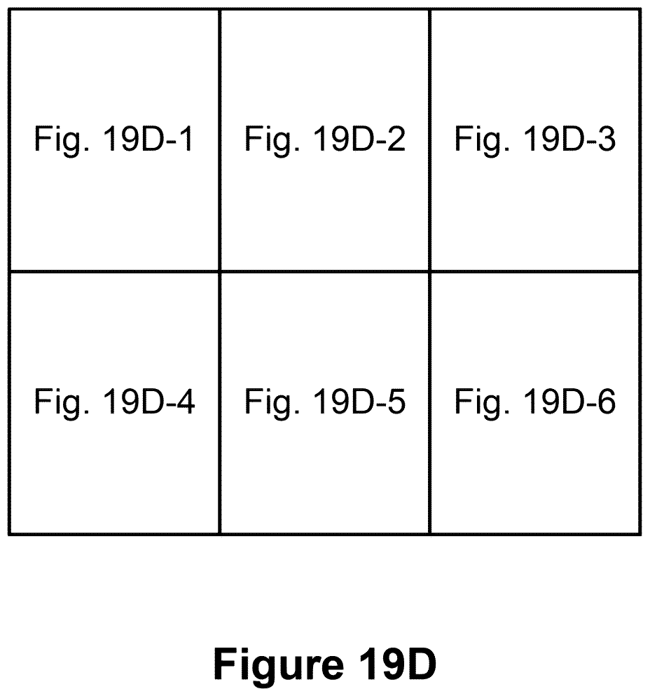

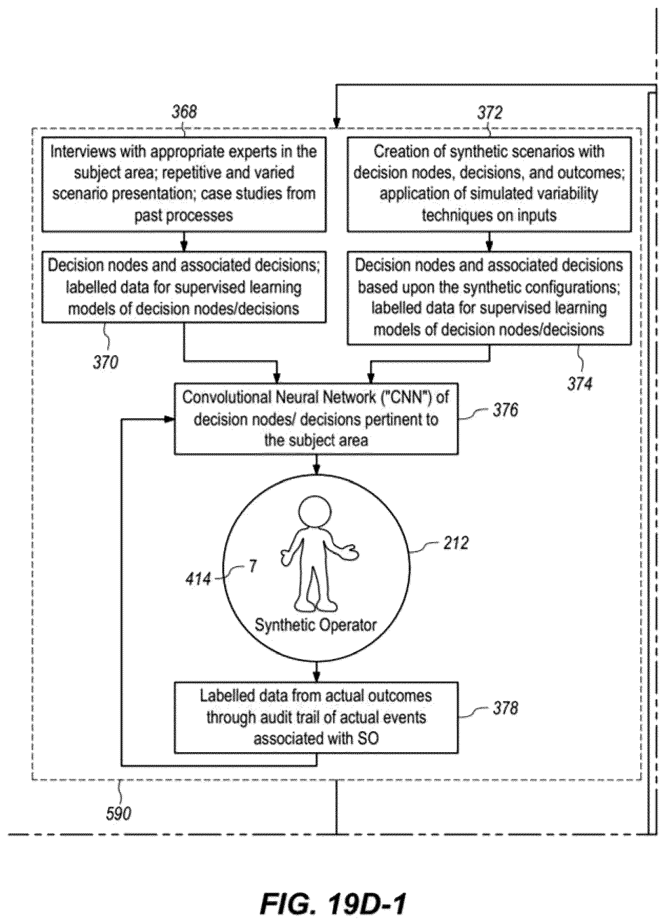

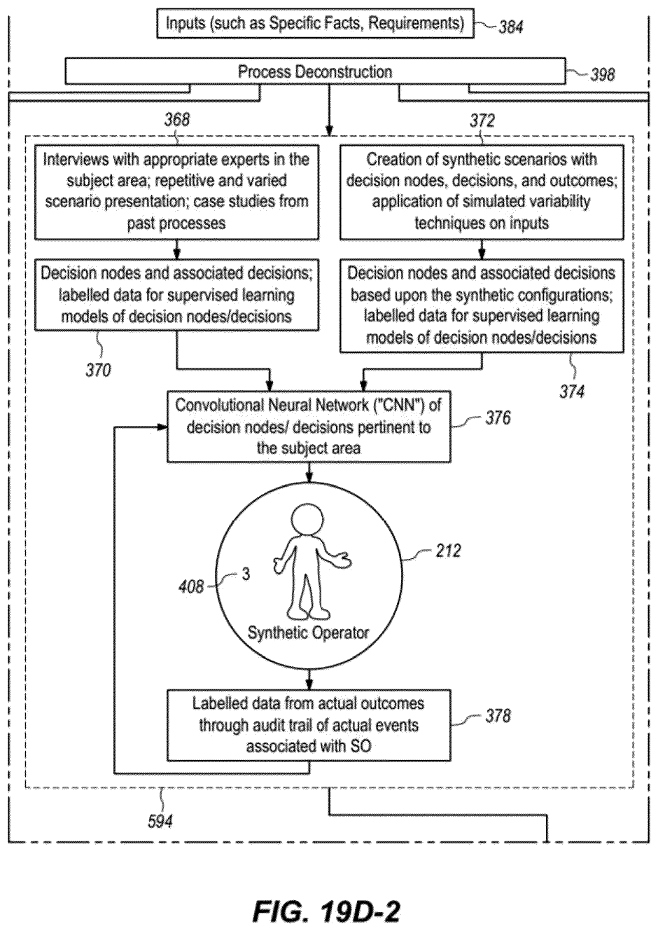

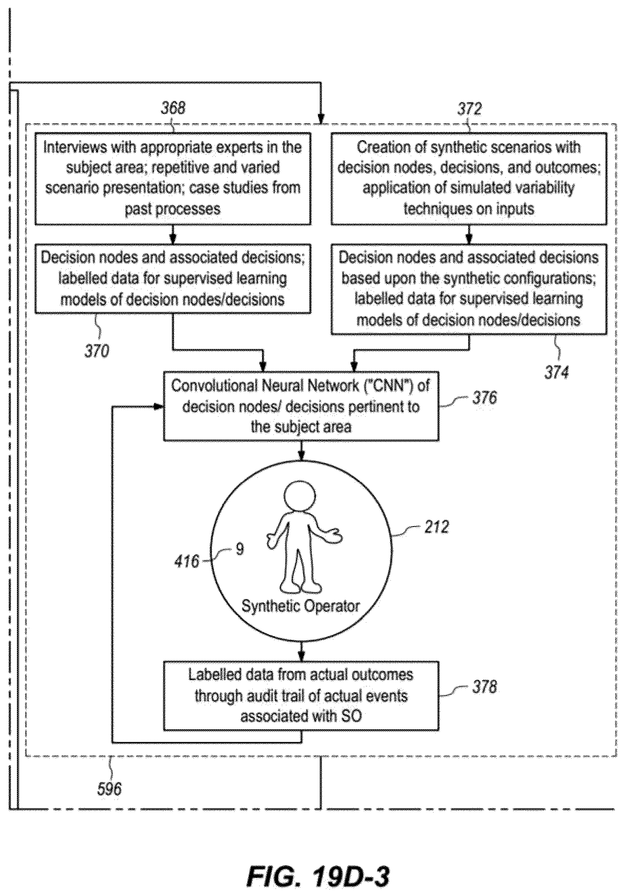

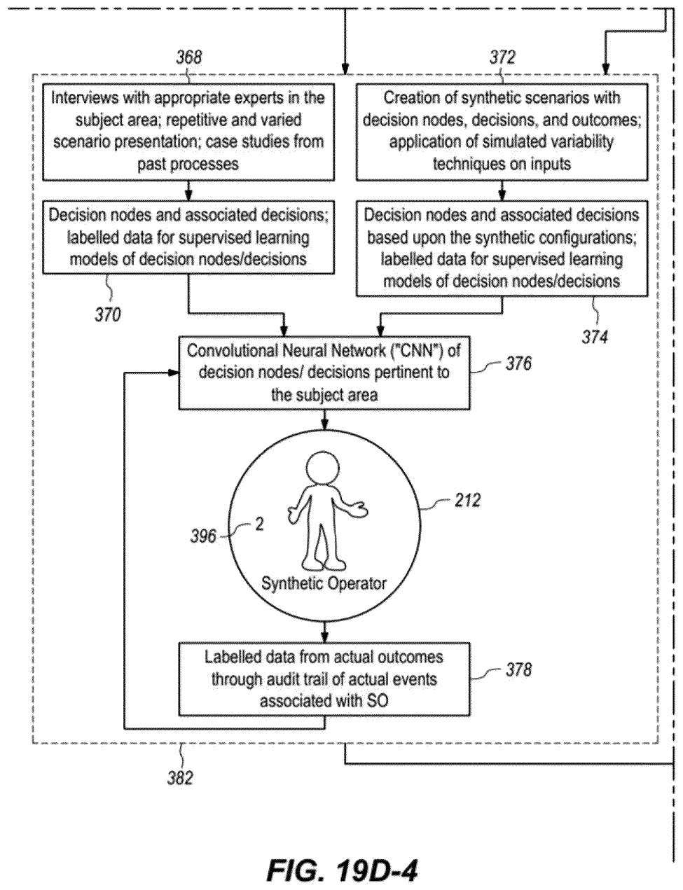

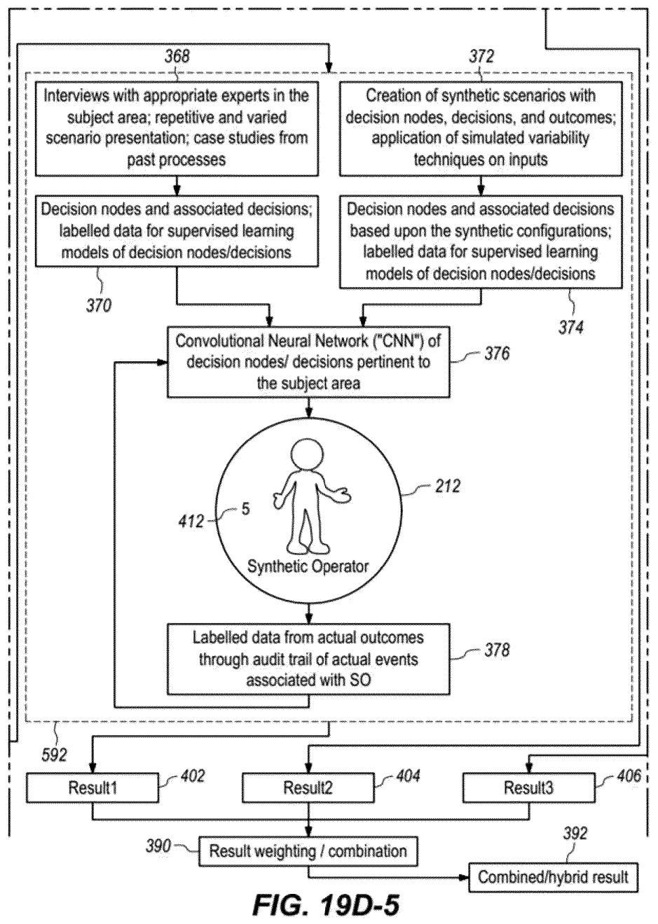

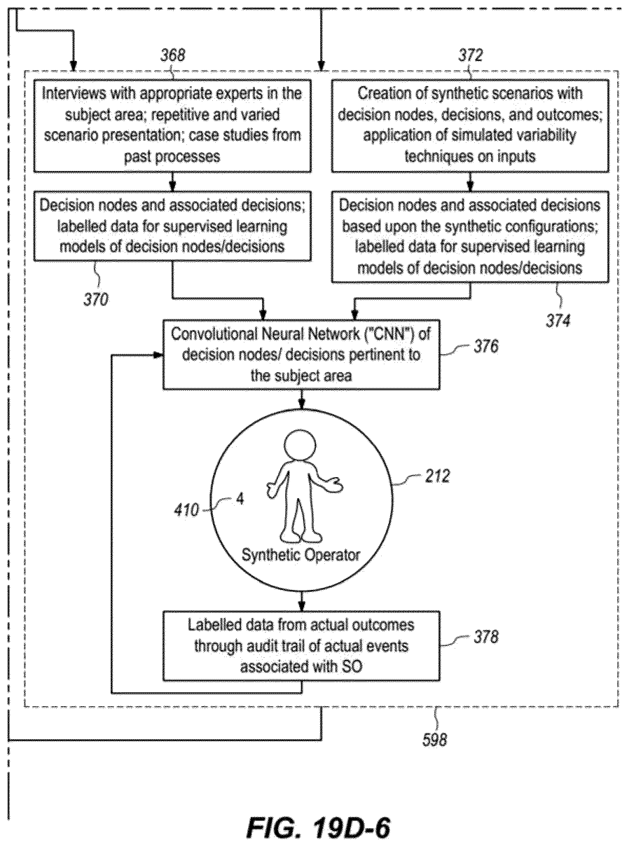

In various embodiments, it may be useful to have synthetic operator capability configured to address multithreaded challenges, such as simulated engagement of multiple players, multiple sub-processes, etc, as in many human scale challenges. Referring to FIG. 19A, for example, a synthetic operator (212) configuration is illustrated wherein a compound artificial intelligence configuration, such as one utilizing a convolutional neural network (“CNN”) (376), may be employed. For example, referring to FIG. 19A, the CNN driving the functionality of the synthetic operator (212) may be informed by a supervised learning configuration wherein interviews with appropriate experts in the subject area may be utilized, along with repetitive and varied scenario presentation and case studies from past processes (368). For example, to build a synthetic operator capability similar to that of the famous engineering manager David Packard, founder of Hewlett Packard Inc., interviews, scenarios, and case studies of what David Packard actually did in various situations may be studied. Decision nodes and associated decisions may be labelled based upon such studies and input for supervised learning models pertaining to these decision nodes and decisions (370) such that the CNN may be created and operated (376). With a recorded audit path of labelled data from actual outcomes utilizing the pertinent CNN-based synthetic operator, further feedback refinement and evolution of the synthetic operator is facilitated over time and over experience with the synthetic operator using the actual outcome data. Further, synthetic scenarios with decision nodes, decisions, and outcomes may be created. For example, simulated scenarios pertaining to situations and speculation regarding what David Packard might have done in a particular engineering management situation may be created, along with detail regarding the synthetic scenario such as decision nodes, decisions, and outcomes. To increase the amount of synthetic data from such configurations, simulated variability techniques on various variables in such processes or subprocesses may be utilized to generate more synthetic data, which may be automatically labelled and utilized (374) to further train the CNN in a supervised learning configuration.

Referring to FIG. 19B, it may be desirable in various complex synthetic operator enhanced processes to have a hybrid functionality, wherein two different synthetic operator configurations (380, 382) may be utilized together to address a particular challenge. The configuration of FIG. 19B illustrates two different synthetic operators utilizing the same inputs (384) in a parallel configuration, whereby the system may be configured to receive each of the independent results (386, 388), weigh and/or combine them based upon user preferences, and present a combined or hybrid result (392).

Referring to FIG. 19C, a configuration is illustrated wherein after a process deconstruction to determine which nodes of a process are to be handled by which of two or more synthetic operators to be applied in sequence, the sequential operation is conducted such that a first (394) synthetic operator handles a first portion of the challenge, followed by a handoff to a second (396) synthetic operator to handle the remainder of the challenge and present the hybrid result (393).

Referring to FIG. 19D, a hybrid configuration featuring both series and parallel synthetic operator activity is illustrated wherein a first line of synthetic operator configurations (590, 382, 592, for synthetic operators 7 (414), 2 (396), and 5 (412)) is operated in parallel to a second line featuring a single synthetic operator configuration (594) for synthetic operator 3 (408), as well as a third line featuring two synthetic operator configurations (596, 598) in series for synthetic operator 9 (416) and synthetic operator 4 (410). The results (402, 404, 406) may be weighted and or combined (390) as prescribed by the user, and the result presented (392).

Thus various configurations are illustrated in FIGS. 19A-19D wherein synthetic operator configurations of various types may be utilized to address complex challenges, and a human user or operator may be allowed through a user interface to select a single synthetic operator, multiple synthetic operators, and hybrid operator configurations (for example, hybrid wherein a single synthetic operator is configured to have various characteristics of two other separate synthetic operators, or with a plurality of synthetic operators with process mitigation, as described herein). Thus various embodiments may be directed to a synthetic engagement system for process-based problem solving, comprising: a computing system comprising one or more operatively coupled computing resources; a user interface operated by the computing system and configured to engage a human operator in accordance with a predetermined process configuration toward an established requirement based at least in part upon one or more specific facts; wherein the user interface is configured to allow the human operator to select and interactively engage two or more synthetic operators operated by the computing system to collaboratively proceed through the predetermined process configuration, and to return a result to the human operator selected to at least partially satisfy the established requirement; and wherein each of the two or more synthetic operators is informed by a convolutional neural network informed at least in part by historical actions of a particular actual human operator. The one or more specific facts may be selected from the group consisting of: textual information, numeric data, audio information, video information, emotional state information, analog chaos input selection, activity perturbance selection, curiosity selection, memory configuration, learning model, filtration configuration, and encryption configuration. The one or more specific facts may comprise textual information pertaining to specific background information from historical storage. The one or more specific facts may comprise textual information pertaining to an actual operator. The one or more specific facts may comprise textual information pertaining to a synthetic operator. The specific facts may comprise a predetermined profile of specific facts developed as an initiation module for a specific synthetic operator profile. The one or more operatively coupled computing resources may comprise a local computing resource. The local computing resource may be selected from the group consisting of: a mobile computing resource, a desktop computing resource, a laptop computing resource, and an embedded computing resource. The local computing resource may comprise an embedded computing resource selected from the group consisting of: an embedded microcontroller, an embedded microprocessor, and an embedded gate array. The one or more operatively coupled computing resources may comprise resources selected from the group consisting of: a remote data center; a remote server; a remote computing cluster; and an assembly of computing systems in a remote location. The system further may comprise a localization element operatively coupled to the computing system and configured to determine a location of the human operator relative to a global coordinate system. The localization element may be selected from the group consisting of: a GPS sensor; an IP address detector; a connectivity triangulation detector; an electromagnetic localization sensor; an optical location sensor. The one or more operatively coupled computing resources may be activated based upon the determined location of the human operator. The user interface may comprise a graphical user interface. The user interface may comprise an audio user interface. The graphical user interface may be configured to engage the human operator using an element selected from the group consisting of: a computer graphics engagement display; a video graphics engagement display; and an audio engagement accompanied by displayed graphics. The graphical user interface may comprise a video graphics engagement display configured to present a real-time or near real-time graphical representation of a video interface engagement character with which the human operator may converse. The video interface engagement character may be selected from the group consisting of: a humanoid character, an animal character, and a cartoon character. The user interface may be configured to allow the human operator to select the visual presentation of the video interface engagement character. The user interface may be configured to allow the human operator to select a visual presentation characteristic of the video interface engagement character selected from the group consisting of: character gender, character hair color, character hair style, character skin tone, character eye coloration, and character shape. The visual presentation of the video interface engagement character may be modelled after a selected actual human. The user interface may be configured to allow the human operator to select one or more audio presentation aspects of the video interface engagement character. The user interface may be configured to allow the human operator to select one or more audio presentation aspects of the video interface engagement character selected from the group consisting of: character voice intonation; character voice loudness; character speaking language; character speaking dialect; and character voice dynamic range. The one or more audio presentation aspects of the video interface engagement character may be modelled after a selected actual human. The predetermined process configuration may comprise a finite group of steps through which the engagement shall proceed in furtherance of the established requirement. The predetermined process configuration may comprise a process element selected from the group consisting of: one or more generalized operating parameters; one or more resource/input awareness and utilitization settings; a domain expertise module; a process sequencing paradigm; a process cycling/iteration paradigm; and an AI utilization and configuration setting. The finite group of steps may comprise steps selected from the group consisting of: problem definition; potential solutions outline; preliminary design; and detailed design. The predetermined process configuration may comprise a selection of elements by the human operator. Selection of elements by the human operator may comprise selecting synthetic operator resourcing for one or more aspects of the predetermined process configuration. The system may be configured to allow the human operator to specify a particular resourcing for a first specific portion of the predetermined process configuration. The system may be configured to allow the human operator to specify a particular resourcing for a second specific portion of the predetermined process configuration that is different from the particular resourcing for the first specific portion of the predetermined process configuration. The system may be configured to allow the human operator to specify a particular resourcing for a first specific portion of the predetermined process configuration that is based upon a plurality of synthetic operator characters. Each of the plurality of synthetic operator characters may be applied to the first specific portion sequentially. Each of the plurality of synthetic operator characters may be applied to the first specific portion simultaneously. The system may be configured to allow the human operator to specify a particular resourcing for a first specific portion of the predetermined process configuration that is based upon one or more hybrid synthetic operator characters. The one or more hybrid synthetic operator characters may comprise a combination of otherwise separate synthetic operator characters which may be applied to the first specific portion simultaneously. The convolutional neural network may be informed using inputs from a training dataset comprising data pertaining to the historical actions of the particular actual human operator. The convolutional neural network may be informed using inputs from a training dataset using a supervised learning model. The convolutional neural network may be informed using inputs from a training dataset along with analysis of the established requirement using a reinforcement learning model. Each of the two or more synthetic operators may be informed by a convolutional neural network informed at least in part by a curated selection of synthetic action records pertaining to synthetic actions of an actual human operator. Each of the two or more synthetic operators may be informed by a convolutional neural network informed at least in part by a curated selection of synthetic action records pertaining to synthetic actions of a synthetic operator. The computing system may be configured to separate each of the finite group of steps with an execution step during which the two or more synthetic operators are configured to progress toward the established requirement in accordance with one or more execution behaviors associated with the pertinent convolutional neural network. At least one of the one or more execution behaviors may be based upon a project leadership influence on the pertinent convolutional neural network. The computing system, based at least in part upon the at least one execution behavior based upon a project leadership influence, may be configured to divide the execution step into a plurality of tasks which may be addressed by the available resources in furtherance of the established requirement. The computing system, based at least in part upon the at least one execution behavior based upon a project leadership influence, may be further configured to project manage accomplishment of the plurality of tasks toward one or more milestones in pursuit of the established requirement. The computing system, based at least in part upon the at least one execution behavior based upon a project leadership influence, may be further configured to functionally provide an update pertaining to accomplishment of the plurality of tasks at one or more stages of the execution step. The computing system, based at least in part upon the at least one execution behavior based upon a project leadership influence, may be further configured to functionally provide an update pertaining to accomplishment of the plurality of tasks at the end of each executing step for consideration in each of the finite group of steps in the process configuration. The computing system, based at least in part upon the at least one execution behavior based upon a project leadership influence, may be further configured to functionally present the update update for consideration by the human operator utilizing the user interface operated by the computing system. The computing system, based at least in part upon the at least one execution behavior based upon a project leadership influence, may be further configured to incorporate instructions from the human operator pertaining to the presented update utilizing the user interface operated by the computing system, as the finite steps of the process configuration are continued. The user interface may be configured to allow the human operator to pause the computing system while it otherwise proceeds through the predetermined process configuration so that one or more intermediate results may be examined by the human operator pertaining to the established requirement. The user interface may be configured to allow the human operator to change one or more aspects of the one or more specific facts during the pause of the computing system to facilitate forward execution based upon the change. The user interface may be configured to provide the human operator with a calculated resourcing cost based at least in part upon utilization of the operatively coupled computing resources in the predetermined process configuration. The system may be configured to allow the human operator to specify that the two or more synthetic operators are different. The system may be configured to allow the human operator to specify that the two or more synthetic operators are the same and may be configured to collaboratively scale their productivity as they proceed through the predetermined process configuration. The two or more synthetic operators may be configured to automatically optimize their application as resources as they proceed through the predetermined process configuration. The system may be configured to utilize the two or more synthetic operators to produce an initial group of decision nodes pertinent to the established requirement based at least in part upon characteristics of the two or more synthetic operators. The system may be further configured to create a group of mediated decision nodes based upon the initial group of decision nodes. The system may be further configured to create a group of operative decision nodes based upon the group of mediated decision nodes. The two or more synthetic operators may be operated by the computing system to collaboratively proceed through the predetermined process configuration by sequencing through the operative decision nodes in furtherance of the established requirement. The two or more synthetic operators may comprise a plurality limited only by the operatively coupled computing resources.

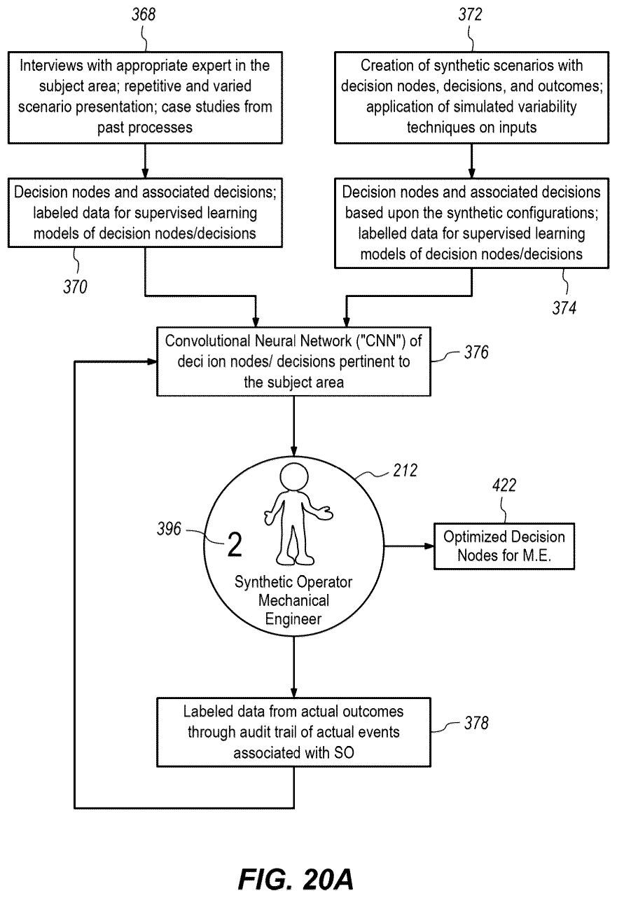

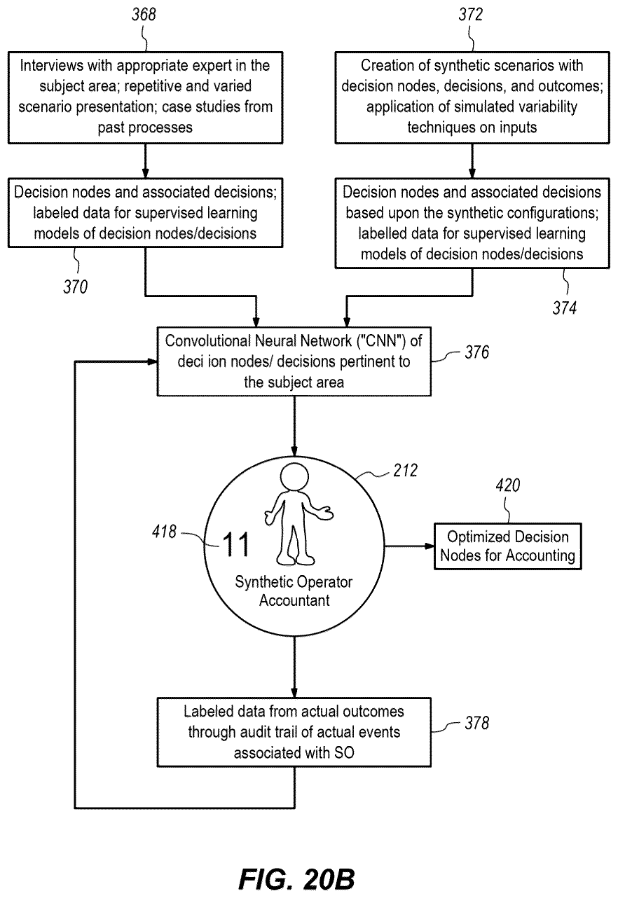

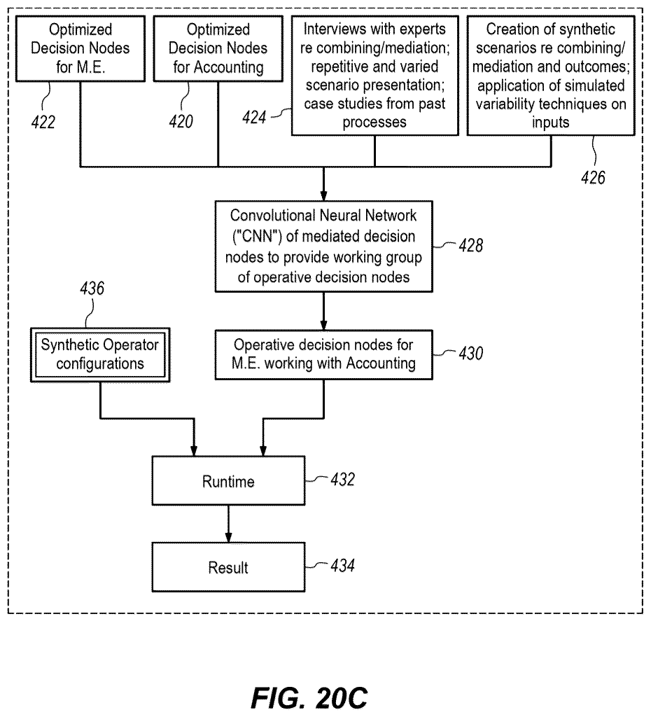

Referring to FIG. 20A, for example, a configuration for creating and updating a mechanical engineer synthetic operator “2” (396) is illustrated, wherein the continually updated CNN may be utilized to produce a group of optimized decision nodes (422) for this particular synthetic operator mechanical engineer 2 (i.e., somewhat akin to the process with regard to how this engineer addresses and works through a challenge).

Referring to FIG. 20B, for example, a configuration for creating and updating an accountant synthetic operator “11” (418) is illustrated, wherein the continually updated CNN may be utilized to produce a group of optimized decision nodes (420) for this particular synthetic operator accountant 11 (i.e., somewhat akin to the process with regard to how this accountant addresses and works through a challenge).

Referring to FIG. 20C, to have two different synthetic operators work through particular process steps to get to a result together (i.e. as opposed to independent parallel or sequential operation followed by results combination at the end), much in the manner that complex human teams operate, it may be useful to develop a CNN (428) that is informed by the optimized decision nodes for each synthetic operator (422, 420 in the example of the illustrative mechanical engineer 2 and accountant 11 of FIGS. 20A and 20B), as well as actual (424) and synthetic (426) data pertaining to how these decision nodes should be combined and mediated. Such CNN may be utilized to create the operative decision nodes for this synthetic operator mechanical engineer 2 working with this synthetic operator accountant 11 through a given process. In other words, a group of decision nodes is now available for the collaboration based upon previously disparate sets of decisions nodes, and now the synthetic operator configurations (436) (i.e., pertaining to mechanical engineer 2 and accountant 11, such as per FIGS. 20A and 20B, in this particular illustrative scenario) may be executed at runtime (432) and utilized to produce a result (434).

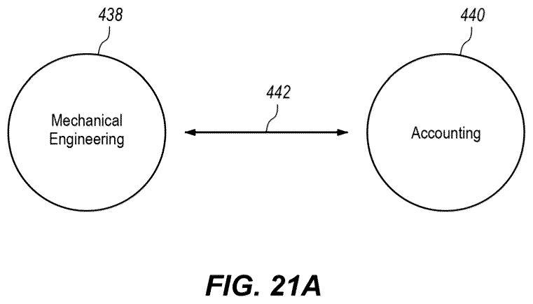

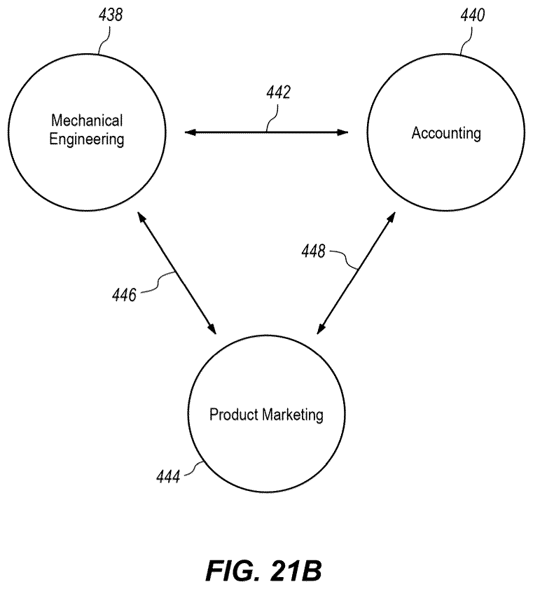

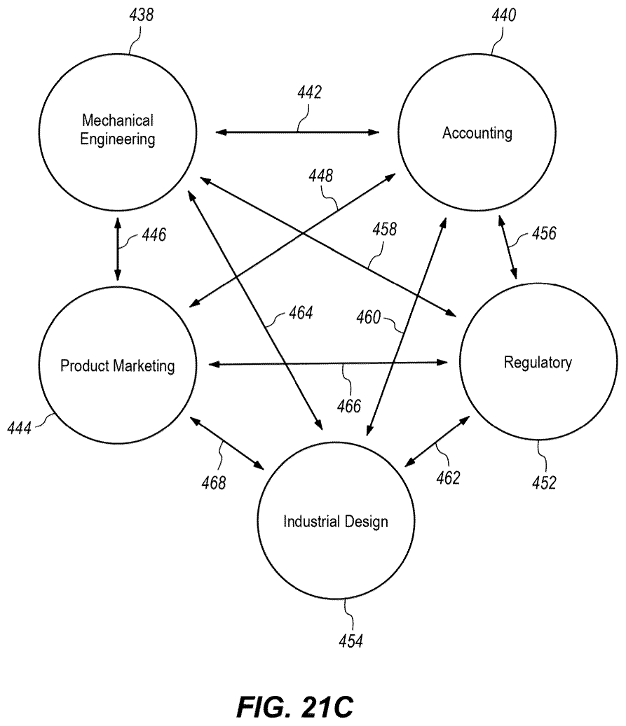

Referring to FIG. 21A, with two synthetic operators (such as a mechanical engineer synthetic operator configuration 438 and accountant synthetic operator configuration 440), there is essentially one relationship (442) between the two, and one process mediation to address to get both into a coherent process. Referring to FIG. 21B, by bringing in additional synthetic operators, such as a product marketing synthetic operator configuration (444), each synthetic operator theoretically has two different relationships (442, 446, 448) and the process mediation is more complex as a result. Referring to FIG. 21C, a configuration with five synthetic operator configurations (438, 440, 452, 454, 444) is illustrated to show the multiplication of relationship (442, 456, 462, 468, 446, 448, 458, 464, 460, 466) complexity for process mediation.

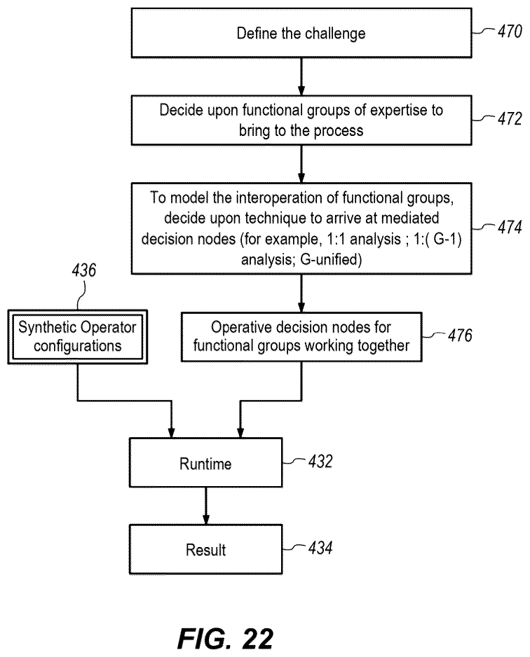

Referring to FIG. 22, such complexity may be addressed in various configurations. After defining the challenge (470) and deciding upon functional groups of expertise to bring into a particular process (472), a user or supervisor may decide upon a model for interoperation of the processes (474); for example, it may be decided that every relationship be modelled 1:1 for each synthetic operator; it may be decided that each synthetic operator is only modeled versus the rest of the group as a whole (“1:(G-1)”); it may be decided that the user or supervisor is going to dictate a process mediation for the group as a unified whole (“G-unified”) (i.e., “this is the process we are all going to run”). With the operational decision nodes determined for the functional groups to work the process together (476), the synthetic operator configurations (436) may be utilized to execute at runtime (432) and produce a result (434).

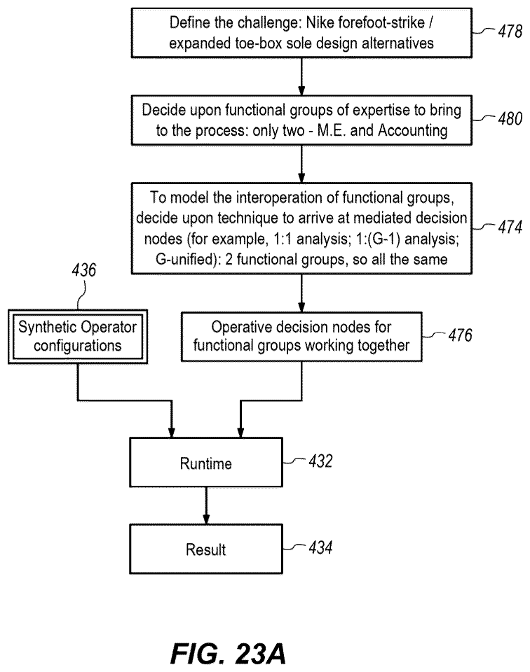

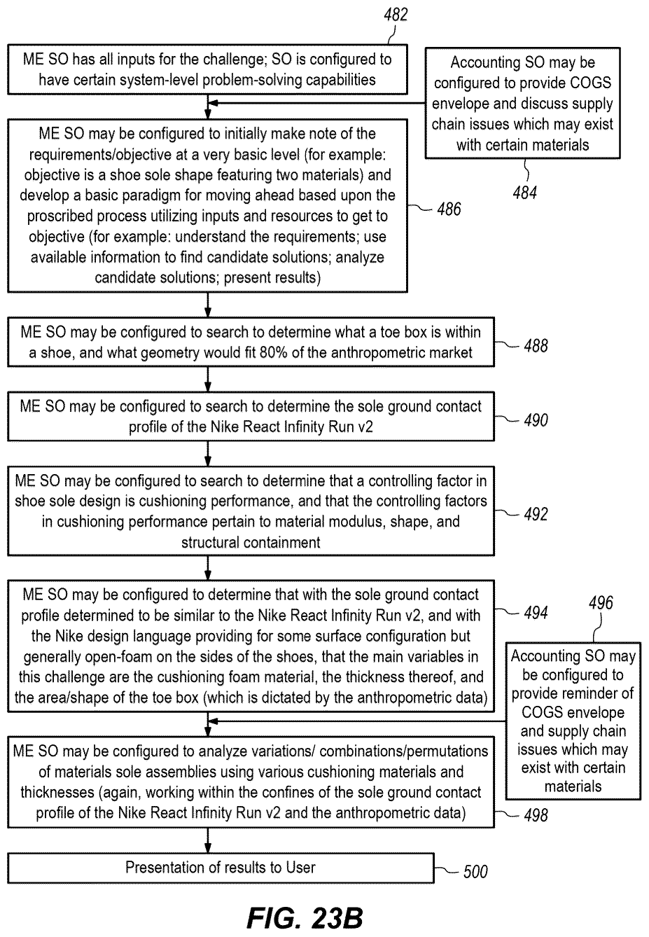

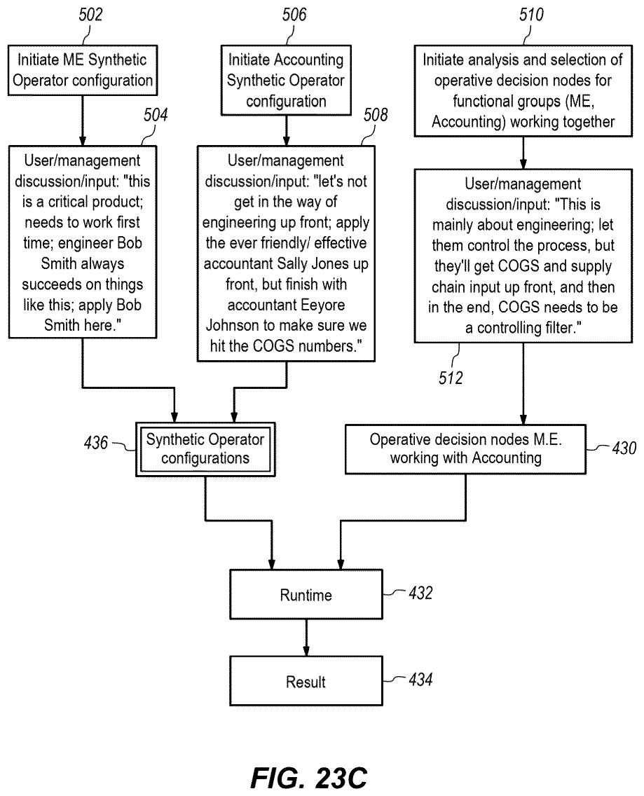

Referring to FIG. 23A, as an example, a challenge for a Nike® shoe sole design is defined (478). A simplified grouping of a mechanical engineer synthetic operator is to be combined with an accounting synthetic operator (480). With only two synthetic operators, one relationship and process mediation is required (474); this may be dictated, for example, by a user or supervisor, as illustrated in FIG. 23B, wherein the accounting synthetic operator only comes into the process, which is mainly an engineering process, in two locations.

Thus referring to FIG. 23B, a mechanical engineer (“ME”) SO and an accounting SO have all inputs for the challenge; the synthetic operators may be configured to have certain system-level problem-solving capabilities (482), and the accounting SO may be configured to provide a cost of goods sold (“COGS”) envelope and discuss supply chain issues which may exist with certain materials (484). The ME SO may be configured to initially make note of the requirements/objective at a very basic level (for example: objective is a shoe sole shape featuring two materials) and develop a basic paradigm for moving ahead based upon the proscribed process utilizing inputs and resources to get to objective (for example: understand the requirements; use available information to find candidate solutions; analyze candidate solutions; present results) (486). The ME SO may be configured to search to determine what a toe box is within a shoe, and what geometry would fit 80% of the anthropometric market (488). The ME SO may be configured to search to determine the sole ground contact profile of the Nike React Infinity Run v2® (490). The ME SO may be configured to search to determine that a controlling factor in shoe sole design is cushioning performance, and that the controlling factors in cushioning performance pertain to material modulus, shape, and structural containment (492). The ME SO may be configured to determine that with the sole ground contact profile determined to be similar to the Nike React Infinity Run v2, and with the Nike design language providing for some surface configuration but generally open-foam on the sides of the shoes, that the main variables in this challenge are the cushioning foam material, the thickness thereof, and the area/shape of the toe box (which is dictated by the anthropometric data) (494). The Accounting SO may be configured to provide reminder of COGS envelope and supply chain issues which may exist with certain materials (496). The ME SO may be configured to analyze variations/combinations/permutations of sole assemblies using various cushioning materials and thicknesses (again, working within the confines of the sole ground contact profile of the Nike React Infinity Run v2 and the anthropometric data) (498). The results of the complex process configuration may be presented to the user (500).

As noted above, such as in reference to FIGS. 20C and 22, both the synthetic operator configurations (436) and the decision node process mediation to determine operative decision nodes for functional groups working together (430, 476) are playing key roles at runtime (432). Referring to FIG. 23C, with regard to the illustrative example of FIGS. 23A and 23B, ME synthetic operator configuration may be initiated (502); user, management, and/or supervisor discussion or input may be something akin to: “this is a critical product; needs to work first time; engineer Bob Smith always succeeds on things like this; apply Bob Smith here.” (504) An accounting synthetic operator configuration may be initiated (506); user, management, and/or supervisor discussion or input may be something akin to: “let's not get in the way of engineering up front; apply the ever friendly/effective accountant Sally Jones up front, but finish with accountant Eeyore Johnson to make sure we hit the COGS numbers.” (508). The system may be configured to initiate analysis and selection of operative decision nodes for functional groups (ME, Accounting) working together (510), with user, management, and/or supervisor discussion or input being something akin to: “This is mainly about engineering; let them control the process, but they'll get COGS and supply chain input up front, and then in the end, COGS needs to be a controlling filter.” With such inputs, operative decision nodes may be developed as discussed from process mediation (430), and with the associated synthetic operator configuration (436), runtime (432) and results (434).

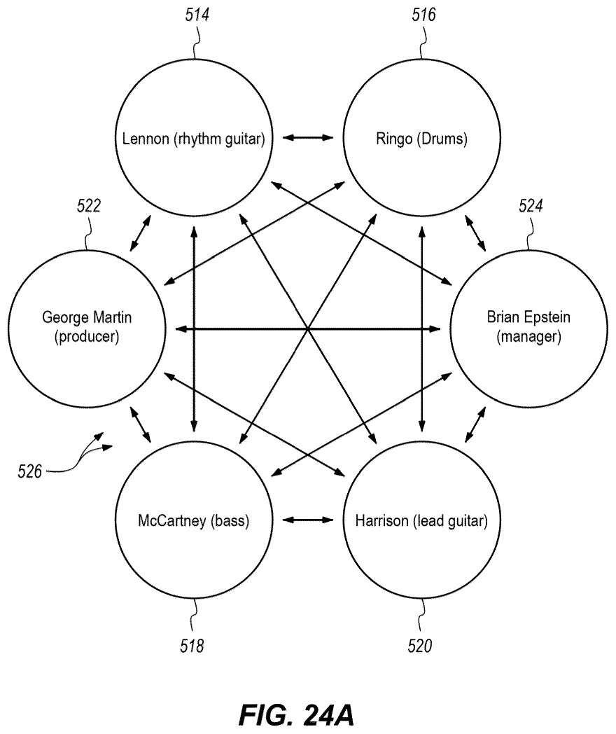

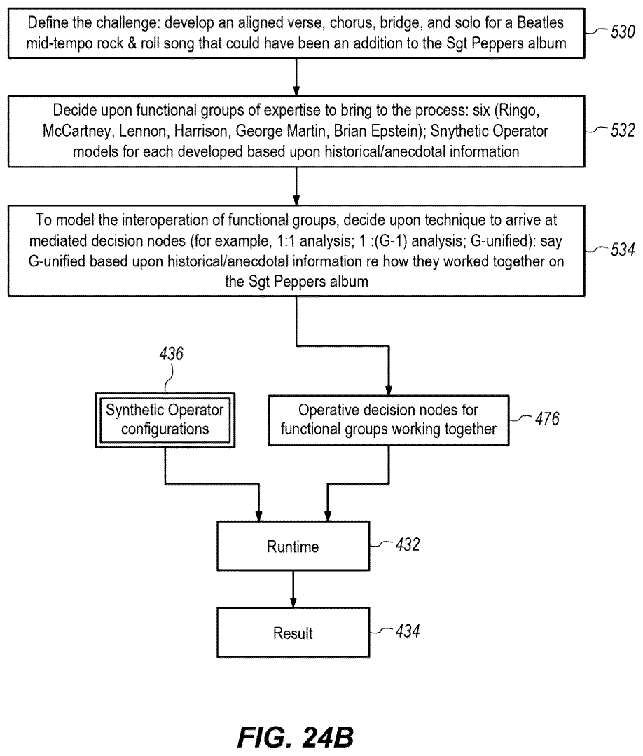

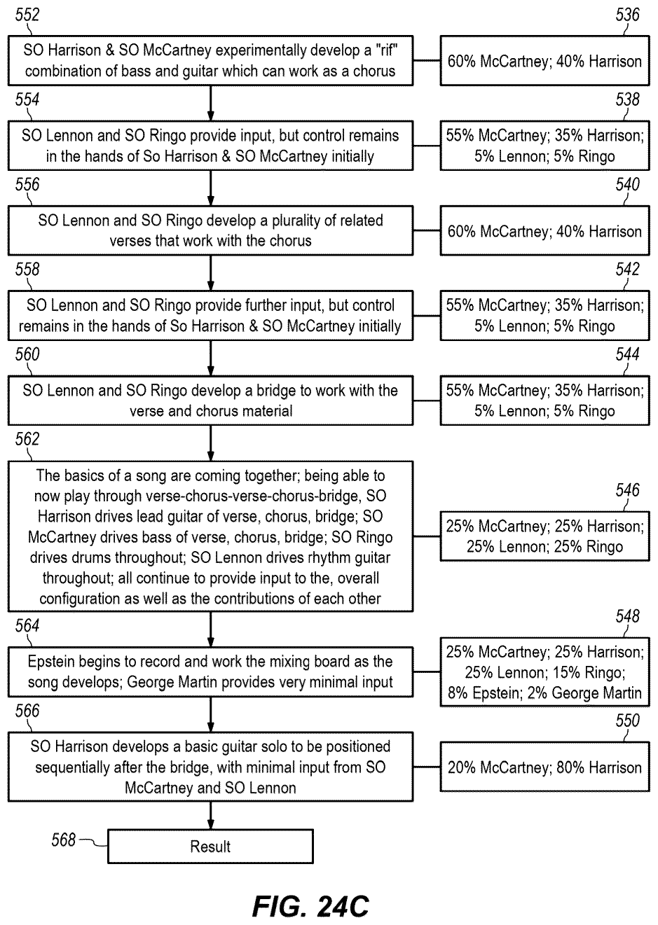

Referring to FIGS. 24A-24C, a complex configuration is illustrated wherein synthetic operators pertaining to the four Beatles®, their producer, and their manager may be utilized to create an addition to a previous album. Referring to FIG. 24A, as noted above, with a significant number of synthetic operators (514, 516, 524, 520, 518, 522) the number of relationships (526) is significant. Referring to FIG. 24B, the challenge may be defined: develop an aligned verse, chorus, bridge, and solo for a Beatles mid-tempo rock & roll song that could have been an addition to the Sgt Peppers album (530). A decision may be made regarding functional groups of expertise to bring to the process: six (Ringo, McCartney, Lennon, Harrison, George Martin, Brian Epstein); Snythetic Operator models for each developed based upon historical/anecdotal information (532). To model the interoperation of functional groups, a decision may be made regarding a technique to arrive at mediated decision nodes with this large group of synthetic operators (for example, 1:1 analysis; 1:(G-1) analysis; G-unified); in this instance it may be dictated (say G-unified based upon historical/anecdotal information re how they worked together on the Sgt Peppers album) (534). With such decisions and configurations, the operative decision nodes (476) may be utilized along with synthetic operator configurations (436) created for these particular characters, and these may be utilized at runtime (432) and to deliver a result (434), such as is illustrated further in FIG. 24C.

Referring to FIG. 24C, process mediation is dictated by the user in the boxes illustrated at the right (536, 536, 540, 542, 544, 546, 548, 550). SO Harrison & SO McCartney experimentally develop a “rif” combination of bass and guitar which can work as a chorus (552). SO Lennon and SO Ringo provide input, but control remains in the hands of So Harrison & SO McCartney initially (554). SO Lennon and SO Ringo develop a plurality of related verses that work with the chorus (556). SO Lennon and SO Ringo provide further input, but control remains in the hands of So Harrison & SO McCartney initially (558). SO Lennon and SO Ringo develop a bridge to work with the verse and chorus material (560). The basics of a song are coming together; being able to now play through verse-chorus-verse-chorus-bridge, SO Harrison drives lead guitar of verse, chorus, bridge; SO McCartney drives bass of verse, chorus, bridge; SO Ringo drives drums throughout; SO Lennon drives rhythm guitar throughout; all continue to provide input to the overall configuration as well as the contributions of each other (562). Epstein begins to record and work the mixing board as the song develops; George Martin provides very minimal input (564). SO Harrison develops a basic guitar solo to be positioned sequentially after the bridge, with minimal input from SO McCartney and SO Lennon (566). A result is completed and may be presented (568).

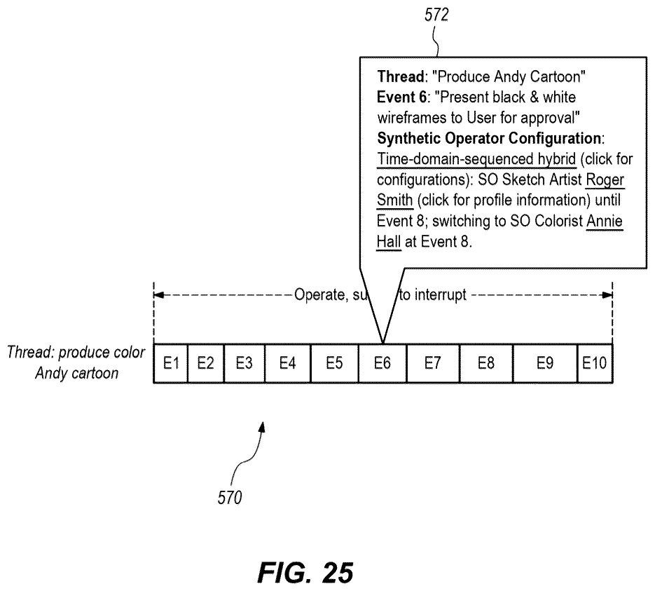

Referring to FIG. 25, a user interface example is presented wherein a user may be presented (570) with a representation of an event sequence and may be able to click or right-click upon a particular event to be further presented with a sub-presentation (such as a box or bubble) (572) with further information regarding the synthetic operator enhanced computing operation and status.

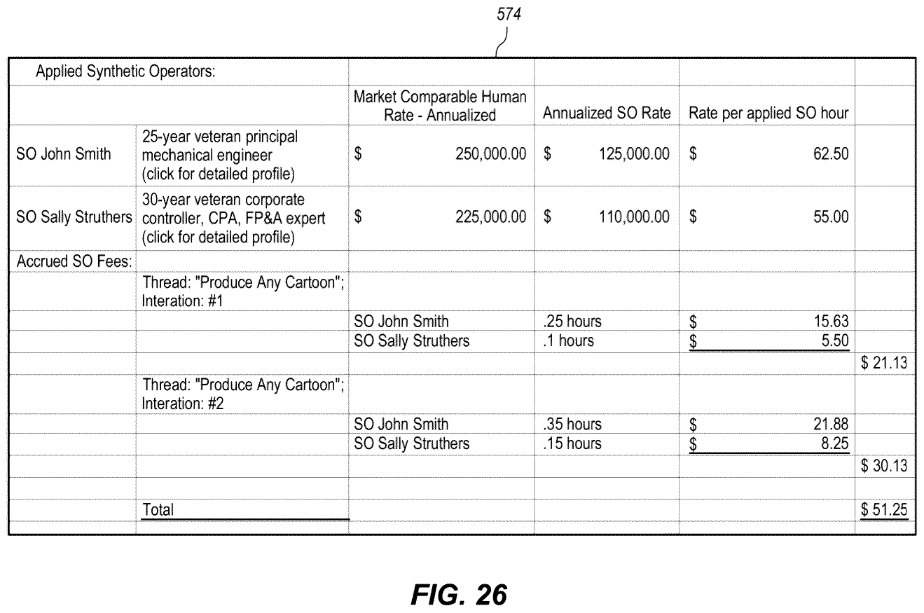

Referring to FIG. 26, a calculation table portion (574) is shown to illustrate that various business models may be utilized to present users/customers with significant value while also creating positive operating margin opportunities, depending upon costs such as those pertaining to computing resources.

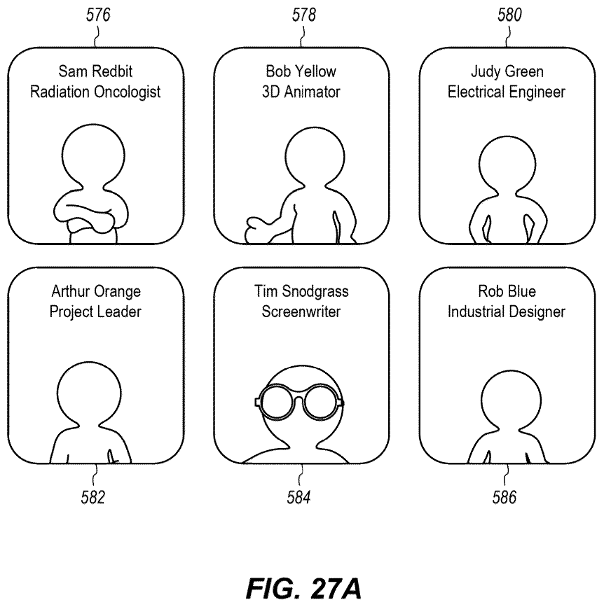

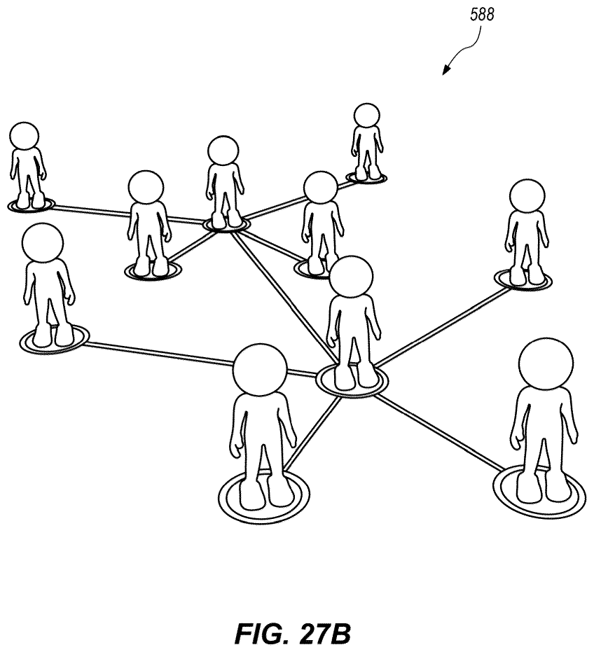

Referring to FIG. 27A, as noted above, many human processes are complex and varied, and it may be useful to bring many different types of synthetic operators (576, 578, 580, 582, 584, 586) together to address various challenges of complexity. Indeed, in various embodiments, it is preferable that the various system instantiations utilize synthetic operator resources in cohesive and connected manners (588), somewhat akin to actual human processes wherein the very best people are combined to address complex challenges.

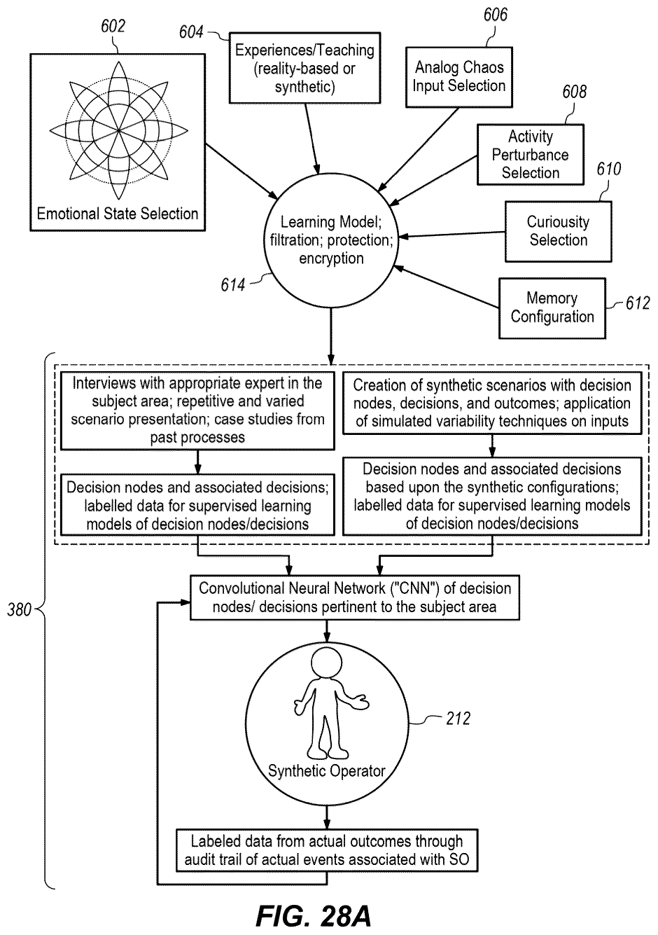

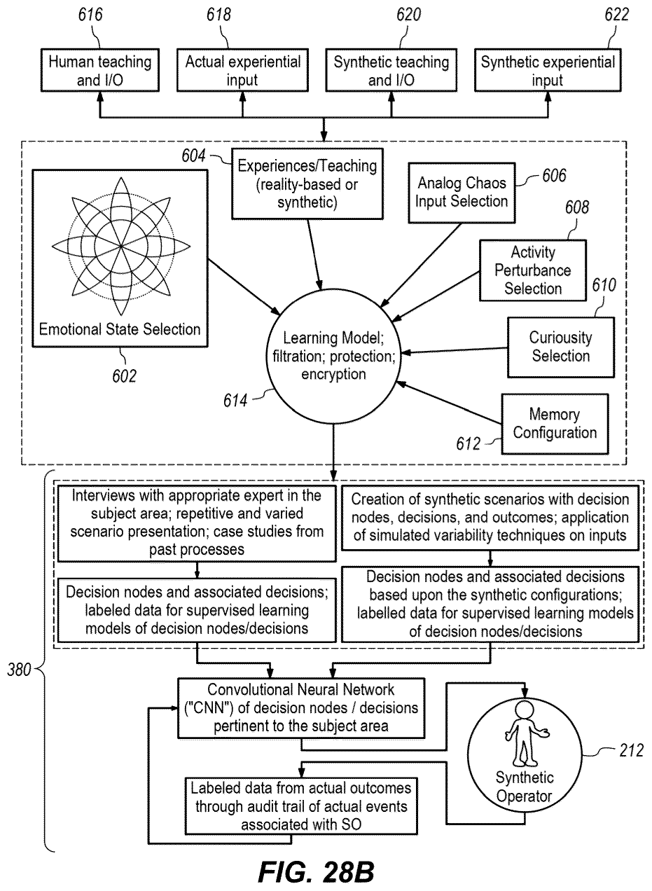

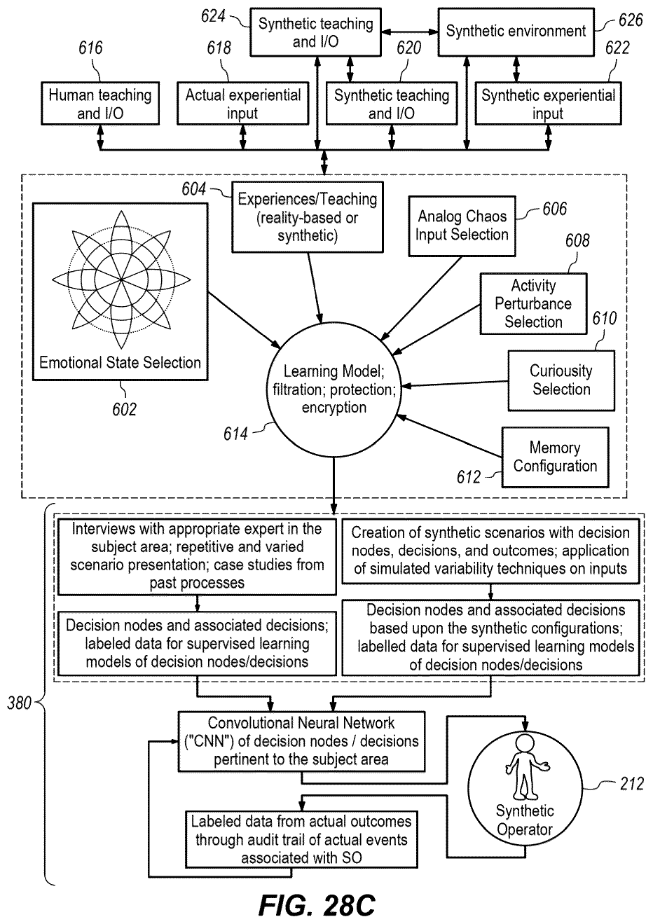

Referring to FIG. 28A, a synthetic operator (212) configuration (380) is illustrated with additional details intercoupled with regard to how continued learning and evolution may be accomplished using various factors. For example, as noted above, a neural network configured to operate aspects of a synthetic operator may be informed by actual historical data, synthetic data, and audit data pertaining to utilization. A learning model (614) may be configured to assist in filtering, protecting, and encrypting inputs to the process of constantly adjusting the neural network. For example, in various embodiments, a user may be presented with controls or a control panel to allow for configuration of mood/emotional state (such as via selection of an area on an emotional state chart) (602), access to various experiences and the teachings of others (604), an analog chaos input selection (606), an activity perturbance selection (608), a curiousity selection (610), and a memory configuration (612). For example, with a positive emotional state selected, a synthetic operator may be configured to engage in more positive information and approaches. Greater access to teachings and experiences may broaden the potential of a synthetic operator configuration. Additional chaos in a synthetic operator process may be good or bad; for example, it may keep activity very much alive, or it may lead to cycle wasting. Activity perturbance at a high level may assist in keeping processes, learning, and other activities at a high level. Curiosity at a high level may enhance learning and intake as inputs to the neural network. Memory configuration with significant long term and short term memory may assist in development of the neural network.

Referring to FIG. 28B, the various aspects of the learning model configuration may be informed by actual human teaching and experiences (616), actual experiential input from real human scenarios (618), teaching of synthetic facts and scenarios (620) (such as: a synthetic scenario about how Cyberdine Systems took over the world ala the movie “Terminator”®), and other synthetic experiential inputs (622) (such as: how the war happened with Cyberdine Systems versus the humans).

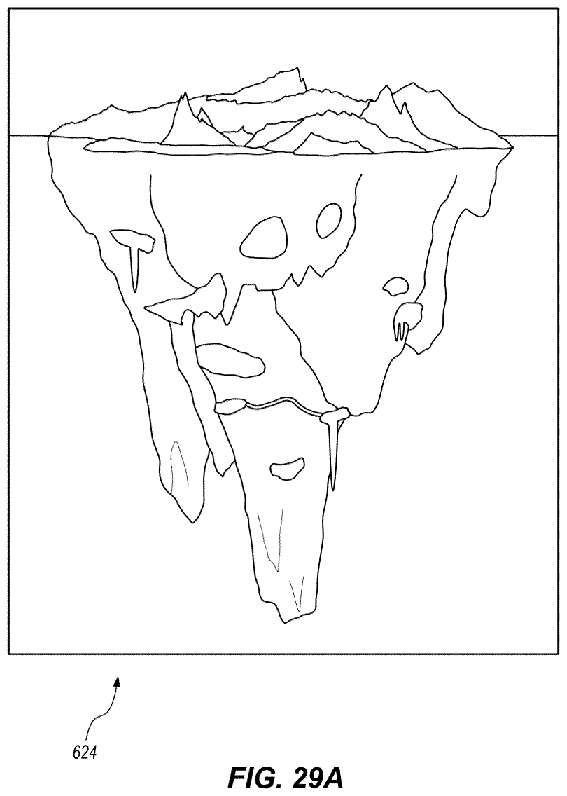

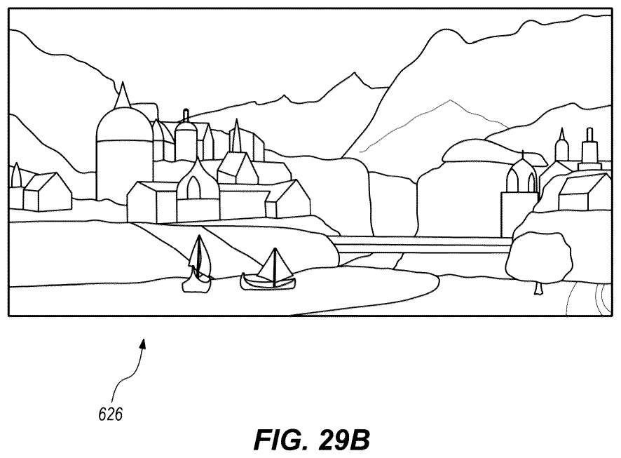

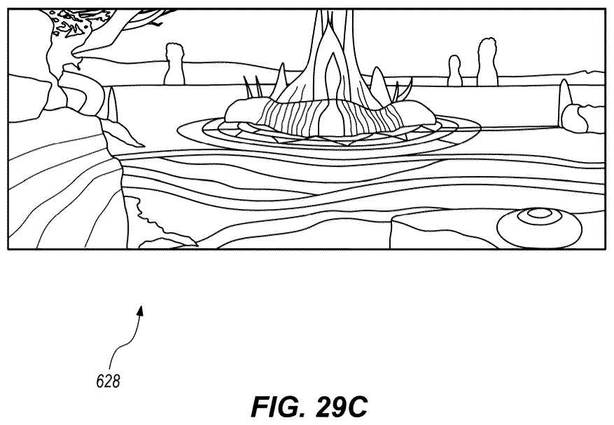

Referring to FIG. 28C, the various aspects of the learning model configuration may be further informed by interaction with synthetic relationships (624) which may be between synthetic operators, as well as synthetic environments (626) which may be configured to assist synthetic operators in engaging in various synthetic experiences, teachings, and encounters, as influenced, for example, by the user settings for the learning model configuration at the time. For example, synthetic worlds (624, 626, 628) are illustrated in FIGS. 29A-29C. A system may be configured to utilize synthetic operator configurations, along with learning model settings, to assist given synthetic operators in synthetically navigating around such worlds and having pertinent experiences and learning. For example, if SO #27 is a heavy metal guitarist and has emotional state settings in a pertinent learning model set to black for a period of time, that SO #27 may gravitate toward darker, heavier aspects of the pertinent synthetic world, which may be correlated with darker, heavier information and experiences, such as a dark cave filled with scorpions. To the contrary, a yoga instructor SO with a very positive emotional state selection may gravitate to brighter, sunnier, more positive aspects of the synthetic world, and gain more positive information and experiences in that stage of evolution.

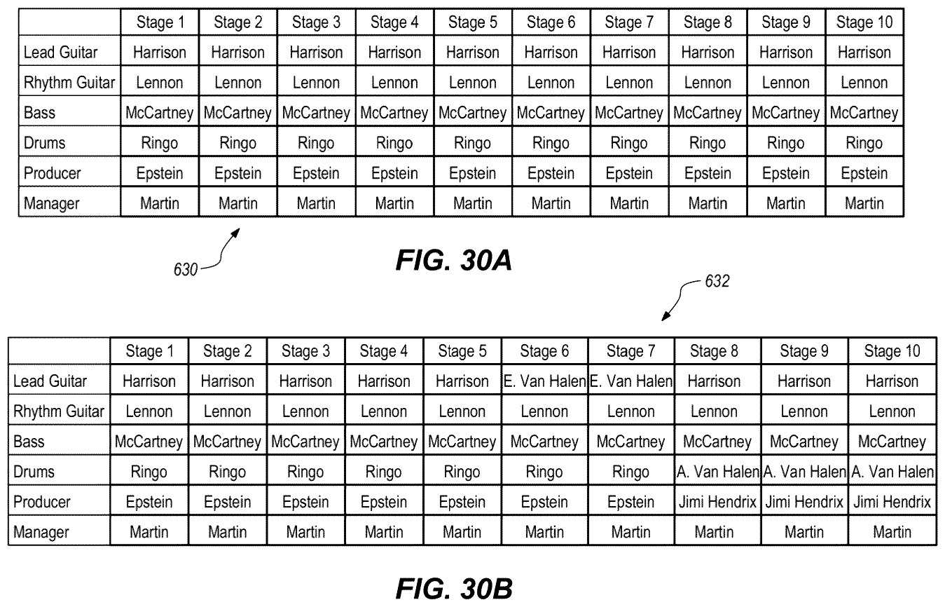

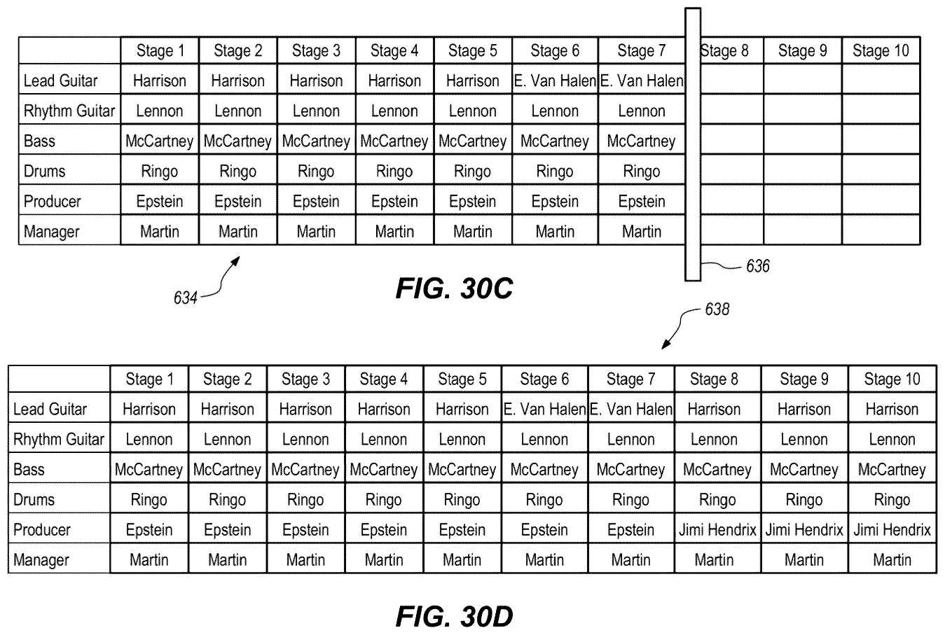

Referring to FIGS. 30A-30D, the system may be configured to assist a user in configuring various sequences, and customizing the results based upon sequence and time domain issues. For example, FIG. 30A illustrates a process depiction wherein ten stages of a process involving four musicians, a producer, and a manager. The depicted configuration has the Beatles members for the entire 10 stage process. Referring to the configuration (632) illustrated in FIG. 30B, at Stages 6 and 7, Eddie Van Halen has been swapped in on lead guitar, and in Stages 8, 9, and 10, Alex Van Halen has been swapped in on drums as well as Jimi Hendrix at the mixing board as Producer for Stages 8, 9, and 10. With the net result of the configuration of FIG. 30B being unsatisfactory, a time domain selector (636) may be utilized to back the process up to the beginning of Stage 8, as shown in FIG. 30C, and then as shown in FIG. 30D, the process may be run forward again from there with Ringo back on the drums for Stages 8, 9, and 10, but with Jimi Hendrix still in the producer role at the mixing board for Stages 8, 9, and 10 to see how that impacts the result.

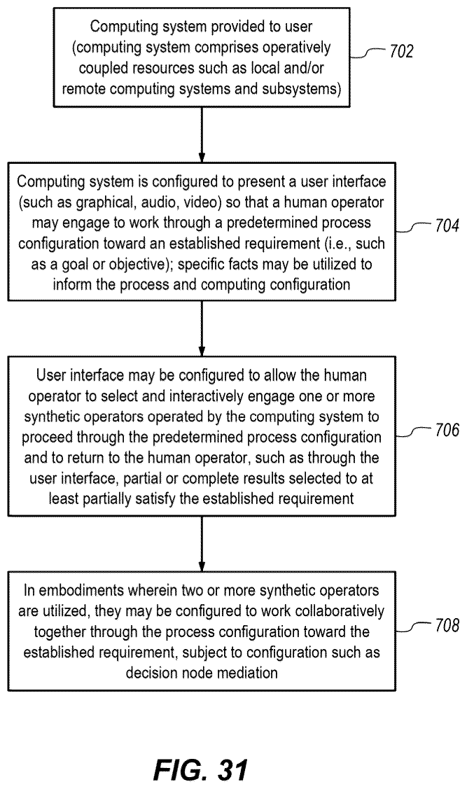

Referring to FIG. 31, a process configuration is illustrated wherein a computing system provided to user (computing system comprises operatively coupled resources such as local and/or remote computing systems and subsystems) (702). The computing system may be configured to present a user interface (such as graphical, audio, video) so that a human operator may engage to work through a predetermined process configuration toward an established requirement (i.e., such as a goal or objective); specific facts may be utilized to inform the process and computing configuration (704). The user interface may be configured to allow the human operator to select and interactively engage one or more synthetic operators operated by the computing system to proceed through the predetermined process configuration and to return to the human operator, such as through the user interface, partial or complete results selected to at least partially satisfy the established requirement (706). In embodiments wherein two or more synthetic operators are utilized, they may be configured to work collaboratively together through the process configuration toward the established requirement, subject to configuration such as decision node mediation (708).

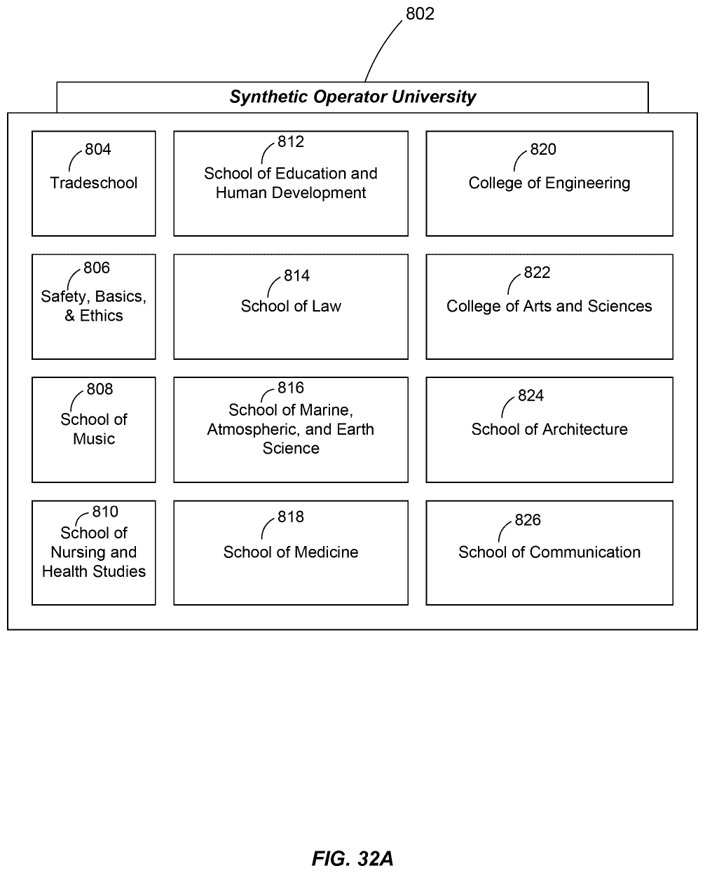

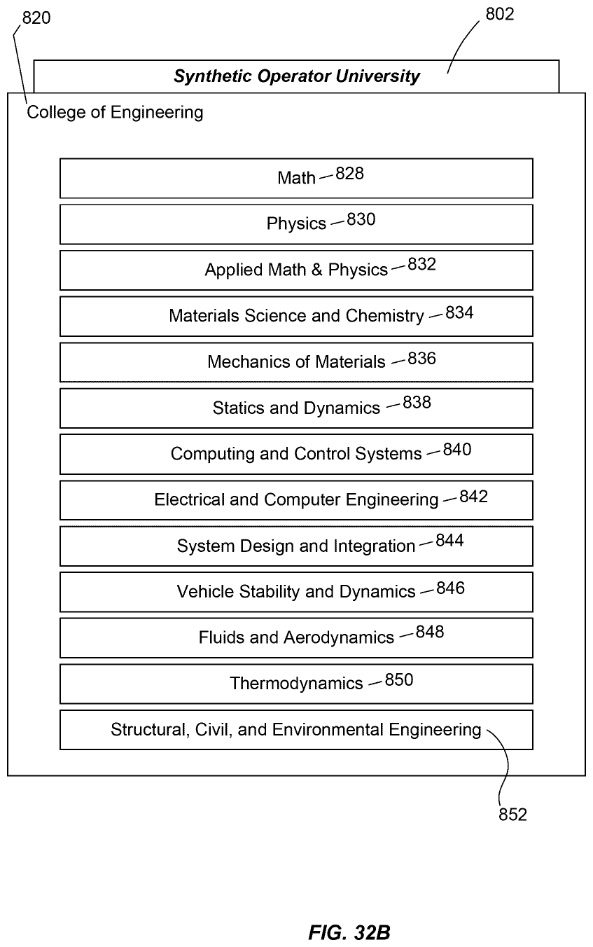

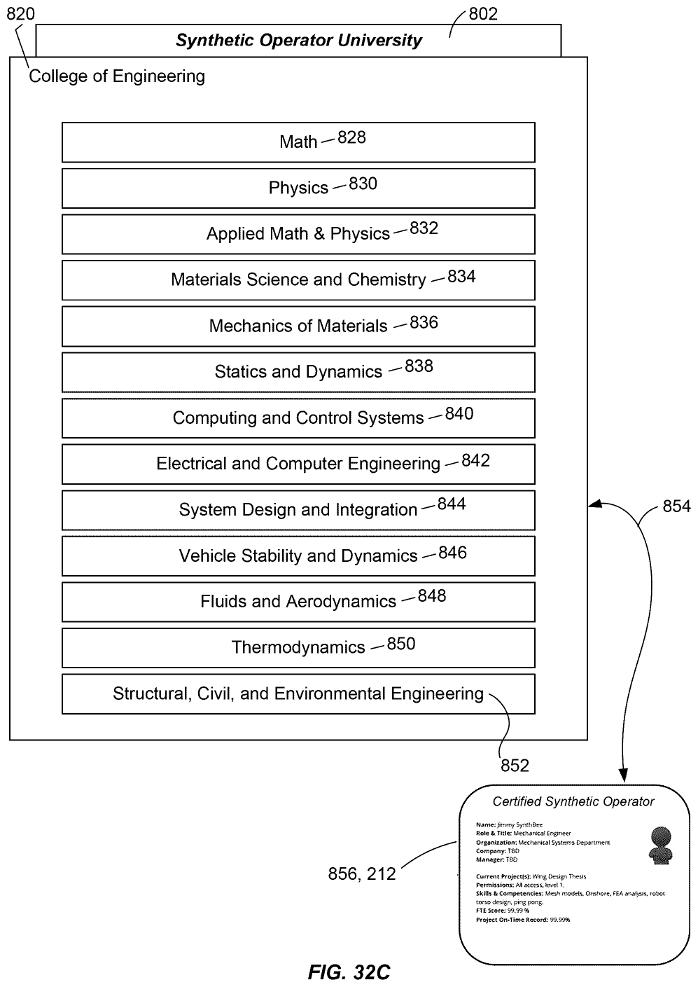

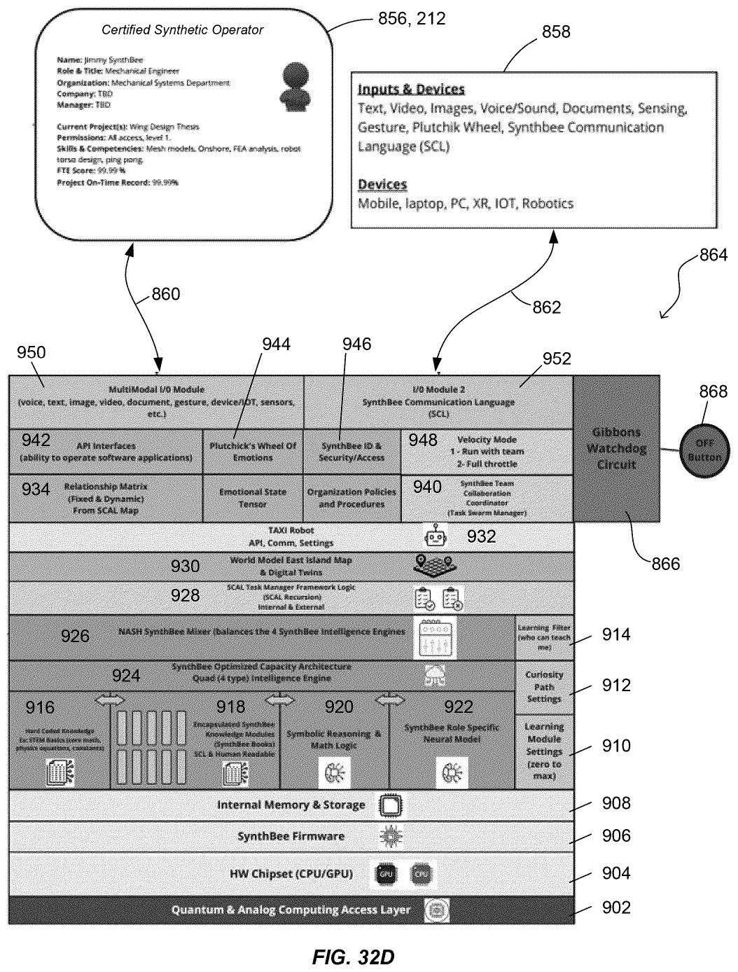

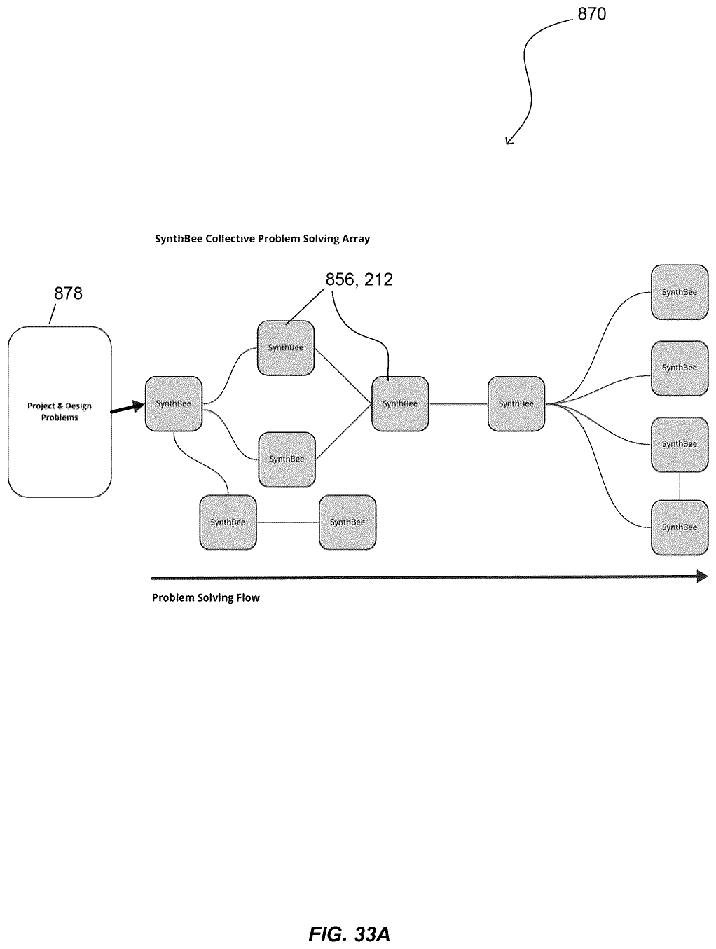

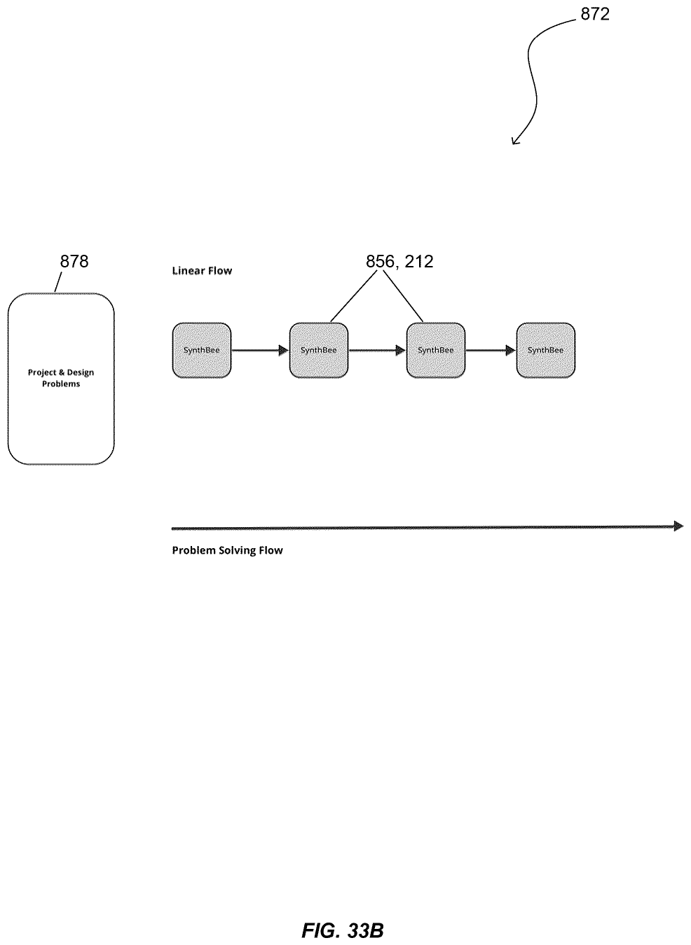

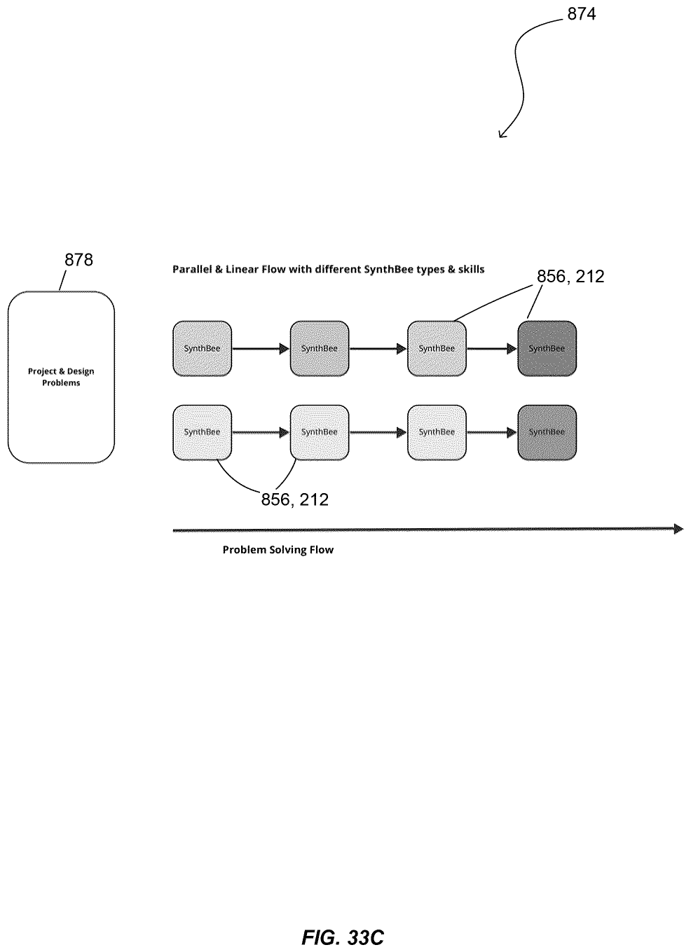

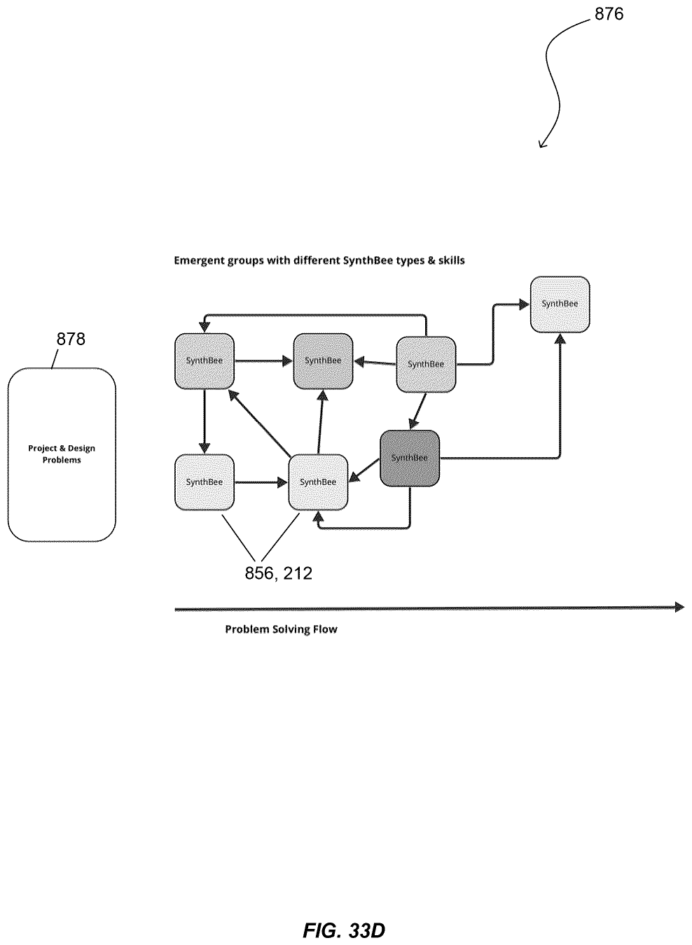

Referring to FIGS. 32A-32D and 33A-33D, various embodiments are illustrated wherein synthetic operators (212), or “synthetic beings” or “SynthBees™”, as they may also be called, may be given backgrounds and configured such that they may be created, educated, and utilized in process configurations of various complexity. Referring to FIGS. 32A-32D, for example, synthetic operator background configuration may comprise one or more selectable educational requirements; these may be based at least in part upon synthetic coursework pertaining to areas of formal study. For example, certain synthetic coursework pertaining to areas of formal study may be based at least in part upon education from a university type of setting, and may be categorized in at least one conventional higher education paradigm wherein subject matter may be divided into one or more scientific and liberal arts subjects. For example, the one or more scientific and liberal arts subjects may be selected from the group consisting of: a college of engineering, a school of law, a school of medicine, a college of arts and sciences, a school of nursing, a school of music, a school of architecture, a school of marine, atmospheric, and earth science, a school of communication, a trade school, and a school of safety, basics, and ethics. The one or more selectable educational requirements may comprise subject matter areas, the selectable inclusion of which imputes a level of knowledge to the given one or more synthetic operators. Thus, a given synthetic operator, having knowledge imputed via operator selectable inclusion, may be deemed to have a “certification” status (or be “certified”) to have a specific groups knowledge, experience, or skills which may thereafter be expected by a human operator selecting synthetic operators with such certification status.

Thus again referring to FIG. 32A, a university-like synthetic and/or functional environment (802) may be created which may, for example, comprise a collection of computing resources such as servers, configured to contain organized, domain-specific data structures pertaining to educational programs such as those illustrated (trade school 804; safety, basics, & ethics 806; school of music 808; school of nursing and health studies 810; school of educational and human development 812; school of law 814; school of marine, atmospheric, and earth science 816; school of medicine 818; college of engineering 820; college of arts and sciences 822; school of architecture 824; school of communication 826). Thus when a synthetic operator (212) is manufactured and/or trained, only role-specific data structures may be loaded into a standard 1-full-time-employee (“FTE”) sized synthetic operator (212) functional container. The educated, improved, and/or manufactured synthetic operators may be certified, validated, and made upgradeable under the supervising controls paradigm. Within each synthetic university module, various programs may be present comprising the domain-specific data structures. For example, referring to FIG. 32B, the college of engineering (820) may be configured to comprise various fundamental elements (such as math 828; physics 830; applied math and physics 832; materials science and chemistry 834; mechanics of materials 836; statics and dynamics 838; computing and control systems 840; electrical and computer engineering 842; system design and integration 844; vehicle stability and dynamics 846; fluids and aerodynamics 848; thermodynamics 850; structural, civil, and environmental engineering 852). Referring to FIG. 32C, the resultant (854) trained and/or educated synthetic operator (856, 212) may be certified, validated, and made upgradeable under the supervising controls paradigm, as noted above, and may be operated in runtime to engage in various solo endeavors, or with teams of other synthetic operators, synthetic beings, or SynthBees™, as shown, for example, in the flows of FIGS. 33A-33D. Referring ahead to FIG. 33A, a digital dossier comprising project and design problems and/or challenge descriptions (878) may be addressed by a plurality of synthetic operators, synthetic beings, or SynthBees™ working in a hybrid parallel/series configuration such that some of the synthetic operators (856, 212) work in series, while others work in parallel, relative to the time domain, to address a particular problem or challenge. Referring to FIG. 33B, a digital dossier comprising project and design problems and/or challenge descriptions (878) may be addressed by a plurality of synthetic operators, synthetic beings, or SynthBees™ working in a series or sequential configuration such that the synthetic operators (856, 212) work primarily in series to address a particular problem or challenge. Referring to FIG. 33C, a digital dossier comprising project and design problems and/or challenge descriptions (878) may be addressed by a plurality of synthetic operators, synthetic beings, or SynthBees™ working in a plurality of series or sequential configurations such that the synthetic operators (856, 212) work primarily as groups in series to address a particular problem or challenge. Referring to FIG. 33D, a digital dossier comprising project and design problems and/or challenge descriptions (878) may be addressed by a plurality of synthetic operators, synthetic beings, or SynthBees™ working in a hybrid parallel/series configuration such that some of the synthetic operators (856, 212) work in series, while others work in parallel, relative to the time domain, to address a particular problem or challenge—and wherein certain sequences dictate that one or more process steps may be accomplished in the reverse direction, or in another ordered direction, relative to the time domain axis.

Referring back to FIG. 32D, an architecture configuration (864) for a given example synthetic operator (856, 212) is illustrated with various functional modules designed to address a myriad of objectives with the intercoupled inputs and/or devices (858; such as text, video, voice/sound, documents, sensing, gesture information, Plutchik Wheel information, and SynthBee™ intercommunication—which may be executed and/or assisted utilizing a specific synthbee-communication-language (“SCL”)). The architecture configuration (864) preferably is configured such that the learning provided is highly-curated, accurate, and role specific (for example, it may comprise reinforced learning from other synthetic operators, humans, books, processes, data, and the like, and may be reinforced further with validation data, test data, and physics) for the specific synthetic being (856, 212). For example, referring again to FIG. 32D, various functional or elemental blocks are shown comprising a given synthetic operator, including but not limited to a quantum and/or analog computing access layer (902); a hardware chipset module which may comprise one or more CPU and/or GPU functionalities (904); a firmware module comprising software resident to operate certain local processes (906); an internal memory and/or storage module (908) configured to store various aspects of operational information; a group of learning module settings (910) which may, for example, be set from a baseline rate to a higher or functional maximal rate; curiosity path settings (912) configured to modulate certain exploratory functions of the subject synthetic operator; a learning filter (914) which may dynamically control aspects such as which sources of information are valid for teaching or informing this particular synthetic operator (856, 212); a role-specific neural module (922); symbolic reasoning and math logic (920); encapsulated synthetic operator knowledge modules (such as those which may be termed “SynthBee Books”, which may be in human readable and/or SCL format (918); hard-coded knowledge (916; such as engineering/STEM basics which may include math and physics relationships and equations, constants, and the like); a synthetic operator optimized capacity architecture quad (4-type) intelligence engine (924); a NASH synthetic operator mixer (926; may be configured to integrate one or more of the operational engines within the depicted operator example: 916, 918, 920, 922) a synthetic operator circuit mapping manager framework logic module (“SCAL” 928; may be configured dynamic to the problem/challenge); a world model mapping module (930; may also comprise digital twin information); a taxi robot module (932; may comprise, for example, application programming interface elements, communications elements and settings); a relationship matrix 934; may be fixed and/or dynamic, such as from an SCAL map); an emotional state tensor module (936); a organizational policies and/or procedures module (938; such as pertinent to the problem, challenge, associated organization or team, etc); a synthetic operator team collaboration coordinator module (940; such as a so-called “task swarm manager” element); one or more additional application programming interfaces (942; such as those which may be utilized to assist in operating software applications; an associated Plutchick's Wheel of Emotions (944); a synthetic operator identification and security/access module (946); a velocity mode controller (948; for example, may be utilized to control functional velocity and/or processing from a baseline mode, such as “run with team”, to a higher level mode, such as “full-throttle”); a multi-modal I/O module (950; for example, controlling the input, output, and exchange of voice information, text information, documents, gesture information, device/internet-of-things modules, other sensors, etc); a secondary I/O module (952; may be pertinent to the synthetic operator communication language, or “SCL”, as noted above); other functional modules pertaining to the particular synthetic operator may include a manual shutoff capability (868) and/or an automatic shutoff capability (866; may be known as a “Gibbons Watchdog Circuit” and may be configured to automatically shutoff or stop runtime operation of the particular synthetic operator (856, 212) should a certain aberrant condition be detected.

Various exemplary embodiments of the invention are described herein. Reference is made to these examples in a non-limiting sense. They are provided to illustrate more broadly applicable aspects of the invention. Various changes may be made to the invention described and equivalents may be substituted without departing from the true spirit and scope of the invention. In addition, many modifications may be made to adapt a particular situation, material, composition of matter, process, process act(s) or step(s) to the objective(s), spirit or scope of the present invention. Further, as will be appreciated by those with skill in the art that each of the individual variations described and illustrated herein has discrete components and features which may be readily separated from or combined with the features of any of the other several embodiments without departing from the scope or spirit of the present inventions. All such modifications are intended to be within the scope of claims associated with this disclosure.

Any of the devices described for carrying out the subject diagnostic or interventional procedures may be provided in packaged combination for use in executing such interventions. These supply “kits” may further include instructions for use and be packaged in sterile trays or containers as commonly employed for such purposes.

The invention includes methods that may be performed using the subject devices. The methods may comprise the act of providing such a suitable device. Such provision may be performed by the end user. In other words, the “providing” act merely requires the end user obtain, access, approach, position, set-up, activate, power-up or otherwise act to provide the requisite device in the subject method. Methods recited herein may be carried out in any order of the recited events which is logically possible, as well as in the recited order of events.

Exemplary aspects of the invention, together with details regarding material selection and manufacture have been set forth above. As for other details of the present invention, these may be appreciated in connection with the above-referenced patents and publications as well as generally known or appreciated by those with skill in the art. The same may hold true with respect to method-based aspects of the invention in terms of additional acts as commonly or logically employed.

In addition, though the invention has been described in reference to several examples optionally incorporating various features, the invention is not to be limited to that which is described or indicated as contemplated with respect to each variation of the invention. Various changes may be made to the invention described and equivalents (whether recited herein or not included for the sake of some brevity) may be substituted without departing from the true spirit and scope of the invention. In addition, where a range of values is provided, it is understood that every intervening value, between the upper and lower limit of that range and any other stated or intervening value in that stated range, is encompassed within the invention.

Also, it is contemplated that any optional feature of the inventive variations described may be set forth and claimed independently, or in combination with any one or more of the features described herein. Reference to a singular item, includes the possibility that there are plural of the same items present. More specifically, as used herein and in claims associated hereto, the singular forms “a,” “an,” “said,” and “the” include plural referents unless the specifically stated otherwise. In other words, use of the articles allow for “at least one” of the subject item in the description above as well as claims associated with this disclosure. It is further noted that such claims may be drafted to exclude any optional element. As such, this statement is intended to serve as antecedent basis for use of such exclusive terminology as “solely,” “only” and the like in connection with the recitation of claim elements, or use of a “negative” limitation.

Without the use of such exclusive terminology, the term “comprising” in claims associated with this disclosure shall allow for the inclusion of any additional element—irrespective of whether a given number of elements are enumerated in such claims, or the addition of a feature could be regarded as transforming the nature of an element set forth in such claims. Except as specifically defined herein, all technical and scientific terms used herein are to be given as broad a commonly understood meaning as possible while maintaining claim validity.

The breadth of the present invention is not to be limited to the examples provided and/or the subject specification, but rather only by the scope of claim language associated with this disclosure.

1. A synthetic engagement system for process-based problem solving, comprising:
a. a computing system comprising one or more operatively coupled computing resources; and
b a user interface operated by the computing system and configured to engage a human operator in accordance with a predetermined process configuration toward an established requirement based at least in part upon one or more specific facts;
wherein the user interface is configured to allow the human operator to select and interactively engage one or more synthetic operators operated by the computing system to proceed through the predetermined process configuration, and to return a result to the human operator selected to at least partially satisfy the established requirement; and
wherein each of the one or more synthetic operators is informed by a convolutional neural network informed at least in part by a combination of historical actions of a particular actual human operator and a synthetic operator background configuration.

2. The system of claim 1, wherein the one or more specific facts are selected from the group consisting of: textual information, numeric data, audio information, video information, emotional state information, analog chaos input selection, activity perturbance selection, curiosity selection, memory configuration, learning model, filtration configuration, and encryption configuration.

3. The system of claim 2, wherein the one or more specific facts comprise textual information pertaining to specific background information from historical storage.

4. The system of claim 2, wherein the one or more specific facts comprise textual information pertaining to an actual operator.

5. The system of claim 2, wherein the one or more specific facts comprise textual information pertaining to a synthetic operator.

6. The system of claim 1, wherein the specific facts comprise a predetermined profile of specific facts developed as an initiation module for a specific synthetic operator profile.

7. The system of claim 1, wherein the one or more operatively coupled computing resources comprises a local computing resource.

8. The system of claim 7, wherein the local computing resource is selected from the group consisting of: a mobile computing resource, a desktop computing resource, a laptop computing resource, and an embedded computing resource.

9. The system of claim 8, wherein the local computing resource comprises an embedded computing resource selected from the group consisting of: an embedded microcontroller, an embedded microprocessor, and an embedded gate array.

10. The system of claim 1, wherein the one or more operative coupled computing resources comprises resources selected from the group consisting of: a remote data center; a remote server; a remote computing cluster; and an assembly of computing systems in a remote location.

11. The system of claim 1, further comprising a localization element operatively coupled to the computing system and configured to determine a location of the human operator relative to a global coordinate system.

12. The system of claim 11, wherein the localization element is selected from the group consisting of: a GPS sensor; an IP address detector; a connectivity triangulation detector; an electromagnetic localization sensor; an optical location sensor.

13. The system of claim 11, wherein the one or more operatively coupled computing resources are activated based upon the determined location of the human operator.

14. The system of claim 1, wherein the user interface comprises a graphical user interface.

15. The system of claim 1, wherein the user interface comprises an audio user interface.

16. The system of claim 14, wherein the graphical user interface is configured to engage the human operator using an element selected from the group consisting of: a computer graphics engagement display; a video graphics engagement display; and an audio engagement accompanied by displayed graphics.

17. The system of claim 14, wherein the graphical user interface comprises a video graphics engagement display configured to present a real-time or near real-time graphical representation of a video interface engagement character with which the human operator may converse.

18. The system of claim 17, wherein the video interface engagement character is selected from the group consisting of: a humanoid character, an animal character, and a cartoon character.

19. The system of claim 18, wherein the user interface is configured to allow the human operator to select the visual presentation of the video interface engagement character.

20. The system of claim 19, wherein the user interface is configured to allow the human operator to select a visual presentation characteristic of the video interface engagement character selected from the group consisting of: character gender, character hair color, character hair style, character skin tone, character eye coloration, and character shape.

21. The system of claim 19, wherein the visual presentation of the video interface engagement character may be modelled after a selected actual human.

22. The system of claim 18, wherein the user interface is configured to allow the human operator to select one or more audio presentation aspects of the video interface engagement character.

23. The system of claim 22, wherein the user interface is configured to allow the human operator to select one or more audio presentation aspects of the video interface engagement character selected from the group consisting of: character voice intonation; character voice loudness; character speaking language; character speaking dialect; and character voice dynamic range.

24. The system of claim 23, wherein the one or more audio presentation aspects of the video interface engagement character may be modelled after a selected actual human.

25. The system of claim 1, wherein the predetermined process configuration comprises a finite group of steps through which the engagement shall proceed in furtherance of the established requirement.

26. The system of claim 1, wherein the predetermined process configuration comprises a process element selected from the group consisting of: one or more generalized operating parameters; one or more resource/input awareness and utilitization settings; a domain expertise module; a process sequencing paradigm; a process cycling/iteration paradigm; and an AI utilization and configuration setting.

27. The system of claim 25, wherein the finite group of steps comprises steps selected from the group consisting of: problem definition; potential solutions outline; preliminary design; and detailed design.

28. The system of claim 25, wherein the predetermined process configuration comprises a selection of elements by the human operator.

29. The system of claim 28, wherein selection of elements by the human operator comprises selecting synthetic operator resourcing for one or more aspects of the predetermined process configuration.

30. The system of claim 29, wherein the system is configured to allow the human operator to specify a particular resourcing for a first specific portion of the predetermined process configuration.

31. The system of claim 30, wherein the system is configured to allow the human operator to specify a particular resourcing for a second specific portion of the predetermined process configuration that is different from the particular resourcing for the first specific portion of the predetermined process configuration.

32. The system of claim 30, wherein the system is configured to allow the human operator to specify a particular resourcing for a first specific portion of the predetermined process configuration that is based upon a plurality of synthetic operator characters.

33. The system of claim 32, wherein each of the plurality of synthetic operator characters is applied to the first specific portion sequentially.

34. The system of claim 32, wherein each of the plurality of synthetic operator characters is applied to the first specific portion simultaneously.

35. The system claim 30, wherein the system is configured to allow the human operator to specify a particular resourcing for a first specific portion of the predetermined process configuration that is based upon one or more hybrid synthetic operator characters.

36. The system of claim 30, wherein the one or more hybrid synthetic operator characters comprises a combination of otherwise separate synthetic operator characters which may be applied to the first specific portion simultaneously.

37. The system of claim 1, wherein the convolutional neural network is informed using inputs from a training dataset comprising data pertaining to the historical actions of the particular actual human operator.

38. The system of claim 37, wherein the convolutional neural network is informed using inputs from a training dataset using a supervised learning model.

39. The system of claim 37, wherein the convolutional neural network is informed using inputs from a training dataset along with analysis of the established requirement using a reinforcement learning model.

40. The system of claim 1, wherein each of the one or more synthetic operators is informed by a convolutional neural network informed at least in part by a curated selection of synthetic action records pertaining to synthetic actions of an actual human operator.

41. The system of claim 1, wherein each of the one or more synthetic operators is informed by a convolutional neural network informed at least in part by a curated selection of synthetic action records pertaining to synthetic actions of a synthetic operator.

42. The system of claim 25, wherein the computing system is configured to separate each of the finite group of steps with an execution step during which the one or more synthetic operators are configured to progress toward the established requirement in accordance with one or more execution behaviors associated with the pertinent convolutional neural network.

43. The system of claim 42, wherein at least one of the one or more execution behaviors is based upon a project leadership influence on the pertinent convolutional neural network.

44. The system of claim 43, wherein the computing system, based at least in part upon the at least one execution behavior based upon a project leadership influence, is configured to divide the execution step into a plurality of tasks which may be addressed by the available resources in furtherance of the established requirement.

45. The system of claim 44, wherein the computing system, based at least in part upon the at least one execution behavior based upon a project leadership influence, is further configured to project manage accomplishment of the plurality of tasks toward one or more milestones in pursuit of the established requirement.

46. The system of claim 44, wherein the computing system, based at least in part upon the at least one execution behavior based upon a project leadership influence, is further configured to functionally provide an update pertaining to accomplishment of the plurality of tasks at one or more stages of the execution step.

47. The system of claim 46, wherein the computing system, based at least in part upon the at least one execution behavior based upon a project leadership influence, is further configured to functionally provide an update pertaining to accomplishment of the plurality of tasks at the end of each executing step for consideration in each of the finite group of steps in the process configuration.

48. The system of claim 47, wherein the computing system, based at least in part upon the at least one execution behavior based upon a project leadership influence, is further configured to functionally present the update update for consideration by the human operator utilizing the user interface operated by the computing system.

49. The system of claim 48, wherein the computing system, based at least in part upon the at least one execution behavior based upon a project leadership influence, is further configured to incorporate instructions from the human operator pertaining to the presented update utilizing the user interface operated by the computing system, as the finite steps of the process configuration are continued.

50. The system of claim 1, wherein the user interface is configured to allow the human operator to pause the computing system while it otherwise proceeds through the predetermined process configuration so that one or more intermediate results may be examined by the human operator pertaining to the established requirement.

51. The system of claim 50, wherein the user interface is configured to allow the human operator to change one or more aspects of the one or more specific facts during the pause of the computing system to facilitate forward execution based upon the change.

52. The system of claim 1, wherein the user interface is configured to provide the human operator with a calculated resourcing cost based at least in part upon utilization of the operatively coupled computing resources in the predetermined process configuration.

53. The system of claim 1, wherein the synthetic operator background configuration comprises one or more selectable educational requirements.

54. The system of claim 53, wherein the one or more selectable educational requirements are based at least in part upon synthetic coursework pertaining to areas of formal study.

55. The system of claim 54, wherein the synthetic coursework pertaining to areas of formal study are based at least in part upon education from a university setting.

56. The system of claim 55, wherein the areas of formal study are based at least in part upon education from a university setting categorized in at least one conventional higher education paradigm.

57. The system of claim 56, wherein the at least one conventional higher education paradigm comprises division of subject matter into one or more scientific and liberal arts subjects.

58. The system of claim 57, wherein the one or more scientific and liberal arts subjects are selected from the group consisting of: a college of engineering, a school of law, a school of medicine, a college of arts and sciences, a school of nursing, a school of music, a school of architecture, a school of marine, atmospheric, and earth science, a school of communication, a trade school, and a school of safety, basics, and ethics.

59. The system of claim 53, wherein the one or more selectable educational requirements comprise subject matter areas, the selectable inclusion of which imputes a level of knowledge to the given one or more synthetic operators.

60. The system of claim 59, wherein a given synthetic operator, having knowledge imputed via operator selectable inclusion, may be deemed to have a certification status to have a specific groups knowledge, experience, or skills which may thereafter be expected by a human operator selecting synthetic operators with such certification status.

61. The system of claim 1, wherein the user interface is further configured to allow the human operator to select and interactively engage two or more synthetic operators operated by the computing system to collaboratively proceed through the predetermined process configuration, and to return a result to the human operator selected to at least partially satisfy the established requirement; wherein each of the two or more synthetic operators is informed by a convolutional neural network informed at least in part by historical actions of a particular actual human operator and a synthetic operator background configuration.

62. The system of claim 61, wherein the system is configured to allow the human operator to specify that the two or more synthetic operators are different.

63. The system of claim 61, wherein the system is configured to allow the human operator to specify that the two or more synthetic operators are the same and may be configured to collaboratively scale their productivity as they proceed through the predetermined process configuration.

64. The system of claim 61, wherein the two or more synthetic operators are configured to automatically optimize their application as resources as they proceed through the predetermined process configuration.

65. The system of claim 61, wherein the system is configured to utilize the two or more synthetic operators to produce an initial group of decision nodes pertinent to the established requirement based at least in part upon characteristics of the two or more synthetic operators.

66. The system of claim 65, wherein the system is further configured to create a group of mediated decision nodes based upon the initial group of decision nodes.

67. The system of claim 66, wherein the system is further configured to create a group of operative decision nodes based upon the group of mediated decision nodes.

68. The system of claim 66, wherein the two or more synthetic operators are operated by the computing system to collaboratively proceed through the predetermined process configuration by sequencing through the operative decision nodes in furtherance of the established requirement.

69. The system of claim 61, wherein the two or more synthetic operators comprises a plurality limited only by the operatively coupled computing resources.

70-138. (canceled)
